(19) United States
(12) Patent Application Publication
(10) Pub. No.: US 2025/0254007 A1
(43) Pub. Date: Aug. 7, 2025

(54) METHOD AND APPARATUS FOR RECEIVING AND TRANSMITTING INFORMATION IN A WIRELESS COMMUNICATION SYSTEM

(71) Applicant: Samsung Electronics Co., Ltd., Suwon-si (KR)

(72) Inventors: Zhe CHEN, Beijing (CN); Sa ZHANG, Beijing (CN); Feifei SUN, Beijing (CN)

(21) Appl. No.: 19/038,087

(22) Filed: Jan. 27, 2025

(30) Foreign Application Priority Data
Feb. 6, 2024 (CN) 202410172278.0
Mar. 28, 2024 (CN) 202410370516.9
May 15, 2024 (CN) 202410606933.9

(51) Int. Cl. H04L 5/00; H04L 5/14

(52) U.S. Cl. CPC H04L 5/0057; H04L 5/14

(57) ABSTRACT

The disclosure relates to a fifth generation (5G) or sixth generation (6G) communication system for supporting a higher data transmission rate. A method performed by a user equipment (UE) in a wireless communication system is provided. The method includes receiving, from a base station (BS), configuration information for subband non-overlapping full-duplex (SBFD), wherein the configuration information indicates SBFD frequency domain resource(s), receiving, from the BS, a channel state information (CSI) reporting configuration, and determining a CSI reporting band for reporting CSI associated with the CSI reporting configuration based on the SBFD frequency domain resource(s).

### CROSS-REFERENCE TO RELATED APPLICATION(S)

This application is based on and claims priority under 35 U.S.C. § 119 (a) of a Chinese patent application number 202410172278.0, filed on Feb. 6, 2024, in the Chinese Intellectual Property Office, of a Chinese patent application number 202410370516.9, filed on Mar. 28, 2024, in the Chinese Intellectual Property Office, and of a Chinese patent application number 202410606933.9, filed on May 15, 2024, in the Chinese Intellectual Property Office, the disclosure of each of which is incorporated by reference herein in its entirety.

### BACKGROUND

### 1. Field

The disclosure relates to the technical field of wireless communication. More particularly, the disclosure relates to method and apparatus for receiving and transmitting information in a wireless communication system.

### 2. Description of Related Art

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of Band Width Part (BWP), new channel coding methods such as a Low Density Parity Check (LDPC) code for large amount of data transmission and a polar code for highly reliable transmission of control information, Layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR User Equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step Random Access Channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide method and apparatus for receiving and transmitting information in a wireless communication system.

Additional aspects will be set forth in part in the description which follows and, in part, will be apparent from the description, or may be learned by practice of the presented embodiments.

In order to enhance the scheduling efficiency of the 5G wireless communication system, the base station needs to obtain channel state information (CSI) to schedule according to the CSI fed back by the terminal equipment. However, how to further enhance the performance of CSI reporting is a problem to be solved.

In accordance with an aspect of the disclosure, a method performed by a user equipment UE in a wireless communication system is provided. The method includes receiving, from a base station (BS), configuration information for subband non-overlapping full-duplex (SBFD), wherein the configuration information indicates SBFD frequency domain resource(s), receiving, from the BS, a channel state information (CSI) reporting configuration, and determining a CSI reporting band for reporting CSI associated with the CSI reporting configuration based on the SBFD frequency domain resource(s).

In an example, the CSI reporting band includes at least one of a subset of CSI subbands, or physical resource blocks (PRBs) of a bandwidth part (BWP) associated with the CSI reporting configuration.

In an example, based on a number of the PRBs of the BWP being less than or equal to a predefined value, or the number of PRBs of the BWP in a downlink subband included in the SBFD frequency domain resource(s) being less than or equal to a predefined value, then at least one of the CSI reporting band includes frequency domain resource(s) of the BWP in the downlink subband included in the SBFD frequency domain resource(s), the CSI reporting band includes all PRBs in the BWP, or the BWP is not configured outside the downlink subband included in the SBFD frequency domain resource(s).

In an example, the CSI subbands are within the BWP.

In an example, a number of CSI subbands included in the CSI subbands is determined based on a number of bits in a bitmap included in a CSI reporting band parameter associated with the CSI reporting configuration, and a CSI subband with a lowest frequency domain position in the CSI subbands is a CSI subband with a lowest frequency domain position in the BWP.

In an example, the bitmap indicates one or more CSI subbands in the CSI subbands, and wherein the subset of the CSI subbands includes CSI subbands of the one or more CSI subbands in a downlink subband included in the SBFD frequency domain resource(s).

In an example, the CSI subbands are in the BWP and in a downlink subband included in the SBFD frequency domain resource(s).

In an example, a number of CSI subbands included in the CSI subbands is determined based on a number of bits in a bitmap included in a CSI reporting band parameter associated with the CSI reporting configuration, and a CSI subband with a lowest frequency domain position is a CSI subband with a lowest frequency domain position in the BWP and in a downlink subband included in the SBFD frequency domain resource(s).

In an example, the bitmap indicates one or more CSI subbands in the CSI subbands, and the subset of the CSI subbands includes the one or more CSI subbands.

In an example, the method further includes, for each CSI subband, determining a first CSI subband size from configurable CSI subband sizes based on a parameter associated with subband sizes included in the CSI reporting configuration, wherein the configurable CSI subband sizes are determined based on the frequency domain resource(s) of the BWP in the downlink subband included in the SBFD frequency domain resource(s) or based on the BWP.

In an example, each of the CSI subbands is associated with N_{SB} consecutive PRBs, wherein the N_{SB} is determined based on the first CSI subband size, and/or a number of a reference common resource block (CRB) corresponding to an initial PRB of the N_{SB} consecutive PRBs is an integer multiple of the N_{SB}.

In an example, frequency domain resource(s) of each CSI subband in the subset of the CSI subbands are determined based on a PRB subsets of the N_{SB} consecutive PRBs in the BWP and in the downlink subband included in the SBFD frequency domain resource(s).

In an example, PRBs included in the PRB subset are consecutive, or if the PRBs included in the PRB subset are consecutive, the frequency domain resource(s) of each CSI subband are the PRB subset, or if the PRBs included in the PRB subset are non-consecutive, the frequency domain resource(s) of each CSI subband are a group of consecutive PRBs predefined in the PRB subset.

In an example, the CSI subbands of the subset of the CSI subbands in the downlink subband included in the SBFD frequency domain resource(s) are numbered continuously.

In an example, determining the CSI reporting band is further based on SBFD time domain resource(s) indicated by the configuration information.

In accordance with another aspect of the disclosure, a method performed by a base station in a wireless communication system is provided. The method includes transmitting, to a user equipment (UE), configuration information for subband non-overlapping full-duplex (SBFD), wherein the configuration information indicates SBFD frequency domain resource(s), transmitting, to the UE, a channel state information (CSI) reporting configuration, and receiving, from the UE, CSI associated with a CSI reporting band, wherein the CSI reporting band is determined based on the SBFD frequency domain resource(s).

In an example, the CSI reporting band includes at least one of a subset of CSI subbands, or physical resource blocks (PRBs) of a bandwidth part (BWP) associated with the CSI reporting configuration.

In an example, based on a number of the PRBs of the BWP being less than or equal to a predefined value, or the number of PRBs of the BWP in a downlink subband included in the SBFD frequency domain resource(s) being less than or equal to a predefined value, then at least one of the CSI reporting band includes frequency domain resource(s) of the BWP in the downlink subband included in the SBFD frequency domain resource(s), the CSI reporting band includes all PRBs in the BWP, or the BWP is not configured outside the downlink subband included in the SBFD frequency domain resource(s).

In an example, the CSI subbands are in the BWP.

In an example, a number of CSI subbands included in the CSI subbands is determined based on a number of bits in a bitmap included in a CSI reporting band parameter associated with the CSI reporting configuration, and a CSI subband with the lowest frequency domain position in the CSI subbands is a CSI subband with the lowest frequency domain position in the BWP.

In an example, the bitmap indicates one or more CSI subbands in the CSI subbands, and the subset of the CSI subbands includes CSI subbands of the one or more CSI subbands in the downlink subband included in the SBFD frequency domain resource(s).

In an example, the CSI subbands are in the BWP and in the downlink subband included in the SBFD frequency domain resource(s).

In an example, a number of CSI subbands included in the CSI subbands is determined based on a number of bits in a bitmap included in a CSI reporting band parameter associated with the CSI reporting configuration, and a CSI subband with a lowest frequency domain position is a CSI subband with a lowest frequency domain position in the BWP and in a downlink subband included in the SBFD frequency domain resource(s).

In an example, the bitmap indicates one or more CSI subbands in the CSI subbands, and the subset of the CSI subbands includes the one or more CSI subbands.

In an example, the method further includes having a first CSI subband size for each of the CSI subbands, wherein the first CSI subband size is determined from configurable CSI subband sizes based on a parameter associated with subband sizes included in the CSI reporting configuration, and wherein the configurable CSI subband sizes are determined based on the frequency domain resource(s) of the BWP in the downlink subband included in the SBFD frequency domain resource(s) or based on the BWP.

In an example, each of the CSI subbands is associated with N_{SB} consecutive PRBs, wherein the N_{SB} is determined based on the first CSI subband size, and/or a number of a reference common resource block (CRB) corresponding to an initial PRB of the N_{SB} consecutive PRBs is an integer multiple of the N_{SB}.

In an example, frequency domain resource(s) of each CSI subband in the subset of the CSI subbands are determined based on PRB subsets of the N_{SB} consecutive PRBs in the BWP and in the downlink subband included in the SBFD frequency domain resource(s).

In an example, PRBs included in the PRB subset are consecutive, or if the PRBs included in the PRB subset are consecutive, the frequency domain resource(s) of each CSI subband are the PRB subset, or if the PRBs included in the PRB subset are non-consecutive, the frequency domain resource(s) of each CSI subband are a group of consecutive PRBs predefined in the PRB subset.

In an example, the CSI subbands of the subset of the CSI subbands in the downlink subband included in the SBFD frequency domain resource(s) are numbered continuously.

In an example, determining the CSI reporting band is further based on SBFD time domain resource(s) indicated by the configuration information.

In accordance with another aspect of the disclosure, a user equipment (UE) in a wireless communication system, is provided. The UE includes a transceiver, and a controller coupled to the transceiver and configured to, receive, from a base station (BS), configuration information for subband non-overlapping full-duplex (SBFD), wherein the configuration information indicates SBFD frequency domain resource(s), receiving, from the BS, a channel state information (CSI) reporting configuration, and determining a CSI reporting band for reporting CSI associated with the CSI reporting configuration based on the SBFD frequency domain resource(s).

In accordance with another aspect of the disclosure, a base station (BS) in a wireless communication system, is provided. The BS includes a transceiver, and a controller coupled with the transceiver and configured to transmit, to a user equipment (UE), configuration information for subband non-overlapping full-duplex (SBFD), wherein the configuration information indicates SBFD frequency domain resource(s), transmit, to the UE, a channel state information (CSI) reporting configuration, and receive, from the UE, CSI associated with a CSI reporting band, wherein the CSI reporting band is determined based on the SBFD frequency domain resource(s).

The method provided by the disclosure may improve the performance of CSI, and further improve the scheduling efficiency of the communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an overall structure of an example wireless communication network according to an embodiment of the disclosure;

FIGS. 2A and 2B respectively illustrate a transmission path and a reception path in a wireless communication network according to various embodiments of the disclosure;

FIGS. 3A and 3B respectively illustrate the structures of a user equipment (UE) and a base station in a wireless communication network according to various embodiments of the disclosure;

FIG. 4 illustrates a method performed by a user equipment (UE) according to an embodiment of the disclosure;

FIG. 5 illustrates a method performed by a base station according to an embodiment of the disclosure;

FIG. 6 illustrates a structure of a user equipment according to an embodiment of the disclosure; and

FIG. 7 illustrates a structure of a base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In order to meet the increasing demand for wireless data communication services since the deployment of fourth generation (4G) communication systems, efforts have been made to develop improved 5G or pre-5G communication systems. Therefore, 5G or pre-5G communication systems are also called “Beyond 4G networks” or “Post-long term evolution (LTE) systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive a plurality of-input a plurality of-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (COMP), reception-end interference cancellation, etc.

In 5G systems, hybrid frequency shift keying (FSK) and quadrature amplitude modulation (QAM) (FQAM) and sliding window superposition coding (SWSC) as advanced coding modulation (ACM), and filter bank multicarrier (FBMC), non-orthogonal a plurality of access (NOMA) and sparse code a plurality of access (SCMA) as advanced access technologies have been developed.

The transmission from a base station to a user equipment (UE) is called downlink, and the transmission from the UE to the base station is called uplink.

When describing the embodiments of the disclosure, descriptions related to technical content that are well known in the field and not directly related to the disclosure will be omitted.

For the same reason, some elements may be exaggerated, omitted or schematically shown in the drawings. In addition, the size of each component does not fully reflect the actual size. In the drawings, the same or corresponding elements have the same reference numerals.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

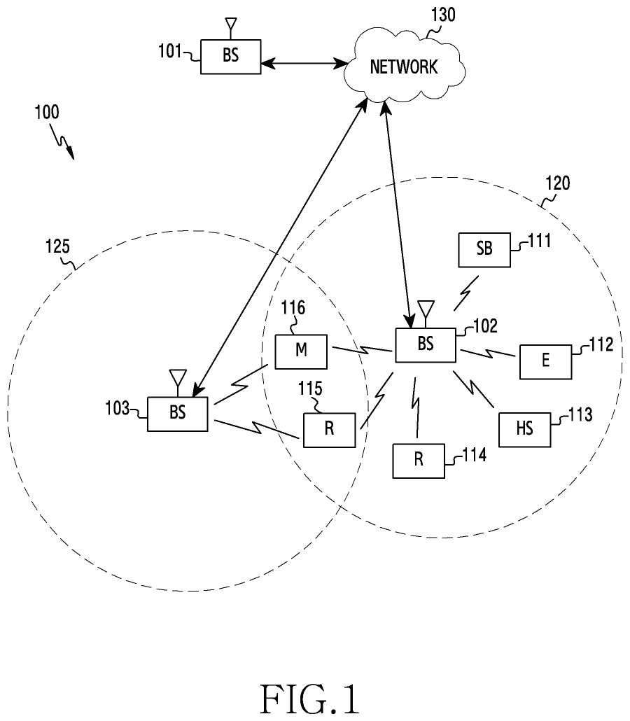

FIG. 1 illustrates an example wireless network according to an embodiment of the disclosure.

The embodiment of the wireless network shown in FIG. 1 is for illustration only. Other embodiments of the wireless network can be used without departing from the scope of the disclosure.

Referring to FIG. 1, a wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless wideband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a Wi-Fi Hotspot (HS); a UE 114, which may be located in a first residence (R); a UE 115, which may be located in a second residence (R); a UE 116, which may be a mobile device (M), such as a cellular phone, a wireless laptop computer, a wireless personal digital assistant (PDA), etc. gNB 103 provides wireless wideband access to the network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-advanced (LTE-A), WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on Configurations of the gNBs and changes in the radio environment associated with natural obstacles and man-made obstacles.

As will be described in more detail below, one or more of gNB 101, gNB 102, and gNB 103 include a two-dimensional (2D) antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless wideband access to the network 130 for those UEs. Similarly, each gNB 102-103 can directly communicate with the network 130 and provide direct wireless wideband access to the network 130 for the UEs. In addition, gNB 101, 102 and/or 103 can provide access to other or additional external networks, such as external telephone networks or other types of data networks.

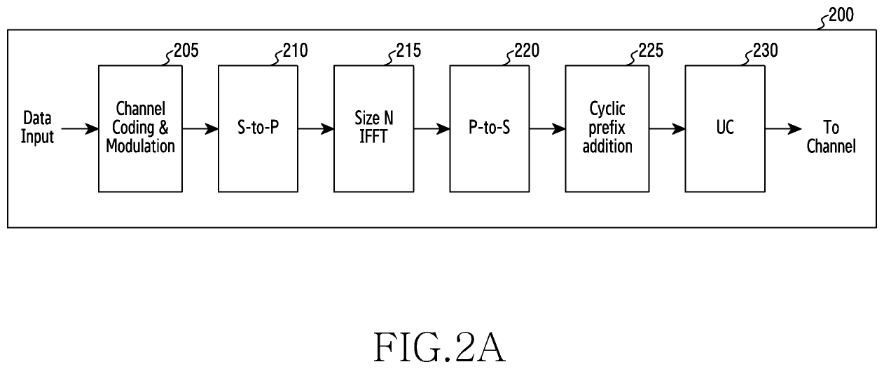

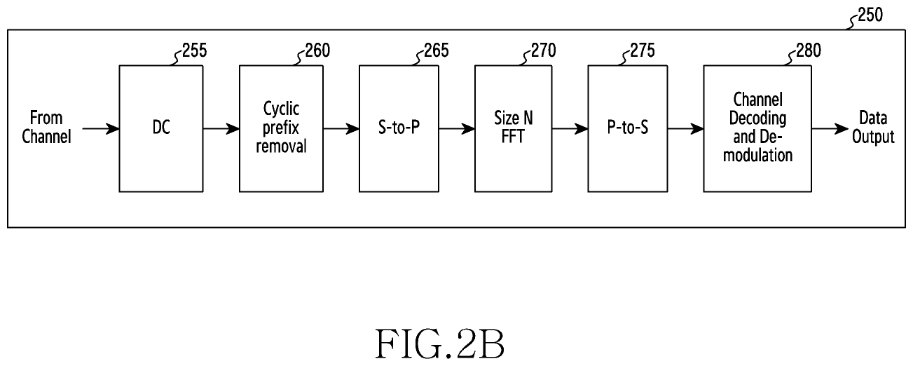

FIGS. 2A and 2B illustrate example wireless transmission and reception paths according to various embodiments of the disclosure.

In the following description, transmission path 200 can be described as being implemented in a gNB, such as gNB 102, and reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

Referring to FIGS. 2A and 2B, a transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. A reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as a plurality of xes) serial modulated symbols into parallel data to generate N parallel symbol streams, where Nis a size of the IFFT/FFT used in gNB 102 and UE 116. The size N IFFT block 215 performs IFFT operations on the N parallel symbol streams to generate a time domain output signal. The Parallel-to-Serial (P-to-S) block 220 converts (such as a plurality of xes) parallel time domain output symbols from the Size N IFFT block 215 to generate a serial time domain signal. The cyclic prefix addition block 225 inserts a cyclic prefix into the time domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter (DC) 255 down-converts the received signal to a baseband frequency, and the cyclic prefix removal block 260 removes the cyclic prefix to generate a serial time domain baseband signal. The Serial-to-Parallel (S-to-P) block 265 converts the time domain baseband signal into a parallel time domain signal. The Size N FFT block 270 performs an FFT algorithm to generate N parallel frequency-domain signals. The Parallel-to-Serial (P-to-S) block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in Configurable hardware or a combination of software and Configurable hardware. For example, the FFT block 270 and IFFT block 215 may be implemented as Configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

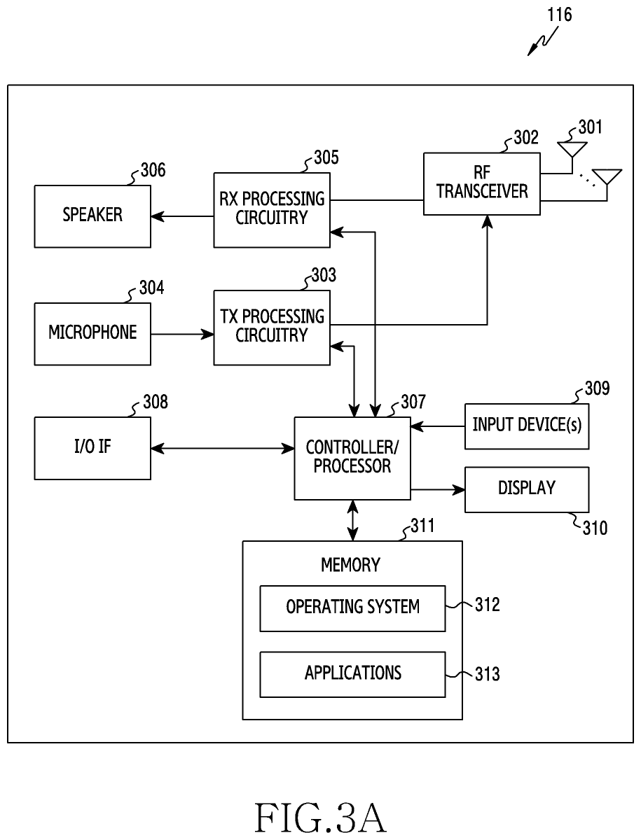

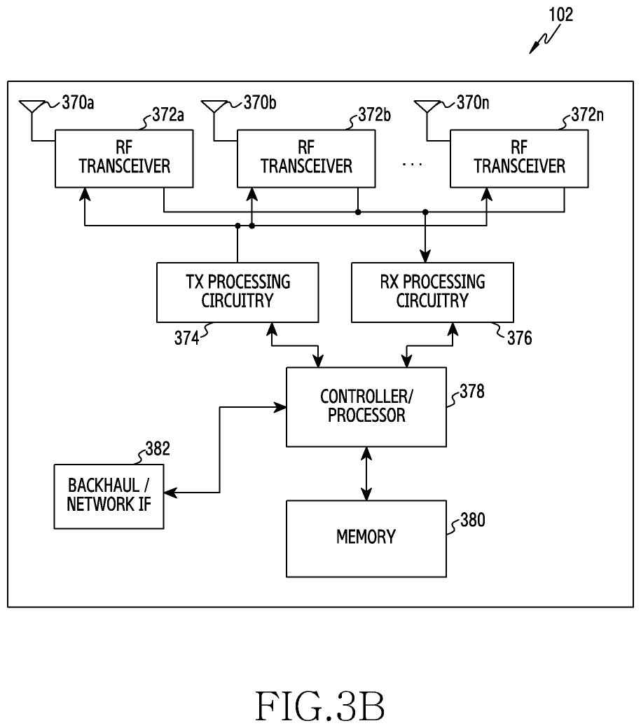

FIG. 3A illustrates an example UE according to an embodiment of the disclosure.

The embodiment of UE 116 shown in FIG. 3A is for illustration only, and UEs 111-115 of FIG. 1 can have the same or similar Configuration. However, a UE has various Configurations, and FIG. 3A does not limit the scope of the disclosure to any specific implementation of the UE.

Referring to FIG. 3A, UE 116 includes an antenna 301, a radio frequency (RF) transceiver 302, transmission (TX) processing circuitry 303, a microphone 304, and reception (RX) processing circuitry 305. UE 116 also includes a speaker 306, a controller/processor 307, an input/output (I/O) interface 308, an input device(s) 309, a display 310, and memory 311. The memory 311 includes an operating system (OS) 312 and one or more applications 313.

The RF transceiver 302 receives an incoming RF signal transmitted by a gNB of the wireless network 100 from the antenna 301. The RF transceiver 302 down-converts the incoming RF signal to generate an intermediate frequency (IF) or baseband signal. The IF or baseband signal is transmitted to the RX processing circuitry 305, where the RX processing circuitry 305 generates a processed baseband signal by filtering, decoding and/or digitizing the baseband or IF signal. The RX processing circuitry 305 transmits the processed baseband signal to speaker 306 (such as for voice data) or to controller/processor 307 for further processing (such as for web browsing data).

The TX processing circuitry 303 receives analog or digital voice data from microphone 304 or other outgoing baseband data (such as network data, email or interactive video game data) from controller/processor 307. The TX processing circuitry 303 encodes, multiplexes, and/or digitizes the outgoing baseband data to generate a processed baseband or IF signal. The RF transceiver 302 receives the outgoing processed baseband or IF signal from the TX processing circuitry 303 and up-converts the baseband or IF signal into an RF signal transmitted via the antenna 301.

The controller/processor 307 can include one or more processors or other processing devices and execute an OS 312 stored in the memory 311 in order to control the overall operation of UE 116. For example, the controller/processor 307 can control the reception of forward channel signals and the transmission of backward channel signals through the RF transceiver 302, the RX processing circuitry 305 and the TX processing circuitry 303 according to well-known principles. In some embodiments, the controller/processor 307 includes at least one microprocessor or microcontroller.

The controller/processor 307 is also capable of executing other processes and programs residing in the memory 311, such as operations for channel quality measurement and reporting for systems with 2D antenna arrays as described in embodiments of the disclosure. The controller/processor 307 can move data into or out of the memory 311 as required by an execution process. In some embodiments, the controller/processor 307 is configured to execute the one or more applications 313 based on the OS 312 or in response to signals received from the gNB or the operator. The controller/processor 307 is also coupled to an I/O interface 308, where the I/O interface 308 provides UE 116 with the ability to connect to other devices such as laptop computers and handheld computers. I/O interface 308 is a communication path between these accessories and the controller/processor 307.

The controller/processor 307 is also coupled to the input device(s) 309 and the display 310. An operator of UE 116 can input data into UE 116 using the input device(s) 309. The display 310 may be a liquid crystal display or other display capable of presenting text and/or at least limited graphics (such as from a website). The memory 311 is coupled to the controller/processor 307. A part of the memory 311 can include random access memory (RAM), while another part of the memory 311 can include flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the controller/processor 307 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be Configured to operate as other types of mobile or fixed devices.

FIG. 3B illustrates an example gNB according to an embodiment of the disclosure.

The embodiment of gNB 102 shown in FIG. 3B is for illustration only, and other gNBs of FIG. 1 can have the same or similar Configuration. However, a gNB has various Configurations, and FIG. 3B does not limit the scope of the disclosure to any specific implementation of a gNB. It should be noted that gNB 101 and gNB 103 can include the same or similar structures as gNB 102.

Referring to FIG. 3B, a gNB 102 includes a plurality of antennas 370a and 370b-370n, a plurality of RF transceivers 372a and 372b-372n, a transmission (TX) processing circuitry 374, and a reception (RX) processing circuitry 376. In certain embodiments, one or more of the plurality of antennas 370a-370n include a 2D antenna array. gNB 102 also includes a controller/processor 378, memory 380, and a backhaul or network interface 382.

RF transceivers 372a-372n receive an incoming RF signal from antennas 370a-370n, such as a signal transmitted by the UEs or other gNBs. RF transceivers 372a-372n down-convert the incoming RF signal to generate an IF or baseband signal. The IF or baseband signal is transmitted to the RX processing circuitry 376, where the RX processing circuitry 376 generates a processed baseband signal by filtering, decoding and/or digitizing the baseband or IF signal. RX processing circuitry 376 transmits the processed baseband signal to controller/processor 378 for further processing.

The TX processing circuitry 374 receives analog or digital data (such as voice data, network data, email or interactive video game data) from the controller/processor 378. TX processing circuitry 374 encodes, a plurality of xes and/or digitizes outgoing baseband data to generate a processed baseband or IF signal. RF transceivers 372a-372n receive the outgoing processed baseband or IF signal from TX processing circuitry 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuitry 376 and the TX processing circuitry 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include flash memory or other ROMs. In certain embodiments, a plurality of instructions, such as the BIS algorithm, are stored in the memory. The plurality of instructions are Configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuitry 374 and/or RX processing circuitry 376) support aggregated communication with frequency division duplex (FDD) cells and time division duplex (TDD) cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuitry 374 and a single instance of the RX processing circuitry 376, gNB 102 can include a plurality of instances of each (such as one for each RF transceiver).

In the disclosure, the term “CSI reporting configuration” may be used interchangeably with the terms “CSI reporting configuration information” and “information for CSI reporting configuration” and “information for configuring CSI report”. In the disclosure, the term “CSI” may be used interchangeably with the terms “CSI parameter” or “CSI quantity”. In the disclosure, the term “mapping order of CSI” may be used interchangeably with the terms “order of CSI” or “order of CSI information bits” or “order of CSI field”. In the disclosure, the term “CSI transmission occasion” may be used interchangeably with the term “CSI reference signal (CSI-RS) occasion”. In the disclosure, the term “CSI interference measurement (CSI-IM) occasion” may be used interchangeably with the term “CSI-IM transmission occasion”. The CSI may include at least one of the followings:
CSI-RS Resource Indicator (CRI);
Rank Indicator (RI);
Precoding Matrix Indicator (PMI);
Channel quality indicator (CQI);
Layer indicator (LI);
Synchronization Signal/Physical Broadcast Channel (SSB) Block Resource indicator (SSBRI);
Layer 1-Reference Signal Received Power (L1-RSRP);
Layer 1-Signal to Interference and Noise Ratio (L1-SINR);
CapabilityIndex.

In some cases, the base station may enhance the coverage of the communication system or reduce the latency through duplex. Duplex may include subband non-overlapping full duplex (SBFD). For example, a subband non-overlapping full duplex mode may be adopted in a time division duplex (TDD) frequency band (for example, in an unpaired spectrum). Subband non-overlapping duplex may refer to dividing the bandwidth (e.g., carrier bandwidth) of a communication node (e.g., a base station) into more than one subband (e.g., without overlapping between subbands), and uplink and downlink communication may be performed simultaneously on different subbands.

In the disclosure, the term “SBFD configuration information” may be used interchangeably with “configuration information for SBFD”.

In the disclosure, the term “subband non-overlapping duplex” may be used interchangeably with “subband full duplex”.

In the disclosure, the term “frequency domain resource corresponding to uplink subband” may be used interchangeably with the terms “frequency domain position corresponding to uplink subband” or “frequency domain resource of uplink subband” or “frequency domain resource for uplink” or “frequency domain position for uplink” or “frequency domain position for uplink transmission” or “frequency domain position for uplink transmission”.

In the disclosure, the term “frequency domain resource corresponding to downlink subband” may be used interchangeably with the terms “frequency domain position corresponding to downlink subband” or “frequency domain resource of downlink subband” or “frequency domain resource for downlink” or “frequency domain position for downlink” or “frequency domain position for downlink reception” or “frequency domain position for downlink reception”.

In the disclosure, the term “frequency domain resource corresponding to guardband” may be used interchangeably with the terms “frequency domain position corresponding to guardband” or “frequency domain resource of guardband” or “frequency domain resource between (boundaries of) uplink and downlink subbands” or “frequency domain position between (boundaries of) uplink and downlink subbands” or “frequency domain resource for protecting/isolating uplink subband and downlink subband”.

In the disclosure, the term “Time Division Duplex (TDD) configuration information” may be used interchangeably with the terms “TDD uplink/downlink configuration information” or “information for configuring slot format”.

In the disclosure, the frequency domain resource(s) may include/correspond to several frequency domain units. The frequency domain unit may be at least one of a subcarrier, a carrier, a frequency band, a frequency range (FR), a cell, and a serving cell, and the frequency domain unit is not limited by the disclosure. Optionally, the frequency range may be frequency range 1, frequency range 2 (for example, frequency range 2-1 and/or frequency range 2-2).

In the disclosure, a time domain unit may be at least one of a symbol, a sub-slot, a slot, a subframe, a frame, a millisecond, and a second.

In the disclosure, “bandwidth part (BWP)” may be used interchangeably with “active BWP” and “BWP on SBFD cell”.

In the disclosure, the term “SBFD cell” may be used interchangeably with the term “first cell”, but the name of “SBFD cell” is not limited by the disclosure.

In the disclosure, “determining measurement” may be determining the result of the measurement, or obtaining the result of the measurement, or obtaining the measurement based on the reference signal, or obtaining the measurement based on measurement resources, or obtaining the measurement for determining CSI.

In the disclosure, “determining channel measurement” may be determining the result of the channel measurement, or obtaining the result of the channel measurement, or obtaining the channel measurement based on the reference signal, or obtaining the channel measurement based on measurement resources, or obtaining the channel measurement for determining CSI.

In the disclosure, “determining interference measurement” may be determining the result of the interference measurement, or obtaining the result of the interference measurement, or obtaining the interference measurement based on the reference signal, or obtaining the interference measurement based on measurement resources, or obtaining the interference measurement for determining CSI.

In the disclosure, the term “uplink channel associated with CSI report” may be used interchangeably with the terms “uplink channel associated with/corresponding to CSI report” or “uplink channel carrying CSI report”.

In the disclosure, the term “SBFD cell” may be used interchangeably with “SBFD serving cell”.

In the disclosure, the term “CSI subband” may be used interchangeably with the terms “CSI reporting subband” or “subband for CSI reporting” or “subband for CSI report” or “subband associated with CSI”.

In the disclosure, the term “CSI subbands in BWP” may be used interchangeably with the terms “CSI subbands overlapping with BWP” or “CSI subbands overlapping with BWP frequency domain” or “CSI subbands partially/completely overlapping with BWP frequency domain”. In the disclosure, the term “CSI subbands in downlink subband associated with SBFD configuration information” may be used interchangeably with the terms “CSI subbands overlapping with downlink subband associated the SBFD configuration information” or “CSI subbands partially/completely overlapping with downlink subband associated with SBFD configuration information”.

In the disclosure, the term “possible CSI subband sizes” may be used interchangeably with the term “configurable CSI subband sizes”.

In the disclosure, the term “size of configured CSI subband” may be used interchangeably with the term “size of first CSI subband”.

In the disclosure, the term “frequency domain resource(s) of CSI subband” may be used interchangeably with the terms “frequency domain resource(s) associated with CSI subband” and “frequency domain resource(s) corresponding to CSI subband”.

In the disclosure, the term “CSI” may be used interchangeably with the term “CSI value”. In the disclosure, the term “SBFD time resources” may be used interchangeably with the term “SBFD time resources”. In the disclosure, “CSI resource setting associated with CSI reporting configuration” may be used interchangeably with the terms “CSI resource setting corresponding to CSI reporting configuration” or “resources associated with CSI reporting configuration” or “measurement associated with CSI reporting configuration” or “measurement resources associated with CSI reporting configuration” or “resources for channel measurement and/or interference measurement associated with CSI reporting configuration” or “resources for channel measurement associated with CSI reporting configuration” or “resources associated with CSI resource setting” or “reference signal resource associated with CSI resource setting” or “resources in resource set associated with CSI resource setting” or “reference signal resource in resource set associated with CSI resource setting” or “reference signal resource in resource set associated with CSI reporting configuration”. In the disclosure, the term “cell discontinuous transmission (DTX) is activated” may be used interchangeably with the terms “cell DTX is configured” or “cell DTX is configured and/or activated”. In the disclosure, “quasi-co-location (QCL) parameter” may be used interchangeably with the terms “transmission configuration indication (TCI) state” or “QCL assumption” or “QCL type D parameter”. In the disclosure, the term “L1-RSRP” may be used interchangeably with the term “L1-RSRP value”. In the disclosure, the term “discontinuous reception (DRX)” may be used interchangeably with “UE DRX” or “connected state DRX (C-DRX)”.

In the disclosure, the term “reference signal resource” may be used interchangeably with the terms “reference signal” or “reference signal occasion” or “reference signal resource occasion”. Optionally, the reference signal may be at least one of CSI-RS, CSI-IM and SSB. Optionally, the reference signal may be at least one of non-zero power (NZP) CSI-RS, CSI-IM and SSB.

In the disclosure, the term “subset of CSI subbands” may be used interchangeably with the terms “subset of a group of CSI subbands” or “subset of a group of subbands” or “subset in a group of subbands”.

In the disclosure, the term “PRBs included in/corresponding to a PRB subset being non-consecutive” may be used interchangeably with the terms “all PRBs included in/corresponding to a PRB subset being non-consecutive” or “all PRBs included in/corresponding to a PRB subset being not consecutive in frequency domain” or “numbers of all PRBs included in/corresponding to a PRB subset being non-consecutive” or “numbers of all PRBs included in/corresponding to a PRB subset being not non-consecutive” or “the number of all PRBs included in/corresponding to a PRB subset being less than (or not equal to) the difference between the corresponding PRB with the highest CRB/PRB number and the corresponding PRB with the lowest CRB/PRB number in (all) PRBs included in/corresponding to the PRB subset”.

Embodiments of the disclosure will be described below in detail with reference to accompanying drawings.

The UE may receive/obtain/be configured with SBFD configuration information. Optionally, the UE may receive/obtain/be configured with the SBFD configuration information via common signaling (e.g., common radio link control (RRC) signaling) or specific signaling (e.g., specific RRC signaling). Optionally, the SBFD configuration information may be configuration information associated with the SBFD. For example, the SBFD configuration information may be configuration information for the SBFD. For example, the SBFD configuration information may be configuration information associated with SBFD operation (of the base station). For example, the SBFD configuration information may be configuration information for indicating time domain resource(s) and/or frequency domain resource(s) associated with the SBFD operation. Optionally, the UE receives the SBFD configuration information in RRC_CONNECTED state. Optionally, the UE may receive the SBFD configuration information in RRC_IDLE/RRC_INACTIVE state.
Optionally, a cell (e.g., serving cell) corresponding to/associated with the SBFD configuration information/where the SBFD configuration information is located/for may be called an SBFD cell.
Optionally, the cell corresponding to/associated with the SBFD configuration information may be a cell that performs the SBFD operation associated with the SBFD configuration. Optionally, the cell corresponding to/associated with the SBFD configuration information may be a primary cell (e.g., PCell) or a special cell (e.g., a SpCell). Optionally, the cell corresponding to/associated with the SBFD configuration information may be a secondary cell (e.g., SCell). Optionally, the cell corresponding to/associated with the SBFD configuration information may be a cell where the time domain resource(s) and/or frequency domain resource(s) associated with the SBFD configuration information are located/correspond to. Optionally, the cell corresponding to/associated with the SBFD configuration information may be a cell where time domain resource configuration and/or frequency domain resource configuration associated with the SBFD configuration information are applied/used.
Optionally, the SBFD configuration information may indicate/correspond to/be associated with frequency domain resource(s) and/or (corresponding/associated) time domain resource(s). Optionally, the time domain resource(s) corresponding to/associated with the frequency domain resource(s) refer to the time domain resource(s) on which the frequency domain resource(s) configured by the SBFD configuration information i is applicable/effective/workable. Optionally, the time domain resource(s) corresponding to/associated with the frequency domain resource(s) refers to the time domain resource(s) on which the frequency domain resource(s) configured by the SBFD configuration information is applicable/usable (by the UE).
Optionally, the SBFD configuration information may indicate the frequency domain resource(s) (associated with/corresponding to SBFD time domain resource(s)). The frequency domain resource(s) indicated by/configured by/associated with the SBFD configuration information may be called SBFD frequency domain resource(s). Optionally, the SBFD configuration information may indicate at least one of frequency domain resource(s) corresponding to the uplink subband, frequency domain resource(s) corresponding to the downlink subband(s), and frequency domain resource(s) corresponding to the guardband. Optionally, the SBFD frequency domain resource(s) may include at least one of frequency domain resource(s) corresponding to uplink subband, frequency domain resource(s) corresponding to downlink subband(s), and frequency domain resource(s) corresponding to the guardband(s). Optionally, the frequency domain resource(s) corresponding to the uplink subband may include one or more consecutive PRBs, or a group of consecutive PRBs. Optionally, the frequency domain resource(s) corresponding to the downlink subband(s) may include one or more PRBs, or one or two groups of consecutive PRBs. Optionally, the frequency domain resource(s) corresponding to the guardband may include one PRB or a group of consecutive PRBs or two groups of consecutive PRBs. Optionally, the uplink subband may be a subband for uplink (e.g., uplink transmission). Optionally, the uplink subband may be frequency domain resource(s) for uplink (e.g., uplink transmission). Optionally, the downlink subband(s) may be a subband for downlink (e.g., downlink reception). Optionally, the downlink subband(s) may be frequency domain resource(s) for downlink (e.g., downlink reception). Optionally, the UE may determine the frequency domain resource(s) corresponding to the guardband based on the frequency domain resource(s) corresponding to the uplink subband and/or the frequency domain resource(s) corresponding to the downlink subband(s) (and the carrier bandwidth of the SBFD cell). Optionally, the UE may determine the frequency domain resource(s) corresponding to the downlink subband(s) based on the frequency domain resource(s) corresponding to the uplink subband and/or the frequency domain resource(s) corresponding to the guardband (and the carrier bandwidth of the SBFD cell). Optionally, the frequency domain resource(s) corresponding to the downlink subband(s) may include one or more PRBs, or one or two groups of consecutive PRBs.
Optionally, the SBFD frequency domain resource(s) are determined based on the SBFD configuration information and a reference subcarrier spacing parameter indicated by TDD configuration information (for example, the reference subcarrier spacing parameter referenceSubcarrierSpacing included in the TDD configuration information). For example, the SBFD frequency domain resource(s) are determined based on (a parameter associated with the frequency domain resource(s) indicated by) the SBFD configuration information and the reference subcarrier spacing parameter (for example, referenceSubcarrierSpacing) included in the TDD configuration information (for the cell). This method may reuse the parameter indicated by the TDD configuration information to determine the SBFD frequency domain resource(s), thus saving signaling overhead and improving the efficiency of the communication system.
Optionally, the SBFD frequency domain resource(s) are determined based on the reference subcarrier spacing parameter indicated by the SBFD configuration information (for example, the reference subcarrier spacing parameter included in the SBFD configuration information). For example, the SBFD time domain resource(s) are determined based on the reference subcarrier spacing parameter (e.g., referenceSubcarrierSpacing) included in the SBFD configuration information. This method may use the SBFD configuration information to determine the SBFD frequency domain resource(s), to facilitate the base station to perform the SBFD operation flexibly and improve the efficiency of the communication system.
Optionally, on the SBFD time domain resource(s), the part of the uplink BWP in the frequency domain resource(s) corresponding to the uplink subband associated with the SBFD frequency domain resource(s) may be/is allowed for uplink transmission. Optionally, on the SBFD time domain resource(s), the part of the uplink BWP not in the frequency domain resource(s) corresponding to the uplink subband associated with the SBFD frequency domain resource(s) may not be/is not allowed for uplink transmission. This method clarifies scheduling restrictions based on the SBFD configuration, to facilitate the base station to schedule flexibly and improve the efficiency of the communication system.
Optionally, on the SBFD time domain resource(s), the part of the downlink BWP in the frequency domain resource(s) corresponding to the downlink subband(s) associated with the SBFD frequency domain resource(s) may be/is allowed for downlink reception. Optionally, on the SBFD time domain resource(s), the part of the downlink BWP not in the frequency domain resource corresponding to the downlink subband(s) associated with the SBFD frequency domain resource(s) may not be/is not allowed for downlink reception. This method clarifies scheduling restrictions based on the SBFD configuration, to facilitate the base station to schedule flexibly and improve the efficiency of the communication system.
Optionally, the SBFD configuration information may indicate/configure/be associated with the time domain resource(s). The time domain resource(s) indicated by/configured by/associated with the SBFD configuration information may be called the SBFD time domain resource(s). Time domain resource(s) other than SBFD time domain resource(s) (or a part of time domain resource(s) other than SBFD time domain resource(s)) may be called the non-SBFD time domain resource(s); optionally, time domain resource(s) that are not the SBFD time domain resource(s) may be called the non-SBFD time domain resource(s); optionally, the time domain resource(s) outside the SBFD time domain resource(s) and within the downlink slots/symbols and/or flexible slots/symbols indicated/configured by the base station are called the non-SBFD time domain resource(s), or the time domain resource(s) within the uplink slots/symbols indicated/configured by the base station are called the non-SBFD time domain resource(s). The SBFD time domain resource(s) may include several time domain units. Optionally, the SBFD time domain resource(s) are not on the uplink slots and/or uplink symbols indicated by the common information. Optionally, the SBFD time domain resource(s) are on the downlink slots and/or downlink symbols indicated by the base station, and/or the SBFD time domain resource(s) are on the flexible slots and/or flexible symbols indicated/configured by the base station. Optionally, the non-SBFD time domain resource(s) are not on the uplink slots or uplink symbols indicated by the common information. Optionally, the non-SBFD time domain resource(s) are on the downlink slots and/or downlink symbols indicated by the base station, and/or the non-SBFD time domain resource(s) are on the flexible slots and/or flexible symbols indicated/configured by the base station. Optionally, the UE may obtain at least one of the uplink symbols, uplink slots, downlink symbols, downlink slots, flexible symbols and flexible slots indicated by the base station via the TDD configuration information. The TDD configuration information includes: cell specific TDD configuration information (for example, tdd-UL-DL-ConfigurationCommon) and/or UE-specific TDD configuration information (tdd-UL-DL-ConfigurationDedicated).
Optionally, the SBFD time domain resource(s) are determined based on the SBFD configuration information and the reference subcarrier spacing parameter indicated by the TDD configuration information (for example, the reference subcarrier spacing parameter referenceSubcarrierSpacing included in the TDD configuration information). For example, the SBFD time domain resource(s) are determined based on (the parameter associated with the time domain resource(s) indicated by) the SBFD configuration information and the reference subcarrier spacing parameter (for example, referenceSubcarrierSpacing) included in the TDD configuration information (for the cell). This method can reuse the parameter indicated by the TDD configuration information to determine the SBFD time domain resource(s), thus saving signaling overhead and improving the efficiency of the communication system.
Optionally, the SBFD time domain resource(s) are determined based on the reference subcarrier spacing parameter indicated by the SBFD configuration information (for example, the reference subcarrier spacing parameter referenceSubcarrierSpacing included in the SBFD configuration information). For example, the SBFD time domain resource(s) are determined based on the reference subcarrier spacing parameter (e.g., referenceSubcarrierSpacing) included in the SBFD configuration information. This method may use the SBFD configuration information to determine the SBFD time domain resource(s), to facilitate the base station to perform SBFD operation flexibly and improve the efficiency of the communication system.
Optionally, on a BWP, if a symbol/slot partially overlaps with the SBFD time domain resource(s), the symbol/slot may not be used/allowed for transmission/reception. Optionally, on a BWP, if a symbol/slot completely overlaps with the SBFD time domain resource(s), the symbol/slot may be used/allowed for transmission/reception. This method clarifies scheduling restrictions based on the SBFD configuration, to facilitate the base station to schedule flexibly and improve the efficiency of the communication system.

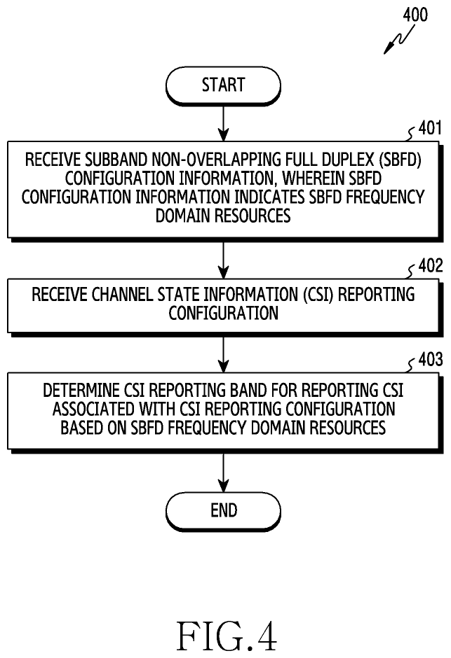

FIG. 4 illustrates a method performed by a user equipment (UE) according to an embodiment of the disclosure.

Referring to FIG. 4, a method 400 includes: at operation 401, the UE receives subband non-overlapping full duplex (SBFD) configuration information from a base station, wherein the SBFD configuration information indicates SBFD frequency domain resource(s); at operation 402, the UE receives a channel state information (CSI) reporting configuration from the base station; and at operation 403, the UE determines a CSI reporting band for reporting CSI associated with the CSI reporting configuration based on the SBFD frequency domain resource(s).

The UE may receive/be configured with the CSI reporting configuration (e.g., CSI-ReportConfig). Optionally, the CSI reporting configuration may be associated with one or more CSI resource settings (e.g., CSI-ResourceConfig). Optionally, the CSI resource setting may include CSI resource setting for channel measurement and/or CSI resource setting for interference measurement. Optionally, the CSI resource setting may correspond to/include/be associated with one or more resource sets. Optionally, the CSI resource setting may correspond to/include at least one of CSI-RS resources, CSI-IM resources and SSB resources. Optionally, the resource set may include several resources. Optionally, the resource set may include/correspond to at least one of CSI-RS resources, CSI-IM resources and SSB resources. For example, the UE may determine and/or report the CSI associated with the CSI reporting configuration based on the measurement of the resources associated with the CSI resource setting associated with the CSI reporting configuration. For example, the UE may determine and/or report the CSI associated with the CSI reporting configuration based on the measurement of the resources in the resource set associated with the CSI reporting configuration.

In some cases, optionally, a carrier (e.g., the carrier associated with the SBFD cell) may correspond to/include one or more CSI subbands. Optionally, the CSI subband may be defined as/may correspond to/may be associated with N_{SB} PRBs (for example, N_{SB} consecutive PRBs). Here, the frequency domain unit of the CSI subband for the CSI report takes a PRB as an example, and the frequency domain unit may also be other units, and the disclosure is not limited thereto. Optionally, the frequency domain position associated with the CSI subband (for example, the frequency domain position/frequency domain starting position of consecutive N_{SB} PRBs associated with the CSI subband) is determined based on/with reference to a common resource block (CRB) grid, for example, based on/with reference to the CRB with number of 0. For example, the CRB number corresponding to the starting PRB in consecutive N_{SB} PRBs associated with the CSI subband may be an integer multiple (for example, a non-negative integer multiple or a positive integer multiple) of N_{SB}. Optionally, N_{SB} corresponds to the size of the configured CSI subband. Optionally, the size of the configured CSI subband (for example, N_{SB}) may be determined by the following methods. Optionally, the UE may be configured with one of one or more possible CSI subband sizes via higher-layer signaling. Two possible CSI subband sizes are described below as an example. For example, for CSI reporting, the UE may be configured via higher-layer signaling with one of two possible CSI subband sizes. For example, the CSI reporting configuration may include/be configured with a subband size parameter (e.g., subband size), wherein the subband size parameter may indicate one of two configurable CSI subband sizes. For example, the subband size parameter may indicate one of two values corresponding to two configurable CSI subband sizes. Optionally, the indicated value corresponds to N_{SB}, or the indicated value corresponds to the size of the configured CSI subband. Optionally, the subband size parameter indicates the size of the configured CSI subband. Optionally, the value indicated by the subband size parameter corresponds to N_{SB}. Optionally, if the CSI reporting configuration does not include a CSI reporting band parameter (for example, csi-ReportingBand), the UE ignores the subband size parameter (or the UE ignores the field corresponding to the subband size parameter). Optionally, the configurable CSI subband sizes may be determined based on the BWP and/or the SBFD frequency domain resource(s). Optionally, the BWP is the downlink BWP. Optionally, the BWP is the BWP associated with the CSI reporting configuration. Optionally, the BWP is the BWP corresponding to the CSI resource setting associated with the CSI reporting configuration. For example, the resources associated with the CSI reporting configuration are measured in the BWP.
Method 1: optionally, the configurable CSI subband sizes may be determined based on the number of PRBs included in the BWP. For example, when the number of PRBs included in the BWP is between 24 and 72, the corresponding configurable CSI subband sizes are 4 PRBs and 8 PRBs. For example, when the number of PRBs included in the BWP is between 73 and 144, the corresponding configurable CSI subband sizes are 8 PRBs and 16 PRBs. For example, when the number of PRBs included in the BWP is between 145 and 275, the corresponding configurable CSI subband sizes are 16 PRBs and 32 PRBs.
Method 2: optionally, the configurable CSI subband sizes may be determined based on the BWP and the SBFD frequency domain resource(s). For example, the configurable CSI subband sizes may be determined based on smaller or larger one of (e.g., the number of PRBs included in) the frequency domain resource(s) included in the BWP and (e.g., the number of PRBs included in) the frequency domain resource(s) included in the downlink subband(s) associated with the SBFD frequency domain resource(s). For example, the configurable CSI subband sizes may be determined based on the intersection (e.g., overlapping part) of the BWP and the downlink subband(s) associated with the SBFD frequency domain resource(s). For example, the configurable CSI subband sizes may be determined based on the number of PRBs in the BWP and in the downlink subband(s) associated with the SBFD frequency domain resource(s). Optionally, the PRB being in the downlink subband(s) refers that the PRB is completely/partially in the downlink subband(s). Optionally, when the number of PRBs determined based on the BWP and the SBFD frequency domain resource(s) is between 24 and 72, the corresponding configurable CSI subband sizes are 4 PRBs and 8 PRBs. Optionally, when the number of PRBs based on the BWP and the SBFD frequency domain resource(s) is between 73 and 144, the corresponding configurable CSI subband sizes are 8 PRBs and 16 PRBs. Optionally, when the number of PRBs based on the BWP and the SBFD frequency domain resource(s) is between 145 and 275, the corresponding configurable CSI subband sizes are 16 PRBs and 32 PRBs. Method 2 may determine the granularity of the CSI subband for the SBFD frequency domain resource(s), improving the flexibility of the communication system.
Optionally, conditions for performing Method 2 may include at least one of the followings: the UE is configured with the SBFD configuration information; the CSI reporting configuration is configured with parameters for enabling Method 2; the first time domain resource(s) are the SBFD time domain resource(s); the first condition. Refer below for specific explanation for “first time domain resource(s)” and “first condition”.

Optionally, the UE receives configuration information (for example, the CSI reporting band parameter csi-ReportingBand). Optionally, the UE may determine/obtain the indicated one or more CSI subbands via the configuration information. Optionally, the UE may determine/obtain the indicated one or more CSI subbands (in a group of the CSI subbands) from the group of the CSI subbands (for example, L CSI subbands) via the configuration information. The number of the CSI subbands included in the one or more CSI subbands is M. Optionally, the one or more CSI subbands (e.g., M CSI subbands) may be referred as the indicated one or more CSI subbands. Optionally, 1≤M≤L. Optionally, the one or more CSI subbands (e.g., M CSI subbands) may be consecutive or non-consecutive. Optionally, the UE may determine the corresponding CSI based on the indicated one or more CSI subbands. Methods associated with the CSI subband are further explained below.

Optionally, the CSI reporting configuration may include/be configured with a parameter for indicating the CSI subband. Optionally, the parameter for indicating the CSI subband being the CSI reporting band parameter (for example, csi-ReportingBand) is taken as an example. Methods for configuration restrictions are described below.
Method 1: optionally, when the PRBs included in the BWP are less than (or equal to) a predefined number of PRBs, the CSI reporting configuration does not include the CSI reporting band parameter. Optionally, when the PRBs included in the BWP are less than (or equal to) the predefined number of PRBs, the CSI reporting configuration has wideband granularity (and, if applicable, the CSI reporting configuration corresponds to/is associated with the type-I single-panel codebook). Optionally, when the PRBs included in the BWP are greater than (or equal to) the predefined number of PRBs, the CSI reporting configuration includes the CSI reporting band parameter. Optionally, the predefined number may be a positive integer. For example, the predefined number may be one of 4, 8, 12, 16, 24, 36, 48.
Method 2: optionally, when the (consecutive) PRBs included in the BWP in the downlink subband(s) associated with the SBFD configuration information are less than (or equal to) the predefined number of PRBs, the CSI reporting configuration does not include the CSI reporting band parameter. Optionally, when the (consecutive) PRBs included in the BWP in the downlink subband(s) associated with the SBFD configuration information are less than (or equal to) the predefined number of PRBs, the CSI reporting configuration has wideband granularity (and, if applicable, the CSI reporting configuration corresponds to/is associated with the type-I single-panel codebook). Optionally, when the (consecutive) PRBs included in the BWP in the downlink subband(s) associated with the SBFD configuration information are greater than (or equal to) the predefined number of PRBs, the CSI reporting configuration includes the CSI reporting band parameter. Optionally, the predefined number may be a positive integer. For example, the predefined number may be one of 4, 8, 12, 16, 24, 36, 48. This method may make the bandwidth available for downlink reception in the BWP (that is, the bandwidth of the BWP in the downlink subband(s) associated with the SBFD configuration information) indicate the subband only when it is greater than or equal to a specific value, avoiding inaccurate CSI caused by measurement bandwidth being too small resulting from subband division under the condition of small bandwidth, thus improving the reliability of the communication system.
Optionally, conditions for performing Method 2 for configuration restrictions may include at least one of the followings: the UE is configured with the SBFD configuration information; the CSI reporting configuration is configured with parameters for enabling Method 2 for configuration restrictions; the first time domain resource(s) are the SBFD time domain resource(s); the first condition. Refer below for specific explanation for “first time domain resource(s)” and “first condition”.

Optionally, the CSI reporting configuration may include/be configured with the parameter for indicating the CSI subband. Optionally, the parameter used to indicate the CSI subbands takes the CSI reporting band parameter (for example, csi-ReportingBand) as an example. CSI subband indication methods are described below.
Method 1: optionally, the CSI reporting configuration may include/be configured with the report frequency domain configuration parameter (for example, reportFreqConfiguration). Optionally, the report frequency domain configuration parameter indicates/includes the CSI reporting band parameter (for example, csi-ReportingBand). Optionally, the CSI reporting band parameter indicates/corresponds to one or more CSI subbands (e.g., M subbands) in the BWP. Optionally, the CSI reporting band parameter indicates/corresponds to one or more consecutive or non-consecutive CSI subbands in the BWP. Optionally, the reported CSI corresponding to the CSI reporting configuration is for the CSI subbands in the downlink subband(s) associated with the SBFD frequency domain resource(s) in the one or more CSI subbands (e.g., M subbands). Optionally, the CSI reporting band corresponding to/associated with the CSI reporting configuration corresponds to/refers to the CSI subbands in the downlink subband(s) associated with the SBFD frequency domain resource(s) in the one or more CSI subbands (e.g., M subbands). Optionally, M CSI subbands include M′ CSI subbands in the downlink subband(s) associated with the SBFD frequency domain resource(s). Optionally, M′≥1. Optionally, the CSI reporting band parameter may include a bitmap. Optionally, the UE may determine the number of the CSI subbands (e.g., L) based on the length of the bitmap. For example, the UE may determine the number of the CSI subbands (e.g., L) in the BWP/corresponding to the bitmap based on the length of the bitmap. Optionally, the UE determines M CSI subbands from L CSI subbands based on the bitmap. Optionally, the CSI reporting band parameter may include the bitmap, wherein each bit in the bitmap represents/indicates a CSI subband, for example, a CSI subband in the BWP. For example, a bit value of “1” indicates that the CSI subband is indicated; a bit value of “0” indicates that the CSI subband is not indicated. Optionally, the first bit corresponds to the CSI subband with the lowest frequency domain position (for example, the lowest CRB number, or the lowest starting/ending CRB number) in the BWP. Optionally, the z′-th bit corresponds to the CSI subband with the z′-th lowest frequency domain position (for example, the z′-th lowest CRB number, or the z′-th lowest starting/ending CRB number) in the BWP, where z′≥1. Optionally, the rightmost bit in the bitmap (or LSB of the bitmap or MSB of the bitmap) represents the lowest/highest CSI subband in the BWP. Optionally, the lowest/highest CSI subband may be the CSI subband with the lowest/highest frequency domain position. Optionally, the lowest/highest CSI subband may be the corresponding CSI subband with the lowest/highest CRB number. Optionally, the leftmost bit in the bitmap (or LSB of the bitmap, or MSB of the bitmap) represents the corresponding CSI subband with the lowest/highest frequency domain position in the BWP or with lowest/highest CRB number.
Optionally, methods for determining the CSI reporting band associated with the CSI subband indication Method 1, for example, methods for determining the CSI reporting band based on a subset of the indicated CSI subbands, are described below. Optionally, the CSI reporting configuration may include/be configured with the report frequency domain configuration parameter (e.g., reportFreqConfiguration). Optionally, the report frequency domain configuration parameter may indicate the frequency domain granularity of the CSI report corresponding to/associated with the CSI reporting configuration. Optionally, the CSI reporting configuration may define the CSI reporting band as the CSI subband(s) that is from the indicated one or more CSI subband(s) and within the downlink subband(s) associated with the SBFD frequency domain resource(s). Optionally, the number of the CSI subbands corresponding to the CSI reporting band is M′. For example, the CSI subbands indicated by the CSI reporting band parameter are {CSI subband #1, CSI subband #2 and CSI subband #4}, where only CSI subband #1 and CSI subband #2 are in the downlink subband(s) associated with the SBFD frequency domain resource(s), then the CSI reporting bands are CSI subband #1 and CSI subband #2.
Optionally, the configuration restrictions associated with the CSI reporting configuration may be at least one of the followings:
Method 1: optionally, all the indicated one or more CSI subbands (e.g., M CSI subbands) are in the downlink subband(s). For example, the UE expects that all the indicated one or more CSI subbands (e.g., M CSI subbands) are in the downlink subband(s). For example, the UE does not expect that at least one CSI subband in the indicated CSI subbands is not in the downlink subband(s).
Method 2: optionally, the UE is not configured with (or is not expected to be configured with)/does not include/does not indicate/does not correspond to the CSI reporting band parameter including the CSI subband, wherein the frequency density of the reference signal (e.g., CSI-RS or CSI-IM) resource associated with the CSI reporting configuration in the CSI subband is less than that with which the configured reference signal resource is configured. Optionally, the frequency density of the reference signal resource refers to the frequency density of each CSI-RS port per PRB. Optionally, the frequency density is determined based on the SBFD frequency domain resource(s). Optionally, the frequency density is determined based on the downlink subband(s) and/or uplink subband associated with the SBFD frequency domain resource(s). Optionally, the frequency density is determined based on the frequency domain resource(s) (e.g., PRBs) in the downlink subband(s) associated with the SBFD frequency domain resource(s) in the CSI subband. Optionally, the frequency density is determined based on the frequency domain resource(s) (e.g., PRBs) other than the uplink subband (and guardband) associated with the SBFD frequency domain resource(s) in the CSI subband.
Method 3: optionally, if the reference signal (e.g., CSI-RS or CSI-IM) resource is associated with the CSI reporting configuration, the UE is not configured with (or is not expected to be configured with)/does not include/does not indicate/does not correspond to the CSI reporting band parameter including the CSI subband, a which is a subband where not all PRBs in the subband have the CSI-IM REs present. Optionally, in the SBFD time domain resource(s), the UE determines/assumes that the reference signal only occurs in the downlink subband(s) associated with the SBFD frequency domain resource(s) in the BWP. For example, in the SBFD time domain resource(s), UE operates on the assumption that reference signal only occurs in the downlink subband(s) associated with the SBFD frequency domain resource(s) in the BWP. Optionally, the UE determines/assumes that the reference signal does not occur outside the downlink subband(s) associated with the SBFD frequency domain resource(s) in the BWP. Optionally, the UE determines/assumes that the reference signal only occurs in the downlink subband(s) associated with the SBFD frequency domain resource(s) in the BWP.
The above configuration restrictions may prevent the one or more CSI subbands indicated by the base station from being outside the downlink subband(s) of SBFD operation, such that all CSI subbands may be measured, thus improving the reliability of the communication system.
Method 2: optionally, the CSI reporting configuration may include/be configured with the report frequency domain configuration parameter (for example, reportFreqConfiguration). Optionally, the report frequency domain configuration parameter indicates/includes the CSI reporting band parameter (for example, csi-ReportingBand). Optionally, the CSI reporting band parameter indicates/corresponds to one or more CSI subbands (e.g., M CSI subbands) in the BWP and within the downlink subband(s) associated with the SBFD. Optionally, the CSI reporting band parameter indicates/corresponds to one or more consecutive or non-consecutive CSI subbands in the BWP and within the downlink subband(s) associated with the SBFD. Optionally, the CSI reporting band parameter indicates/corresponds to one or more CSI subbands in the BWP and outside the uplink subband (and guardband) associated with the SBFD. Optionally, the CSI reporting band parameter indicates/corresponds to one or more consecutive or non-consecutive CSI subbands in the BWP and outside the uplink subband (and guardband) associated with the SBFD. Optionally, the reported CSI corresponding to the CSI reporting configuration is for the one or more CSI subbands (e.g., M subbands). Optionally, the CSI reporting band corresponding to/associated with the CSI reporting configuration corresponds/refers to the one or more CSI subbands (e.g., M subbands). Optionally, the CSI reporting band parameter may include a bitmap, wherein each bit in the bitmap represents/indicates a CSI subband, for example, a CSI subbands in the BWP and in the downlink subband(s) associated with the SBFD. For example, a bit value of “1” indicates that the CSI subband is indicated; a bit value of “0” indicates that the CSI subband is not indicated. Optionally, the UE may determine the number (L) of the CSI subbands based on the length of the bitmap. Optionally, the UE determines the subset from L CSI subbands based on the bitmap. Optionally, the first bit corresponds to the CSI subband with the lowest frequency domain position (for example, the lowest CRB number, or the lowest starting/ending CRB number) in the BWP and in the downlink subband(s) associated with the SBFD. Optionally, the z-th bit corresponds to the CSI subband with the z-th lowest frequency domain position (for example, the z-th lowest CRB number or the z-th lowest starting/ending CRB number) in the BWP and in the downlink subband(s) associated with the SBFD, where z≥1. Optionally, the rightmost bit in the bitmap (or LSB of the bitmap or MSB of the bitmap) represents the lowest/highest CSI subband in the BWP and in the downlink subband(s) associated with the SBFD. Optionally, the lowest/highest CSI subband may be the CSI subband with the lowest/highest frequency domain position. Optionally, the lowest/highest CSI subband may be the corresponding CSI subband with the lowest/highest CRB number. Optionally, the leftmost bit in the bitmap (or LSB of the bitmap or MSB of the bitmap) represents the lowest/highest CSI subband with the lowest/highest frequency domain position (or corresponding CRB number) in the BWP and in the downlink subband(s) associated with the SBFD. CSI subband indication Method 2 may determine the indicated one or more CSI subbands according to the BWP and the SBFD frequency domain resource(s), such that all the indicated CSI subbands may be used for downlink reception, thus improving the efficiency of the communication system.
Optionally, conditions for performing CSI subband indication Method 2 may include at least one of the followings: the UE is configured with the SBFD configuration information; the CSI reporting configuration is configured with parameters for enabling CSI subband indication Method 2; the first time domain resource(s) are the SBFD time domain resource(s); the first condition. Refer below for specific explanation for “first time domain resource(s)” and “first condition”.
Optionally, methods for determining the CSI reporting band associated with CSI subband indication Method 2, for example, methods for determining the CSI reporting bands based on the indicated one or more CSI subbands are described below. Optionally, the CSI reporting configuration may include/be configured with the report frequency domain configuration parameter (e.g., reportFreqConfiguration). Optionally, the report frequency domain configuration parameter may indicate the frequency domain granularity of the CSI report corresponding to/associated with the CSI reporting configuration. Optionally, the CSI reporting configuration may define/correspond that the CSI reporting band is a subset of the CSI subbands. Optionally, the subset of the CSI subbands is the one or more CSI subbands indicated by the CSI reporting band parameter.

Optionally, methods for determining the CSI reporting band, for example, methods for determining the CSI reporting band based on the indicated subset of the CSI subbands are described below. Optionally, the CSI reporting configuration may include/be configured with the report f configuration parameter (e.g., reportFreqConfiguration). Optionally, the report frequency domain configuration parameter may indicate the frequency domain granularity of the CSI report corresponding to/associated with the CSI reporting configuration. Optionally, the CSI reporting configuration may define/correspond that the CSI reporting band is a subset of the CSI subbands. Optionally, the subset of the CSI subbands is indicated by the CSI reporting band parameter. Optionally, the subset of the CSI subbands is the CSI subbands in the downlink subband(s) associated with the SBFD frequency domain configuration information in the CSI subbands indicated by the CSI reporting band parameter. Optionally, the number of the CSI subbands corresponding to/included in the CSI reporting band may be M′.

Methods for determining the frequency domain resource(s) corresponding to the CSI subbands (corresponding to or indicated by the CSI reporting band) is described below. Optionally, the frequency domain resource(s) corresponding to the CSI subbands may be frequency domain resource(s) of the CSI subbands, or frequency domain resource(s) occupied by the CSI subbands, or frequency domain resource(s) for the CSI report corresponding to the CSI subbands. Optionally, the frequency domain resource(s) corresponding to the CSI subbands are determined based on at least one of the configured CSI subband size (N_{SB}), the BWP, and the downlink subband(s) associated with the SBFD frequency domain resource(s). Optionally, the UE determines and/or reports the CSI based on the CSI subbands. Optionally, the UE determines and/or reports the CSI based on the frequency domain resource(s) corresponding to the CSI subbands. Optionally, the UE determines and/or reports the CSI based on M′ CSI subbands. Optionally, the UE determines and/or reports the CSI based on the frequency domain resource(s) corresponding to M′ CSI subbands. Optionally, the UE may determine the frequency domain resource(s) corresponding to the CSI subbands based on at least one of the following methods.
Method 1: optionally, the frequency domain resource(s) corresponding to the CSI subbands are determined based on the PRB subset associated with the CSI subbands. Optionally, the PRB subset may be a part of PRBs of N_{SB} (consecutive) PRBs associated with the CSI subbands. Optionally, the PRB subset includes/corresponds to the PRBs of N_{SB} (consecutive) PRBs in the BWP and in the downlink subband(s) associated with the SBFD frequency domain resource(s). Optionally, the PRB subset includes/corresponds to the PRBs of N_{SB} (consecutive) PRBs that are not outside the BWP and not outside the downlink subband(s) associated with the SBFD frequency domain resource(s). The method for determining the frequency domain resource(s) corresponding to the CSI subbands is that, for example, N_{SB} PRBs associated with subband #m are N_{SB} consecutive PRBs starting from the CRB number of N_{SB,start,m}, where m=0, 1, 2, . . . , M′−1; the frequency domain resource(s) (or the PRB subset) corresponding to subband #m are the PRBs of the PRBs starting from the CRB number of N_{SB,start,m} to the CRB number of N_{SB,start,m}+N_{SB}−1 in the BWP and in the downlink subband(s) associated with the SBFD frequency domain resource(s).
Optionally, if the PRBs included in/corresponding to the PRB subset are non-consecutive, for example, the PRBs included in/corresponding to the PRB subset include/correspond to two or more groups of consecutive PRBs, then the frequency domain resource(s) corresponding to the CSI subbands are based on/are a predefined group of consecutive PRBs in the PRB subset. For example, the frequency domain resource(s) corresponding to the CSI subbands are based on/are a group of consecutive PRBs with the lowest/highest frequency domain position in the PRB subset. For example, the frequency domain resource(s) corresponding to the CSI subbands are based on/are a group of consecutive PRBs with the lowest/highest number (for example, PRB number or CRB number corresponding to the PRB) associated with the starting/ending PRB in the PRB subset. For example, the frequency domain resource(s) corresponding to the CSI subbands are based on/are a group of consecutive PRBs with the largest/smallest number of PRBs in the PRB subset. Because the subband may be divided into non-consecutive PRBs by the BWP and the downlink subband(s), and processing non-consecutive PRBs in the subband will increase the processing complexity of the UE, the method for determining the frequency domain resource(s) corresponding to the CSI subbands based on the PRB subset here may cause the UE measure only consecutive PRBs in the subband, which reduces the processing complexity of the UE and improves the performance of the communication system.
Optionally, the PRBs included in/corresponding to the PRB subset are consecutive. For example, the UE expects that the PRBs included in/corresponding to the PRB subset are consecutive. Because the subband may be divided into non-consecutive PRBs by the BWP and the downlink subband(s), and processing non-consecutive PRBs in the subband will increase the processing complexity of the UE, performing configuration restrictions on the PRB subset here may avoid occurrence of the non-consecutive PRBs in the PRB subset, reducing the processing complexity of the UE and improving the performance of the communication system.
Optionally, conditions for performing Method 1 for determining the frequency domain resource(s) corresponding to the CSI subbands may include at least one of the followings: the UE is configured with the SBFD configuration information; the CSI reporting configuration is configured with parameters for enabling Method 1 for determining the frequency domain resource(s) corresponding to the CSI subbands; the first time domain resource(s) are the SBFD time domain resource(s); the first condition. Refer below for specific explanation for “first time domain resource(s)” and “first condition”.
Method 1 for determining the frequency domain resource(s) corresponding to the CSI subbands clarifies how to determine frequency domain resource(s) corresponding to subbands for CSI reporting based on the SBFD frequency domain resource(s), such that the UE may perform CSI determination and/or reporting in the SBFD downlink band, improving the flexibility of the communication system.

Optionally, the size of the CSI subbands (for example, the actual size of the CSI subbands) is determined based on at least one of the configured CSI subband size (N_{SB}), the BWP and (the downlink subband(s) associated with) the SBFD frequency domain resource(s). The UE may determine the size of the subbands corresponding to the CSI subbands based on at least one of the following methods.
Method 1: optionally, the size of the CSI subbands may be the size of the frequency domain resource(s) corresponding to the CSI subbands. For example, the size of the CSI subbands is the numbers of (consecutive) PRBs in the frequency domain resource(s) corresponding to the CSI subbands. For example, the size of the CSI subbands is the bandwidth of the frequency domain resource(s) corresponding to the CSI subbands. Refer above for the determination method of the frequency domain resource(s)/bandwidth corresponding to the CSI subbands.
Optionally, conditions for performing Method 1 for determining the size of the CSI subbands may include at least one of the followings: the UE is configured with the SBFD configuration information; the downlink subband(s) associated with the SBFD configuration information does not completely overlap with the BWP, or the downlink subband(s) associated with the SBFD configuration information is not completely in the BWP, or the uplink subband (and guardband) associated with the SBFD configuration information is in the BWP; the CSI reporting configuration is configured with parameters for enabling Method 1 for determining the size of the CSI subband; the first time domain resource(s) are the SBFD time domain resource(s); the first condition. Refer below for specific explanation for “first time domain resource(s)” and “first condition”.
Method 2: optionally, the size of the CSI subbands is determined based on the number of PRBs of N_{SB} (consecutive) PRBs associated with the subband in the BWP. For example, the size of the first CSI subband in the BWP may be N_{SB}−(N_{BWP,start} mod N_{SB}), where N_{BWP,start} corresponds/represents the CRB number corresponding to the starting of the BWP, and mod represents the remainder operation. For example, if (N_{BWP,start}+N_{BWP,size}) mod N_{SB} is not equal to 0, the size of the last CSI subband in the BWP may be (N_{BWP,start}+N_{BWP,size}) mod N_{SB}; or in case that (N_{BWP,start}+N_{BWP,size}) mod N_{SB} is equal to 0, the size of the last CSI subband in the BWP may be N_{SB}. Here, N_{BWP,start} corresponds to/represents the number of CRB corresponding to the starting PRB of the BWP. Here, N_{BWP,size} corresponds to/represents the bandwidth of the BWP or the size of the BWP or the number of PRBs included in the BWP. For example, the size of the CSI subbands other than the first CSI subband and the last CSI subbands in the BWP may be N_{SB}.
Optionally, conditions for performing Method 2 for determining the size of the CSI subbands may include at least one of the followings: the UE is configured with the SBFD configuration information; the downlink subband(s) associated with the SBFD configuration information completely overlap with the BWP, or the downlink subband(s) associated with the SBFD configuration information is completely in the BWP, or the uplink subband (and guardband) associated with the SBFD configuration information is not in the BWP; the CSI reporting configuration is configured with parameters for enabling Method 2 for determining the size of the CSI subbands; the first time domain resource(s) are the SBFD time domain resource(s); the first condition. Refer below for specific explanation for “first time domain resource(s)” and “first condition”.

Numbering methods for the CSI subbands and/or CSI reporting/determination methods in some cases, for example, in case that at least one CSI subband of the indicated subset of the CSI subbands (for example, included in the one or more CSI subbands indicated by csi-ReportingBand) is not in the downlink subband(s) associated with the SBFD configuration information, are described below.
Optionally, for CSI reporting, for example, the CSI subbands in the CSI reporting band for the CSI report corresponding to/associated with the CSI reporting configuration may be numbered or renumbered. Optionally, for CSI reporting, the CSI subbands of the indicated one or more CSI subbands (e.g., M subbands) in the downlink subband(s) associated with the SBFD configuration information may be numbered or renumbered. Optionally, the CSI subbands in the CSI reporting band for the CSI report (or the CSI subbands of the indicated one or more CSI subbands in the downlink subband(s) associated with the SBFD configuration information) are numbered continuously. Optionally, the CSI subbands in the CSI reporting band for the CSI report (or the CSI subbands of the indicated one or more CSI subbands in the downlink subband(s) associated with the SBFD configuration information) are numbered continuously in ascending order. Being numbered continuously in ascending order may refer to being numbered continuously in ascending order according to corresponding bit position/frequency domain position. Optionally, the first subband included in the CSI reporting band for the CSI report (or the CSI subbands of the indicated one or more CSI subbands in the downlink subband(s) associated with the SBFD configuration information) may be numbered as subband #0. Optionally, the lowest subband in the CSI reporting band (or the CSI subbands of the indicated one or more CSI subbands in the downlink subband(s) associated with the SBFD configuration information) may be numbered as subband #0. Optionally, the k+1-th subband included in the CSI reporting band (or the CSI subbands of the indicated one or more CSI subbands in the downlink subband(s) associated with the SBFD configuration information) may be numbered as subband #k. Optionally, the k+1-th lowest subband included in the CSI reporting band (or the CSI subbands of the indicated one or more CSI subbands in the downlink subband(s) associated with the SBFD configuration information) may be numbered as subband #k. For example, the subband with the lowest k+1-th bit position (or corresponding frequency domain position) included in the CSI reporting band (or the CSI subbands of the indicated one or more CSI subbands in the downlink subband(s) associated with the SBFD configuration information) may be numbered as subband #k. Optionally, k≥0. Optionally, if the CSI report includes the CSI corresponding to/associated with the CSI subbands, the mapping order of (the CSI fields associated with) the CSI is determined based on the numbers of the above CSI subbands/the numbered CSI subbands/the renumbered CSI subbands. When the indicated one or more CSI subbands are not in the downlink subband(s) associated with the SBFD frequency domain resource(s), continuous numbering based on the indicated one or more CSI subbands will lead to discontinuous subband numbers of the subbands in the CSI reporting band. Because the CSI of odd subbands and the CSI of even subbands need to be processed separately in parallel in some cases, discontinuous numbering will lead to imbalance between odd subbands and even subbands, which will increase the time of parallel computation; the numbering methods ensure the continuity of subband numbering used for CSI reporting, reduces the time for the UE to compute the CSI and improves the efficiency of the communication system.
Optionally, the UE determines wideband CQI reporting and/or subband CQI reporting based on the CSI reporting band. Optionally, the UE may configure wideband CQI reporting or subband CQI reporting via the higher-layer parameter (e.g., cqi-FormatIndicator) included in/corresponding to/associated with the CSI reporting configuration. When wideband CQI is configured, a wideband CQI is reported for one/each codeword for the entire CSI reporting band. When the subband CQI is configured, a CQI (e.g., a subband CQI) is reported for one/each codeword for each subband in the CSI reporting band.
Optionally, the UE determines wideband PMI reporting and/or subband PMI reporting based on the CSI reporting band. Optionally, the UE may configure wideband PMI reporting or subband PMI reporting via higher-layer parameter (e.g., pmi-FormatIndicator) included in/corresponding to/associated with the CSI reporting configuration. When wideband PMI reporting is configured, a wideband PMI is reported for the entire CSI reporting band. When subband PMI reporting is configured, except for the case of two antenna ports, a wideband indicator (e.g., wideband PMI or, i1) is reported for the entire CSI reporting band, and a subband indicator (e.g., subband PMI or, i2) is reported for each subband in the CSI reporting band. In case that the subband PMI is configured and in case of 2 antenna ports, a subband indicator (or a subband PMI) is reported for each subband in the CSI reporting band.

Methods for determining, by the UE, the CSI reporting band in case that the BWP associated with/corresponding to (the CSI reporting setting associated with) the CSI reporting configuration is less than (or less than or equal to) a predefined number of PRBs, or in case that the number of PRBs of the BWP associated with/corresponding to (the CSI reporting setting associated with) the CSI reporting configuration in the downlink subband(s) associated with the SBFD frequency domain resource(s) is less than the predefined number (or less than or equal to the predefined number) are discussed below. Optionally, the predefined number may be a positive integer. For example, the predefined number may be one of 4, 8, 12, 16, 24, 36, 48.
Method 1: the CSI reporting band associated with the CSI reporting configuration is determined based on (the PRBs included in) the BWP and the SBFD frequency domain resource(s). Optionally, the CSI reporting band is a subset of the PRBs in the BWP. Optionally, the PRB subset is based on/refers to (all) the frequency domain resource(s) (for example, PRBs/CRBs) included in the BWP in the downlink subband(s) associated with the SBFD frequency domain resource(s). Optionally, the PRB subset is based on/refers to (all) the frequency domain resource(s) (for example, PRBs/CRBs) included in the BWP outside the uplink subband (and guardband) associated with the SBFD frequency domain resource(s). Optionally, Method 1 for determining the CSI reporting band provides a method for determining the CSI reporting band in the SBFD scenario, which clarifies the frequency domain resource(s) corresponding to the CSI reported by the UE and ensures the reliability of CSI measurement/CSI reporting.
Optionally, if the PRBs included in/corresponding to the PRB subset are non-consecutive (for example, the PRBs included in/corresponding to the PRB subset include/correspond to two or more groups of consecutive PRBs), the CSI reporting band is a predefined group of consecutive PRBs in the PRB subset. For example, the CSI reporting band is a group of consecutive PRBs with the lowest/highest frequency domain position in the PRB subset. For example, the CSI reporting band is a group of consecutive PRBs with the lowest/highest number (for example, PRB number or CRB number corresponding to the PRB) associated with the starting/ending PRB in the PRB subset. For example, the CSI reporting band is a group of consecutive PRBs with the largest/smallest number of PRBs in the PRB subset. Because the PRBs in the BWP may be divided into non-consecutive PRBs by the downlink subband(s), and processing non-consecutive PRBs in the BWP will increase the processing complexity of the UE, the method for determining the frequency domain resource(s) corresponding to the CSI subbands based on the PRB subset here may cause the UE measure only consecutive PRBs in the BWP, which reduces the processing complexity of the UE and improves the performance of the communication system.
Optionally, the PRBs included in/corresponding to the PRB subset are consecutive. For example, the UE expects that the PRBs included in/corresponding to the PRB subset are consecutive. Because the BWP may be divided into non-consecutive PRBs by the downlink subband(s), and processing non-consecutive PRBs in the BWP will increase the processing complexity of the UE, performing configuration restrictions on the PRB subset proposed here can may occurrence of the non-consecutive PRBs in the PRB subset, reducing the processing complexity of the UE and improving the performance of the communication system.
Optionally, conditions for performing Method 1 for determining the CSI reporting band may include at least one of the followings: the UE is configured with the SBFD configuration information; the downlink subband(s) associated with the SBFD configuration information partially overlap with the BWP, or the downlink subband(s) associated with the SBFD configuration information is not completely in the BWP, or the uplink subband (and guardband) associated with the SBFD configuration information in in the BWP; the CSI reporting configuration is configured with parameters for enabling Method 2; the first time domain resource(s) are the SBFD time domain resource(s); the first condition. Refer below for specific explanation for “first time domain resource(s)” and “first condition”.
Method 2: the CSI reporting band associated with the CSI reporting configuration is determined based on (the PRBs included in) the BWP. For example, the CSI reporting band refers to all PRBs included in the BWP. Optionally, all PRBs included in the BWP are in the downlink subband(s) associated with the SBFD frequency domain resource(s). Optionally, the UE expects all PRBs included in the BWP to be in the downlink subband(s) associated with the SBFD frequency domain resource(s). Optionally, the BWP is not outside the downlink subband(s) associated with the SBFD frequency domain resource(s). For example, the UE expects the BWP not to be outside the downlink subband(s) associated with the SBFD frequency domain resource(s). For example, the UE does not expect the BWP to be outside the downlink subband(s) associated with the SBFD frequency domain resource(s). The configuration restriction may prevent the BWP from being outside the downlink subband(s) associated with the SBFD frequency domain resource(s), thus ensuring that the UE has enough bandwidth for CSI measurement/CSI reporting, and ensuring the reliability of CSI measurement/CSI report.

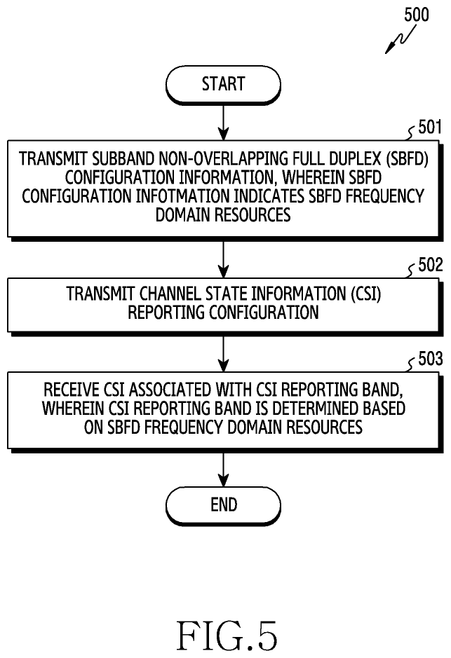

FIG. 5 illustrates a method performed by a base station according to an embodiment of the disclosure.

Referring to FIG. 5, a method 500 includes: at operation 501, the base station transmits subband non-overlapping full duplex (SBFD) configuration information to a user equipment, wherein the SBFD configuration information indicates SBFD frequency domain resource(s); at operation 502, the base station transmits a channel state information (CSI) reporting configuration to the user equipment; and at operation 503, receives CSI associated with a CSI reporting band, wherein the CSI reporting band is determined based on the SBFD frequency domain resource(s).

A method for determining and/or reporting, by the UE, the CSI in case that the UE obtains the SBFD configuration information and the SBFD configuration information indicates the SBFD time domain resource(s) is discussed below. It may be understood that methods 400 and 500 described above may be performed separately or in combination with the CSI determination and/or reporting method by the UE described below. For example, methods 400 and 500 may be performed for the first time domain resource(s) described below, respectively. For example, methods 400 and 500 may be performed when the first time domain resource(s) are the SBFD time domain resource(s), respectively.

In some cases, the UE may be configured with several serving cells. One/each of the several serving cells may be configured with the CSI reporting configuration. Optionally, the serving cell where the UE transmits a CSI report is the same as the serving cell where the CSI reporting configuration corresponding to the CSI report is located. For example, if the UE would transmit the CSI report on a serving cell, the UE determines the CSI report based on the CSI reporting configuration associated with the serving cell. Optionally, the serving cell where the UE transmits the CSI report is the same as the frequency domain unit corresponding to the serving cell where the CSI reporting configuration corresponding to the CSI report is located. For example, if the UE would transmit the CSI report on a serving cell, the UE determines the CSI report based on the CSI reporting configuration in the frequency domain unit (e.g., frequency band) associated with the serving cell. When the serving cell where the CSI reporting configuration (or the CSI report corresponding to the CSI reporting configuration) is located and the SBFD cell are in the same frequency domain unit, the CSI report may be affected by SBFD operation. For example, on the SBFD time domain resource(s) and the non-SBFD time domain resource(s), corresponding interference caused by SBFD is different or components performing SBFD operation are different, thus corresponding transmission/reception parameters are required to overcome the interference or adapt the components performing SBFD operation. The method proposed below may implement the CSI report with different parameters in the SBFD time domain resource(s) and the non-SBFD time domain resource(s), respectively, to reduce performance degradation caused by the SBFD devices or the interference associated with the SBFD, and improve the efficiency of the communication system. In the disclosure, if two cells are in the same frequency band, they may be considered as corresponding to two cells in an intra-band carrier aggregation.

A method for the UE to determine and/or report the CSI based on the CSI reporting configuration and/or determine the parameters associated with the uplink channel carrying the CSI report corresponding to/associated with the CSI reporting configuration will be discussed below in case that the CSI reporting configuration (or the CSI report corresponding to the CSI reporting configuration) is in the SBFD cell, or the serving cell where the CSI reporting configuration (or the CSI report corresponding to the CSI reporting configuration) is located and the SBFD cell are in the same frequency domain unit, or in case that the serving cell where the UE transmits the CSI report (or, the uplink channel carrying the CSI report) and the SBFD cell are in the same frequency unit. For example, when the serving cell where the CSI reporting configuration is located (or the serving cell where the CSI report associated with the CSI reporting configuration is located) and the SBFD cell are in the same frequency domain unit, the UE determines the parameters associated with the uplink channel carrying the CSI report corresponding to the CSI reporting configuration based on the first time domain resource(s) associated with the SBFD time domain resource(s). Optionally, the first time domain resource(s) may be/may include one of the followings: the SBFD time domain resource(s) and/or the non-SBFD time domain resource(s), refer above for definitions of the SBFD time domain resource(s) and the non-SBFD time domain resource(s). Optionally, the UE may determine that the first time domain resource(s) are at least one of the SBFD time domain resource(s) and the non-SBFD time domain resource(s) based on the uplink channel associated with the CSI report. For example, when the uplink channel associated with/corresponding to the CSI report is in the SBFD time domain resource(s), the first time domain resource(s) are the SBFD time domain resource(s). For example, when the uplink channel associated with the CSI report is in the non-SBFD time domain resource(s), the first time domain resource(s) are the non-SBFD time domain resource(s). Specifically, the base station indicates/configures, to the UE, the uplink channel to be used to carry the CSI report associated with/corresponding to the CSI reporting configuration, determines specific content of the first time domain resource(s) (i.e., the first time domain resource(s) being the SBFD time domain resource(s) and/or the non-SBFD time domain resource(s)) based on the configured/indicated uplink channel (e.g., the type of the uplink channel or the time domain position corresponding to the uplink channel), and then determines that the parameters of the uplink channel for carrying the CSI report will be applied in reporting the CSI based on the determined first time domain resource(s). Optionally, the UE may receive two configurations or two groups of configurations from the base station, wherein the two configurations or two groups of configurations are respectively for the case that the first time domain resource(s) are the SBFD time domain resource(s) and for the case that the first time domain resource(s) are the non-SBFD time domain resource(s).
In case that the CSI reporting configuration corresponds to periodic CSI report, or semi-persistent CSI report on the physical uplink control channel (PUCCH), or corresponding CSI report is on the PUCCH, or a report configuration type parameter reportConfigType included in the CSI reporting configuration is set to “periodic” or “semi-persistent”, the CSI reporting configuration may include two groups of parameters/two parameters for indicating PUCCH (transmission). For example, the first group of parameters/first parameter is for the first time domain resource(s) being the SBFD time domain resource(s). For example, the second group of parameters/second parameter is for the first time domain resource(s) being the non-SBFD time domain resource(s). Optionally, when the PUCCH corresponding to the CSI report corresponding to the CSI reporting configuration is to be transmitted on the SBFD time domain resource(s), the parameter(s) of the PUCCH (transmission) is the first group of parameters/first parameter or is determined to be the first group of parameters/first parameter. Optionally, when the PUCCH corresponding to the CSI report corresponding to the CSI reporting configuration is to be transmitted on the non-SBFD time domain resource(s), the parameter(s) of the PUCCH (transmission) is the second group of parameters/second parameter or is determined to be the second group of parameters/second parameter. Optionally, the parameter(s) associated with the PUCCH (transmission) includes/corresponds to at least one of the followings: a power parameter/uplink power control parameter (for example, poalpha) for the PUCCH (transmission), a QCL parameter for the PUCCH (transmission), a frequency hopping parameter for the PUCCH (transmission), and a parameter for indicating the PUCCH resources corresponding to/used by the PUCCH (transmission) (for example, pucch-CSI-ResourceList). Because the strongness of interference on the SBFD time domain resource(s) and the non-SBFD time domain resource(s) may be different, using different parameters on the SBFD time domain resource(s) and the non-SBFD time domain resource(s) may be for different interference on the SBFD time domain resource(s) and the non-SBFD time domain resource(s), and improve the performance of the uplink transmission.
In case that the CSI reporting configuration corresponds to semi-persistent CSI report on the PUSCH, or the CSI report corresponding to the CSI reporting configuration is on the PUCSH, or the report configuration type parameter reportConfigType included in the CSI reporting configuration is set to “semiPersistentOnPUSCH”, the CSI reporting configuration may include two groups of parameters/two parameters for indicating the PUSCH (transmission). For example, the first group of parameters/first parameter is for the first time domain resource(s) being the SBFD time domain resource(s). For example, the second group of parameters/second parameter is for the first time domain resource(s) being the non-SBFD time domain resource(s). Optionally, when the PUSCH corresponding to the CSI report corresponding to the CSI reporting configuration is to be transmitted on the SBFD time domain resource(s), the parameter(s) of the PUSCH (transmission) is the first group of parameters/first parameter or is determined to be the first group of parameters/first parameter. When the PUSCH corresponding to the CSI report corresponding to the CSI reporting configuration is to be transmitted on the non-SBFD time domain resource(s), the parameter(s) of the PUSCH (transmission) is the second group of parameters/second parameter or is determined to be the second group of parameters/second parameter. Optionally, the parameter(s) associated with PUSCH includes at least one of a power parameter (e.g., poalpha) for the PUSCH (transmission), a QCL parameter for the PUSCH (transmission), a frequency hopping parameter for the PUSCH (transmission), and a parameter for indicating the PUSCH resources corresponding to/used by the PUSCH (transmission). Because the strongness of interference on the SBFD time domain resource(s) and the non-SBFD time domain resource(s) may be different, using different parameters on the SBFD time domain resource(s) and the non-SBFD time domain resource(s) may be for different interference on the SBFD time domain resource(s) and the non-SBFD time domain resource(s), and improve the performance of the uplink transmission.

Optionally, the above determination method for determining the parameters of the uplink channel carrying the CSI report takes the uplink channel carrying the CSI report as an example, and the disclosure is not limited thereto, for example, this method may be for determining the parameters associated with uplink signals (for example, sounding reference signal (SRS), demodulation reference signal (DM-RS) of the PUSCH, DM-RS of the PUCCH, phase tracking reference signal (PT-RS) and reference signal for positioning) and/or uplink channels (for example, PUSCH, PUCCH, physical random access channel (PRACH)) not carrying the CSI report. For example, this method may be for determining the parameters of downlink signals (for example, SSB, DM-RS of the PDSCH, DM-RS of the PDCCH, PT-RS, reference signal for positioning) and/or downlink channels (for example, PDSCH, PDCCH, physical broadcast channel (PBCH)).

In some cases, the UE may be configured with several serving cells. One/each of the several serving cells may be configured with the CSI resource setting. Optionally, one/each of the several serving cells may be configured with the CSI resource setting. The cell where the CSI reporting configuration is located and the cell where the CSI resource setting associated with the CSI reporting configuration is located may be the same or different. For example, the CSI reporting configuration may include a higher-layer parameter carrier for indicating the cell where the associated CSI resource setting is located. For example, the UE may determine the cell where the corresponding measurement resources are located based on the higher-layer parameter carrier included in the CSI reporting configuration. For example, the UE may determine which cell to perform measurement on based on the higher-layer parameter carrier that may be included in the CSI reporting configuration. For example, when the CSI reporting configuration does not include the higher-layer parameter carrier, the cell where the corresponding/associated CSI resource setting is located is the same as the cell where the CSI reporting configuration is located. For example, when the CSI reporting configuration does not include the higher-layer parameter carrier, the associated CSI resource setting is in the cell where the CSI reporting configuration is located. Generally, UE needs to determine the cell where the CSI resource setting associated with the CSI reporting configuration is located. When the cell where the CSI resource setting associated with the CSI reporting configuration is located is the SBFD cell, or when the cell where the CSI resource setting associated with the CSI reporting configuration is located and the SBFD cell are in the same frequency domain unit, CSI measurement and/or CSI reporting associated with the CSI resource setting may be affected by SBFD operation of the base station. Therefore, corresponding methods are required to optimize CSI-related processes, thereby improving the reliability of the communication system.

A method for the UE to measure the CSI and/or determine the CSI and/or report the CSI based on the CSI reporting configuration when the CSI reporting configuration is in the SBFD cell, or the CSI resource setting associated with the CSI reporting configuration and the SBFD cell are in the same frequency domain unit will be discussed below. For example, when a first condition is satisfied, the method for the UE to measure CSI and/or determine CSI and/or report the CSI based on the CSI reporting configuration is performed, wherein the first condition includes at least one of the CSI reporting configuration is in the SBFD cell, the CSI resource setting associated with the CSI reporting configuration is in the SBFD cell, the serving cell where the CSI reporting configuration is located and the SBFD cell are in the same frequency domain unit, and the serving cell where the CSI resource setting associated with the CSI reporting configuration is located and the SBFD cell are in the same frequency domain unit. The UE performs at least one of the following operations based on the first time domain resource(s) that may be associated with the SBFD time domain resource(s):
Operation 1: obtaining the measurement based on the reference signal associated with the CSI resource setting;
Operation 2: not receiving the reference signal associated with the CSI resource setting;
Operation 3: determining and/or reporting the CSI based on the CSI reporting configuration.

Optionally, when the serving cell where (the CSI resource setting associated with) the CSI reporting configuration is located and the SBFD cell are in the same frequency domain unit, the UE performs at least one of Operation 1, Operation 2 and Operation 3 based on the first time domain resource(s) associated with the SBFD time domain resource(s). Optionally, the first time domain resource(s) may be/may include the SBFD time domain resource(s) and/or the non-SBFD time domain resource(s). For example, the first time domain resource(s) may be at least one of the SBFD time domain resource(s) and the non-SBFD time domain resource(s).
Optionally, the UE may determine that the first time domain resource(s) are at least one of the SBFD time domain resource(s) and the non-SBFD time domain resource(s) based on the uplink channel associated with the CSI report. For example, when the uplink channel associated with/corresponding to the CSI report is in the SBFD time domain resource(s), the first time domain resource(s) are the SBFD time domain resource(s). For example, when the uplink channel associated with the CSI report is in the non-SBFD time domain resource(s), the first time domain resource(s) are the non-SBFD time domain resource(s). For example, when the uplink channel associated with the CSI report is in the SBFD time domain resource(s) and in the non-SBFD time domain resource(s), the first time domain resource(s) are the SBFD time domain resource(s). For example, when the uplink channel associated with the CSI report is in the SBFD time domain resource(s) and in the non-SBFD time domain resource(s), the first time domain resource(s) are the non-SBFD time domain resource(s). For example, when the uplink channel associated with the CSI report is in the SBFD time domain resource(s) and in the non-SBFD time domain resource(s), the UE determines that the first time domain resource(s) are the SBFD time domain resource(s) or the non-SBFD time domain resource(s) based on the number of slots/symbols of the uplink channel in the SBFD time domain resource(s) and the number of slots/symbols of the uplink channel in the non-SBFD time domain resource(s). For example, when the uplink channel associated with the CSI report is in the SBFD time domain resource(s) and in the non-SBFD time domain resource(s), the first time domain resource(s) are the SBFD time domain resource(s) if the number of slots/symbols of the time domain resource(s) in the SBFD time domain resource(s) are greater than or equal to the number of slots/symbols of the time domain resource(s) of the uplink channel in the non-SBFD time domain resource(s). For example, when the uplink channel associated with the CSI report is in the SBFD time domain resource(s) and in the non-SBFD time domain resource(s), the first time domain resource(s) are the non-SBFD time domain resource(s) if the number of slots/symbols of the time domain resource(s) in the SBFD time domain resource(s) are smaller than the number of slots/symbols of the time domain resource(s) of the uplink channels in the non-SBFD time domain resource(s). For example, when the uplink channel associated with the CSI report is in the SBFD time domain resource(s) and in the non-SBFD time domain resource(s), the UE determines that the first time domain resource(s) are the SBFD time domain resource(s) or the non-SBFD time domain resource(s) based on the starting slot/ending slot/starting symbol/ending symbol of the uplink channel. For example, when the uplink channel associated with the CSI report is in the SBFD time domain resource(s) and in the non-SBFD time domain resource(s), the first time domain resource(s) are the SBFD time domain resource(s) if the starting slot/ending slot/starting symbol/ending symbol of the uplink channel is in the SBFD time domain resource(s). For example, when the uplink channel associated with the CSI report is in the SBFD time domain resource(s) and in the non-SBFD time domain resource(s), the first time domain resource(s) are the non-SBFD time domain resource(s) if the starting slot/ending slot/starting symbol/ending symbol of the uplink channel is in the non-SBFD time domain resource(s). This method may determine specific content of the first time domain resource(s) through the time domain position of the CSI report, which saves the signaling overhead and improves the efficiency of the communication system.
Optionally, the UE may determine that the first time domain resource(s) are at least one of the SBFD time domain resource(s) and the non-SBFD time domain resource(s) based on the CSI reporting configuration. For example, the CSI reporting configuration includes/is configured a parameter for selecting the time domain resource(s), which is called time domain resource selection parameter herein, but the name of the parameter is not limited by the disclosure, where it is used to indicate that the first time domain resource(s) correspond to at least one of the SBFD time domain resource(s) and the non-SBFD time domain resource(s). For example, the CSI reporting configuration includes/is configured with the time domain resource selection parameter, which is used to indicate that the first time domain resource(s) correspond to at least one of the SBFD time domain resource(s) and the non-SBFD time domain resource(s). For example, the CSI reporting configuration includes/is configured with the time domain resource selection parameter, and the UE determines that the first time domain resource(s) are at least one of the SBFD time domain resource(s) and the non-SBFD time domain resource(s) based on the time domain resource selection parameter. This method may indicate specific content of the first time domain resource(s) via the time domain resource selection parameter, which improves the flexibility of indication and the performance of the communication system.
Optionally, the UE may determine that the first time domain resource(s) are at least one of the SBFD time domain resource(s) and the non-SBFD time domain resource(s) based on a sub-configuration included in the CSI reporting configuration. For example, the CSI reporting configuration includes one or more sub-configurations. Optionally, the UE may determine the CSI corresponding to the sub-configuration. Optionally, the UE may perform the above operations (e.g., at least one of Operation 1, Operation 2, and Operation 3) based on the sub-configuration. For example, the sub-configuration included in the CSI reporting configuration includes/is configured with the time domain resource selection parameter, wherein the time domain resource selection parameter indicates that the first time domain resource(s) associated with/corresponding to the sub-configuration correspond to at least one of the SBFD time domain resource(s) and the non-SBFD time domain resource(s). For example, the sub-configuration included in the CSI reporting configuration includes/is configured with the time domain resource selection parameter, and the UE determines that the first time domain resource(s) corresponding to the sub-configuration is at least one of the SBFD time domain resource(s) and the non-SBFD time domain resource(s) based on the time domain resource selection parameter. Optionally, the sub-configuration may also include/indicate a resource parameter, an antenna port subset parameter and a power parameter. For example, the UE determines the CSI based on at least one of the resource parameter, the antenna port subset parameter, the power parameter and a parameter associated with the frequency domain indicated by the sub-configuration. Optionally, the resource parameter of the sub-configuration is used to indicate the resources or a resource subset in the resource set associated with the sub-configuration associated with the CSI reporting configuration. Optionally, the antenna port subset parameter of the sub-configuration is used to indicate a port subset (for CSI computation/CSI determination) of the resources in the resource set associated with the sub-configuration associated with the CSI reporting configuration. Optionally, the power parameter of the sub-configuration is used to indicate the power/power assumption (for CSI computation/CSI determination) of the resources in the resource set associated with the sub-configuration associated with the CSI reporting configuration. The UE determines/computes the CSI based on the power parameter indicated by the sub-configuration and the power parameter (e.g., powerControlOffset) with which the resources in the resource set associated with the CSI reporting configuration is configured. Optionally, the frequency domain parameter associated with the sub-configuration may be for configuring the report in frequency domain. Optionally, the frequency domain parameter associated with the sub-configuration is reportFreqConfiguration. Optionally, the frequency domain parameter associated with the sub-configuration may be used to indicate (consecutive or non-consecutive) subbands corresponding to the CSI report. Optionally, the frequency domain parameter associated with the sub-configuration is csi-ReportingBand. This method may indicate specific content of the first time domain resource(s) via the sub-configuration, which improves the flexibility of indication and the performance of the communication system.
Optionally, the UE may determine that the first time domain resource(s) are at least one of the SBFD time domain resource(s) and the non-SBFD time domain resource(s) based on the trigger state (for example, aperiodic CSI trigger state or semi-persistent CSI trigger state) corresponding to/associated with the CSI reporting configuration. For example, the UE receives/detects downlink control information (DCI) (including a CSI request field) (for example, DCI format 0_1 or DCI format 0_2 or DCI format 0_3), and the DCI triggers/indicates/initiates a CSI trigger state, and the CSI trigger state indicates/is associated with the CSI reporting configuration. Optionally, the CSI trigger state may be used to indicate that the first time domain resource(s) are at least one of the SBFD time domain resource(s) and the non-SBFD time domain resource(s). For example, the CSI trigger state is associated with the time domain resource selection parameter, and the UE determines that the first time domain resource(s) are at least one of the SBFD time domain resource(s) and the non-SBFD time domain resource(s) based on the time domain selection parameter. This method may trigger/activate the CSI associated with the CSI reporting configuration reporting via DCI signaling and indicate specific content of the corresponding first time domain resource(s) at the same time, which improves the flexibility of indication and the performance of the communication system.
Optionally, the UE may determine that the first time domain resource(s) are at least one of the SBFD time domain resource(s) and the non-SBFD time domain resource(s) based on media access control (MAC)-control element (MAC-CE) activating the CSI associated with the CSI reporting configuration. For example, the UE may receive the MAC-CE activating the CSI reporting associated with the CSI reporting configuration. Optionally, the MAC-CE may include a field for indicating whether the first time domain resource(s) are at least one of the SBFD time domain resource(s) and the non-SBFD time domain resource(s). For example, the size of the field may be 1 bit. For example, the field is used to indicate that the first time domain resource(s) are one of the SBFD time domain resource(s) and the non-SBFD time domain resource(s). For example, the size of the field may be 2 bits, for example, the field is used to indicate that the first time domain resource(s) are at least one of the SBFD time domain resource(s) and the non-SBFD time domain resource(s). Here, the first three codepoints of the field may be mapped one-to-one with the SBFD time domain resource(s), the non-SBFD time domain resource(s), the SBFD time domain resource(s) and the non-SBFD time domain resource(s). This method may activate the CSI associated with the CSI reporting configuration via MAC-CE signaling and indicate specific content of the corresponding first time domain resource(s) at the same time, which improves the flexibility of indication and the performance of the communication system.
Optionally, the UE may determine that the first time domain resource(s) are at least one of the SBFD time domain resource(s) and the non-SBFD time domain resource(s) based on the time domain position of the CSI reference resource corresponding to/associated with the CSI report corresponding to/associated with the CSI reporting configuration. For example, when the uplink channel corresponding to/associated with the CSI report corresponding to/associated with the CSI reporting configuration is in the SBFD time domain resource(s), the first time domain resource(s) are the SBFD time domain resource(s). For example, when the uplink channel associated with the CSI report is in the non-SBFD time domain resource(s), the first time domain resource(s) are the non-SBFD time domain resource(s). This method may determine specific content of the first time domain resource(s) through the CSI reference resource, which saves the signaling overhead and improves the efficiency of the communication system.

Optionally, when the first time domain resource(s) are (determined as/indicated as) the SBFD time domain resource(s) and the non-SBFD time domain resource(s), the UE performs the above operations (for example, at least one of Operation 1, Operation 2 and Operation 3) based on the SBFD time domain resource(s) and the non-SBFD time domain resource(s), respectively. For example, when the first time domain resource(s) are (determined as/indicated as) the SBFD time domain resource(s) and the non-SBFD time domain resource(s), respectively, the UE performs the above operations (for example, at least one of Operation 1, Operation 2 and Operation 3) based on the SBFD time domain resource(s), and the UE performs the above operations (for example, at least one of Operation 1, Operation 2 and Operation 3) based on the non-SBFD time domain resource(s). For example, respectively, the UE performs the above operations (e.g., at least one of Operation 1, Operation 2 and Operation 3) based on the SBFD time domain resource(s) and the reference signal associated with the SBFD time domain resource(s), and the UE performs the above operations (e.g., at least one of Operation 1, Operation 2 and Operation 3) based on the non-SBFD time domain resource(s) and the reference signal associated with the non-SBFD time domain resource(s). Optionally, the reference signal associated with the SBFD time domain resource(s) may be a first resource subset of the resources in the resource set associated with the CSI resource setting associated with the CSI reporting configuration. Optionally, the reference signal associated with the non-SBFD time domain resource(s) may be a second resource subset of the resources in the resource set associated with the CSI resource setting associated with CSI reporting configuration. Optionally, the first subset and/or the second subset are determined in a predefined method. For example, the UE determines the first subset and/or the second subset based on the order of the resources in the resource set. For example, if the resource set includes K resources, the first subset is the first K/2 resources in the resource set, and/or the second subset is the first K/2 resources in the resource set. Optionally, the first subset and the second subset are indicated/configured by the CSI reporting configuration. For example, the CSI reporting configuration includes one or more parameters for indicating the first subset and/or the second subset.

Optionally, the UE may be configured with two report frequency domain configuration parameters (for example, reportFreqConfiguration) in the CSI reporting configuration. Optionally, the first one of the two report frequency domain configuration parameters corresponds to/is associated with the SBFD time domain resource(s). Optionally, the second one of the two report frequency domain configuration parameters corresponds to/is associated with the non-SBFD time domain resource(s). For example, when the first time domain resource(s) are (determined as/indicated as) the SBFD time domain resource(s) and the non-SBFD time domain resource(s), respectively, the UE performs the above operation (for example, Operation 3) based on the SBFD time domain resource(s) and the first report frequency domain configuration parameter, and the UE performs the above operation (for example, Operation 3) based on the non-SBFD time domain resource(s) and the second report frequency domain configuration parameter.

Optionally, in the above description, if the time domain resource selection parameter is not configured, the UE determines that the first time domain resource(s) are at least one of the SBFD time domain resource(s) and the non-SBFD time domain resource(s) in a predefined method. For example, optionally, in the above description, if the time domain resource selection parameter is not configured, the UE determines that the first time domain resource(s) are the non-SBFD time domain resource(s). For example, optionally, in the above description, if the time domain resource selection parameter is not configured, the UE determines that the first time domain resource(s) are the SBFD time domain resource(s) and the non-SBFD time domain resource(s). This method may determine specific content of the first time domain resource(s) in the predefined method, which saves the signaling overhead and improves the efficiency of the communication system.

In some cases, Operation 1 may be that the UE may determine and/or report the CSI based on the CSI measurement associated with the CSI reporting configuration. Optionally, the (latest) CSI measurement occasion may occur in the first time domain resource(s). For example, the UE may determine and/or report the CSI based on CSI measurement in the first time domain resource(s). For example, the UE may determine and/or report the CSI based on (the measurement of) the latest CSI measurement occasion in the first time domain resource(s). For example, when the first time domain resource(s) are the SBFD time domain resource(s) and the non-SBFD time domain resource(s), the latest CSI measurement occasion may occur in the SBFD time domain resource(s) and the non-SBFD time domain resource(s), respectively. For example, when the first time domain resource(s) are the SBFD time domain resource(s) and the non-SBFD time domain resource(s), the UE may determine and/or report the CSI based on (the measurement of) the latest CSI measurement occasion in the SBFD time domain resource(s), and the UE may determine and/or report the CSI based on (the measurement of) the latest CSI measurement occasion in the non-SBFD time domain resource(s). This method may determine CSI measurement based on the SBFD time domain resource(s)/time domain resource(s) on which the CSI is based, thus preventing the UE from averaging the CSI measurement result obtained in the SBFD time domain resource(s) and the CSI measurement result obtained in the non-SBFD time domain resource(s), causing the CSI determined by the UE to correspond to channels of the SBFD time domain resource(s) and the non-SBFD time domain resource(s), respectively, thus improving the accuracy of the CSI.

In some cases, Operation 1 may be that the UE may determine and/or report the CSI based on the reference signal resource associated with the resource set associated with the CSI reporting configuration. Optionally, the UE may determine and/or report the CSI based on the reference signal resource associated with the resource set associated with the CSI reporting configuration in the first time domain resource(s). Optionally, the UE obtains the CSI based on the assumption that the transmission occasion associated with the reference signal resource in the SBFD resources and the transmission occasion associated with the reference signal resource in the non-SBFD resources are not averaged. Optionally, when the first time domain resource(s) are the SBFD time domain resource(s) and the non-SBFD time domain resource(s), or the first time domain resource(s) are the SBFD time domain resource(s), or the first time domain resource(s) are the non-SBFD time domain resource(s), the UE obtains/computes the CSI based on the assumption that the transmission occasion associated with the reference signal resource in the SBFD resources and the transmission occasion associated with the reference signal resource in the non-SBFD resources are not averaged. In the disclosure, the term “transmission occasion” may be used interchangeably with the terms “measurement occasion” or “measurement instance” or “occasion” or “instance”. This method may prevent the UE from averaging the CSI measurement result obtained in the SBFD time domain resource(s) and the CSI measurement result obtained in the non-SBFD time domain resource(s), causing the CSI determined by the UE may correspond to the channels of the SBFD time domain resource(s) and the non-SBFD time domain resource(s), respectively, and improving the accuracy of the CSI.

In some cases, the CSI reporting configuration may include a channel measurement time domain restriction parameter and/or an interference measurement time domain restriction parameter. Optionally, the channel measurement time domain restriction parameter (e.g., timeRestrictionForChannelMeasurements) is used to enable time domain restriction for channel measurements. Optionally, the interference measurement time domain restriction parameter (for example, timeRestrictionForInterferenceMeasurements) is used to enable time domain restriction for interference measurements.

Optionally, Operation 1 may be that the UE obtains the measurement result based on the CSI reference resource associated with the CSI resource setting in the first time domain resource(s) and no later than the CSI reference resource corresponding to the CSI report associated with the CSI reporting configuration when the channel measurement time domain restriction parameter included in the CSI reporting configuration or the interference measurement time domain restriction parameter is set to “notConfigured”. Optionally, the measurement result may be the channel measurement result and/or the interference measurement result. This method enables the UE to determine the CSI through the CSI measurement result obtained in the SBFD time domain resource(s) and the CSI measurement obtained in the non-SBFD time domain resource(s), respectively, causing the CSI determined by the UE may correspond to the channels of the SBFD time domain resource(s) and the non-SBFD time domain resource(s), respectively, and improving the accuracy of the CSI.
Optionally, if the channel measurement time domain restriction parameter in the CSI reporting configuration is set to “notConfigured” and/or the first condition is satisfied, the UE determines the channel measurement based on the CSI-RS (or a CSI-RS occasion) in the first time domain resource(s). Optionally, the channel measurement may be the channel measurement for computing the CSI (for example, computing CQI). For example, if the channel measurement time domain restriction parameter in the CSI reporting configuration is set to “notConfigured” and/or the first condition is satisfied, the UE determines the channel measurement for computing the CSI based on only the CSI-RS (or the CSI-RS occasion) associated with the CSI resource setting associated with the CSI reporting configuration in the first time domain resource(s). Optionally, computing the CSI may be computing CQI or computing the CSI associated with CQI. Optionally, the CSI-RS may be NZP CSI-RS. Optionally, the CSI-RS occasion may be the CSI-RS transmission occasion. Optionally, the CSI is reported in the uplink slot n. Optionally, n may represent a slot number. Optionally, n≥0. Here, the CSI-RS (or the CSI-RS occasion) refers to/includes/corresponds to at least one of the followings:
The CSI-RS (or the CSI-RS occasion) no later than the CSI reference resource;
The CSI-RS (or the CSI-RS occasion) in the first time domain resource(s);
The CSI-RS (or the CSI-RS occasion) in DRX active time;
The CSI-RS (or the CSI-RS occasion) in the DRX active time when DRX is configured;
The CSI-RS (or the CSI-RS occasion) in cell DTX active time;
The CSI-RS (or the CSI-RS occasion) in the cell DTX active time of the serving cell where the CSI resource setting associated with the CSI reporting configuration is located when the cell DTX is activated on the serving cell.
Optionally, if the channel measurement time domain restriction parameter in the CSI reporting configuration is set to “notConfigured” and/or the first condition is satisfied, the UE may determine the channel measurement based on the CSI-RS (or the CSI-RS occasion) in the first time domain resource(s). Optionally, the channel measurement may be the channel measurement for computing the CSI (for example, computing L1-RSRP/L1-SINR). For example, when the channel measurement time domain restriction parameter in the CSI reporting configuration is set to “notConfigured” and/or the first condition is satisfied, and/or the resource settings associated with one or two CSI reporting configurations are configured for L1-SINR measurement, the UE determines the channel measurement for computing L1-RSRP/L1-SINR based on only the SSB or CSI-RS (or an SSB or CSI occasion) associated with the CSI resource setting associated with the CSI reporting configuration in the first time domain resource(s). Optionally, the CSI-RS may be NZP CSI-RS. Optionally, the CSI-RS occasion may be the CSI-RS transmission occasion. Optionally, L1-RSRP/L1-SINR is reported in the uplink slot n. Optionally, n may represent the slot number. Optionally, n≥0. Here, the SSB or CSI-RS (or the SSB or CSI-RS occasion) refers to/includes/corresponds to at least one of the followings:
The SSB or CSI-RS (or the SSB or CSI-RS occasion) no later than the CSI reference resource;
The SSB or CSI-RS (or the SSB or CSI-RS occasion) in the first time domain resource(s);
The SSB or CSI-RS (or the SSB or CSI-RS occasion) in the DRX active time;
The SSB or CSI-RS (or the SSB or CSI-RS occasion) in the DRX active time when DRX is configured;
The SSB or CSI-RS (or the SSB or CSI-RS occasion) in the cell DTX active time;
The SSB or CSI-RS (or the SSB or CSI-RS occasion) in the cell DTX active time of the serving cell where the CSI resource setting associated with the CSI reporting configuration is located when the cell DTX is activated on the serving cell.
Optionally, if the interference measurement time domain restriction parameter in the CSI reporting configuration is set to “notConfigured” and/or the first condition is satisfied, the UE determines the interference measurement based on the CSI-IM and/or CSI-RS (or a CSI-IM and/or CSI-RS occasion) for interference measurement in the first time domain resource(s). Optionally, the interference measurement may be the interference measurement for computing the CSI (for example, computing CQI). For example, if the interference measurement time domain restriction parameter in the CSI reporting configuration is set to “notConfigured” and/or the first condition is satisfied, the UE determines the interference measurement based on the CSI-IM and/or CSI-RS (or the CSI-IM and/or CSI-RS occasion) in the first time domain resource(s). Optionally, computing the CSI may be computing CQI or computing the CSI associated with CQI. Optionally, the CSI-RS may be NZP CSI-RS. Optionally, the CSI-RS occasion may be the CSI-RS transmission occasion. Optionally, the CSI is reported in the uplink slot n. Optionally, n may represent the slot number. Optionally, n≥0. Here, the CSI-IM and/or CSI-RS (or the CSI-IM and/or CSI-RS occasion) refers to/includes/corresponds to at least one of the followings:
The CSI-IM and/or CSI-RS (or the CSI-IM and/or CSI-RS occasion) no later than the CSI reference resource;
The CSI-IM and/or CSI-RS (or the CSI-IM and/or CSI-RS occasion) in the first time domain resource(s);
The CSI-IM and/or CSI-RS (or the CSI-IM and/or CSI-RS occasion) in DRX active time;
The CSI-IM and/or CSI-RS (or the CSI-IM and/or CSI-RS occasion) in the DRX active time when DRX is configured;
The CSI-IM and/or CSI-RS (or the CSI-IM and/or CSI-RS occasion) in cell DTX active time;
The CSI-IM and/or CSI-RS (or the CSI-IM and/or CSI-RS occasion) in the cell DTX active time of the serving cell where the CSI resource setting associated with the CSI reporting configuration is located when the cell DTX is activated on the serving cell.
Optionally, if the interference measurement time domain restriction parameter in the CSI reporting configuration is set to “notConfigured” and/or the first condition is satisfied, the UE determines the interference measurement based on the CSI-IM and/or CSI-RS (or a CSI-IM and/or CSI-RS occasion) in the first time domain resource(s). Optionally, the interference measurement may be the interference measurement for computing the CSI (for example, computing L1-SINR). For example, if the interference measurement time domain restriction parameter in the CSI reporting configuration is set to “notConfigured” and/or the first condition is satisfied, and/or the resource settings associated with one or two CSI reporting configurations are configured for L1-SINR measurement, the UE determines the interference measurement for computing L1-SINR based on only the CSI-IM and/or CSI-RS (or a CSI-IM and/or CSI-RS occasion) associated with the CSI resource setting associated with the CSI reporting configuration in the first time domain resource(s). Optionally, the CSI-RS may be NZP CSI-RS. Optionally, the CSI-RS occasion may be the CSI-RS transmission occasion. Optionally, L1-SINR is reported in the uplink slot n. Optionally, n may represent the slot number. Optionally, n≥0. Here, the CSI-IM and/or CSI-RS (or the CSI-IM and/or CSI-RS occasion) refers to/includes/corresponds to at least one of the followings:
The CSI-IM and/or CSI-RS (or the CSI-IM and/or CSI-RS occasion) no later than the CSI reference resource;
The CSI-IM and/or CSI-RS (or the CSI-IM and/or CSI-RS occasion) in the first time domain resource(s);
The CSI-IM and/or CSI-RS (or the CSI-IM and/or CSI-RS occasion) in DRX active time;
The CSI-IM and/or CSI-RS (or the CSI-IM and/or CSI-RS occasion) in the DRX active time when DRX is configured;
The CSI-IM and/or CSI-RS (or the CSI-IM and/or CSI-RS occasion) in cell DTX active time;
The CSI-IM and/or CSI-RS (or the CSI-IM and/or CSI-RS occasion) in the cell DTX active time of the serving cell where the CSI resource setting associated with the CSI reporting configuration is located when the cell DTX is activated on the serving cell.

Optionally, Operation 1 may be that the UE obtains the measurement result based on the CSI reference resource associated with the CSI resource setting in the first time domain resource(s) and is latest and no later than the CSI reference resource corresponding to the CSI report associated with the CSI reporting configuration when the channel measurement time domain restriction parameter included in the CSI reporting configuration or the interference measurement time domain restriction parameter is set to “Configured”. Optionally, the measurement result may be the channel measurement result and/or the interference measurement result. This method enables the UE to determine the CSI through the CSI measurement result obtained in the SBFD time domain resource(s) and the CSI measurement obtained in the non-SBFD time domain resource(s), respectively, causing the CSI determined by the UE may correspond to the channels of the SBFD time domain resource(s) and the non-SBFD time domain resource(s), respectively, and improving the accuracy of the CSI.
Optionally, if the channel measurement time domain restriction parameter in the CSI reporting configuration is set to “Configured” and/or the first condition is satisfied, the UE determines the channel measurement based on the CSI-RS (or a CSI-RS occasion) in the first time domain resource(s). Optionally, the channel measurement may be the channel measurement for computing the CSI (for example, computing CQI). For example, if the channel measurement time domain restriction parameter in the CSI reporting configuration is set to “Configured” and/or the first condition is satisfied, the UE determines the channel measurement for computing the CSI based on only the CSI-RS (or the CSI-RS occasion) associated with the CSI resource setting associated with the CSI reporting configuration in the first time domain resource(s). Optionally, computing the CSI may be computing CQI or computing the CSI associated with CQI. Optionally, the CSI-RS may be NZP CSI-RS. Optionally, the CSI-RS occasion may be the CSI-RS transmission occasion. Optionally, the CSI is reported in the uplink slot n. Optionally, n may represent a slot number. Optionally, n≥0. Here, the CSI-RS (or the CSI-RS occasion) refers to/includes/corresponds to at least one of the followings:
The latest CSI-RS (or the CSI-RS occasion);
The CSI-RS (or the CSI-RS occasion) no later than the CSI reference resource;
The CSI-RS (or the CSI-RS occasion) in the first time domain resource(s);
The CSI-RS (or the CSI-RS occasion) in DRX active time;
The CSI-RS (or the CSI-RS occasion) in the DRX active time when DRX is configured;
The CSI-RS (or the CSI-RS occasion) in cell DTX active time;
The CSI-RS (or the CSI-RS occasion) in the cell DTX active time of the serving cell where the CSI resource setting associated with the CSI reporting configuration is located when the cell DTX is activated on the serving cell.
Optionally, if the channel measurement time domain restriction parameter in the CSI reporting configuration is set to “Configured” and/or the first condition is satisfied, the UE may determine the channel measurement based on the SSB or CSI-RS (or the SSB or CSI-RS occasion) in the first time domain resource(s). Optionally, the channel measurement may be the channel measurement for computing the CSI (for example, computing L1-RSRP/L1-SINR). For example, when the channel measurement time domain restriction parameter in the CSI reporting configuration is set to “Configured” and/or the first condition is satisfied, and/or the resource settings associated with one or two CSI reporting configurations are configured for L1-SINR measurement, the UE determines the channel measurement for computing L1-RSRP/L1-SINR based on only the SSB or CSI-RS (or an SSB or CSI occasion) associated with the CSI resource setting associated with the CSI reporting configuration in the first time domain resource(s). Optionally, the CSI-RS may be NZP CSI-RS. Optionally, the CSI-RS occasion may be the CSI-RS transmission occasion. Optionally, L1-RSRP/L1-SINR is reported in the uplink slot n. Optionally, n may represent the slot number. Optionally, n≥0. Here, the SSB or CSI-RS (or the SSB or CSI-RS occasion) refers to/includes/corresponds to at least one of the followings:
The latest SSB or CSI-RS (or the SSB or CSI-RS occasion);
The SSB or CSI-RS (or the SSB or CSI-RS occasion) no later than the CSI reference resource;
The SSB or CSI-RS (or the SSB or CSI-RS occasion) in the first time domain resource(s);
The SSB or CSI-RS (or the SSB or CSI-RS occasion) in the DRX active time;
The SSB or CSI-RS (or the SSB or CSI-RS occasion) in the DRX active time when DRX is configured;
The SSB or CSI-RS (or the SSB or CSI-RS occasion) in the cell DTX active time;
The SSB or CSI-RS (or the SSB or CSI-RS occasion) in the cell DTX active time of the serving cell where the CSI resource setting associated with the CSI reporting configuration is located when the cell DTX is activated on the serving cell.
Optionally, if the interference measurement time domain restriction parameter in the CSI reporting configuration is set to “Configured” and/or the first condition is satisfied, the UE determines the interference measurement based on the CSI-IM and/or CSI-RS (or a CSI-IM and/or CSI-RS occasion) for interference measurement in the first time domain resource(s). Optionally, the interference measurement may be the interference measurement for computing the CSI (for example, computing CQI). For example, if the interference measurement time domain restriction parameter in the CSI reporting configuration is set to “Configured” and/or the first condition is satisfied, the UE determines the interference measurement based on the CSI-IM and/or CSI-RS (or the CSI-IM and/or CSI-RS occasion) in the first time domain resource(s). Optionally, computing the CSI may be computing CQI or computing the CSI associated with CQI. Optionally, the CSI-RS may be NZP CSI-RS. Optionally, the CSI-RS occasion may be the CSI-RS transmission occasion. Optionally, the CSI is reported in the uplink slot n. Optionally, n may represent the slot number. Optionally, n≥0. Here, the CSI-IM and/or CSI-RS (or the CSI-IM and/or CSI-RS occasion) refers to/includes/corresponds to at least one of the followings:
The latest CSI-IM and/or CSI-RS (or the CSI-IM and/or CSI-RS occasion);
The CSI-IM and/or CSI-RS (or the CSI-IM and/or CSI-RS occasion) no later than the CSI reference resource;
The CSI-IM and/or CSI-RS (or the CSI-IM and/or CSI-RS occasion) in the first time domain resource(s);
The CSI-IM and/or CSI-RS (or the CSI-IM and/or CSI-RS occasion) in DRX active time;
The CSI-IM and/or CSI-RS (or the CSI-IM and/or CSI-RS occasion) in the DRX active time when DRX is configured;
The CSI-IM and/or CSI-RS (or the CSI-IM and/or CSI-RS occasion) in cell DTX active time;
The CSI-IM and/or CSI-RS (or the CSI-IM and/or CSI-RS occasion) in the cell DTX active time of the serving cell where the CSI resource setting associated with the CSI reporting configuration is located when the cell DTX is activated on the serving cell.
Optionally, if the interference measurement time domain restriction parameter in the CSI reporting configuration is set to “Configured” and/or the first condition is satisfied, the UE determines the interference measurement based on the CSI-IM and/or CSI-RS (or a CSI-IM and/or CSI-RS occasion) in the first time domain resource(s). Optionally, the interference measurement may be the interference measurement for computing the CSI (for example, computing L1-SINR). For example, if the interference measurement time domain restriction parameter in the CSI reporting configuration is set to “Configured” and/or the first condition is satisfied, and/or the resource settings associated with one or two CSI reporting configurations are configured for L1-SINR measurement, the UE determines the interference measurement for computing L1-SINR based on only the CSI-IM and/or CSI-RS (or a CSI-IM and/or CSI-RS occasion) associated with the CSI resource setting associated with the CSI reporting configuration in the first time domain resource(s). Optionally, the CSI-RS may be NZP CSI-RS. Optionally, the CSI-RS occasion may be the CSI-RS transmission occasion. Optionally, L1-SINR is reported in the uplink slot n. Optionally, n may represent the slot number. Optionally, n≥0. Here, the CSI-IM and/or CSI-RS (or the CSI-IM and/or CSI-RS occasion) refers to/includes/corresponds to at least one of the followings:
The latest CSI-IM and/or CSI-RS (or the CSI-IM and/or CSI-RS occasion);
The CSI-IM and/or CSI-RS (or the CSI-IM and/or CSI-RS occasion) no later than the CSI reference resource;
The CSI-IM and/or CSI-RS (or the CSI-IM and/or CSI-RS occasion) in the first time domain resource(s);
The CSI-IM and/or CSI-RS (or the CSI-IM and/or CSI-RS occasion) in DRX active time;
The CSI-IM and/or CSI-RS (or the CSI-IM and/or CSI-RS occasion) in the DRX active time when DRX is configured;
The CSI-IM and/or CSI-RS (or the CSI-IM and/or CSI-RS occasion) in cell DTX active time;
The CSI-IM and/or CSI-RS (or the CSI-IM and/or CSI-RS occasion) in the cell DTX active time of the serving cell where the CSI resource setting associated with the CSI reporting configuration is located when the cell DTX is activated on the serving cell.

In some cases, Operation 2 may be that, for example, the UE does not perform the CSI measurement (e.g., measurement of the reference signal) outside the first time domain resource(s) when the first time domain resource(s) are the SBFD time domain resource(s). For example, when the first time domain resource(s) are the non-SBFD time domain resource(s), the UE does not perform the CSI measurement (for example, measurement of the reference signal) outside the first time domain resource(s). Therefore, how the UE does not perform the CSI measurement outside the first time domain resource(s) in case that the first time domain resource(s) are the SBFD time domain resource(s) or the non-SBFD time domain resource(s) will be discussed below. Not performing the CSI measurement outside the first time domain resource(s) may help the UE save energy consumption and improve the efficiency of the communication system. Optionally, not performing the CSI measurement may be that not receiving (or not expecting to receive) the reference signal (or the reference signal resource) associated with CSI measurement corresponding to the CSI reporting configuration. Optionally, the CSI measurement may be the channel measurement and/or the interference measurement. Optionally, not performing the CSI measurement may be that not receiving (or not expecting to receive) the reference signal (or the reference signal resource) associated with the CSI reporting configuration.
For example, when the first time domain resource(s) are the SBFD time domain resource(s), the UE does not receive (or is not expected to receive) the reference signal associated with the CSI resource setting associated with the CSI reporting configuration on the non-SBFD time domain resource(s). For example, when the first time domain resource(s) are the non-SBFD time domain resource(s), the UE does not receive the reference signal associated with the CSI resource setting associated with the CSI reporting configuration on the SBFD time domain resource(s). The reference signal associated with the CSI reporting configuration may be (all) the reference signal(s) (or the reference signal resource(s)) in the resource set for channel measurement and/or interference measurement associated with the CSI resource setting associated with the CSI reporting configuration. Optionally, the reference signal (or the reference signal resource) may be a semi-persistent or periodic reference signal (or the reference signal resource).
For example, in case that the first time domain resource(s) are the SBFD time domain resource(s) or the non-SBFD time domain resource(s), and/or a (or configured) report quantity parameter corresponding to/associated with the CSI reporting configuration includes at least ‘RI’, the UE does not receive (or is not expected to receive) the reference signal associated with the CSI resource setting associated with the CSI reporting configuration on time domain resource(s) other than the first time domain resource(s). The reference signal associated with the CSI reporting configuration may be (all) the reference signal(s) (or the reference signal resource(s)) in the resource set for channel measurement and/or interference measurement associated with the CSI resource setting associated with the CSI reporting configuration. Optionally, the reference signal (or the reference signal resource) may be a semi-persistent or periodic reference signal (or the reference signal resource).

Since the UE does not receive the reference signal associated with the CSI resource setting associated with the CSI reporting configuration on the first time domain resource(s), the UE may receive/demodulate/process the PDSCH based on the assumption that resource elements (REs) of the reference signal may be used to map REs of the PDSCH, such that the resources corresponding to the CSI-RS may be used for data transmission, thereby improving the efficiency of the communication system. For example, the UE receives indication from the base station to determine the time domain resource(s) and/or frequency domain resource(s) of the PDSCH. For example, the UE receives indication from the base station to determine the REs corresponding to the PDSCH. If the PDSCH is in the first time domain resource(s), and the REs corresponding to the PDSCH have the REs of the reference signal associated with the CSI resource setting associated with the CSI reporting configuration (and the reference signal is a periodic reference signal or a semi-persistent reference signal), then the REs may be used to map information bits, for example, the REs may be used for RE mapping of information bits to VRB corresponding to the PDSCH. Optionally, the REs corresponding to the PDSCH may be the REs on VRB corresponding to the PDSCH.

In some cases, Operation 3 may be that the UE determines whether to report the CSI based on the first time domain resource(s) (and the CSI reporting configuration). For example, when the first time domain resource(s) are the SBFD time domain resource(s) or the non-SBFD time domain resource(s), when the UE receives at least one transmission occasion for channel measurement and/or one transmission occasion for interference measurement on the first time domain resource(s), the UE transmits the CSI report corresponding to the CSI reporting configuration. Otherwise, the UE drops the CSI report corresponding to the CSI reporting configuration. Optionally, the transmission occasion is associated with the CSI resource settings. Optionally, the transmission occasion may be the transmission occasion of the reference signal resource in the resource set for channel measurement and/or interference measurement associated with the CSI reporting configuration. For example, when a second condition is satisfied, the UE transmits the CSI report; otherwise, the UE drops the CSI report. The second condition includes at least one of the followings:
After the CSI report (re) configuration, or serving cell activation, or BWP change, or activation of semi-persistent CSI (SP-CSI);
When the first time domain resource(s) are the SBFD time domain resource(s), at least one CSI-RS transmission occasion for channel measurement and/or one CSI-RS and/or CSI-IM occasion for interference measurement is received on the SBFD time domain resource(s);
Optionally, the CSI-RS transmission occasion for channel measurement is for (one/all/each) resource(s) in the resource set; or, the CSI-RS transmission occasion for channel measurement is for (one/all/each) resource(s) in the first subset of the resource set. Refer above for the description of the first subset.
Optionally, the CSI-RS and/or CSI-IM occasion for interference measurement is for (one/all/each) resource(s) in the resource set; the CSI-RS and/or CSI-IM occasion for interference measurement is for (one/all/each) resource(s) in the first subset of the resource set. Refer above for the description of the first subset.
Optionally, the CSI-RS transmission occasion is no later than the CSI reference resource. For example, the CSI-RS transmission occasion is the CSI-RS transmission occasion no later than the CSI reference resource.
Optionally, the CSI-RS and/or CSI-IM occasion is no later than the CSI reference resource. For example, the CSI-RS transmission occasion is the CSI-RS transmission no later than the CSI reference resource and/or the CSI-IM transmission occasion is the CSI-IM transmission occasion no later than the CSI reference resource.
When the first time domain resource(s) are the non-SBFD time domain resource(s), at least one CSI-RS transmission occasion for channel measurement and/or one CSI-RS and/or CSI-IM occasion for interference measurement is received on the non-SBFD time domain resource(s);
Optionally, the CSI-RS transmission occasion for channel measurement is for (one/all/each) resource(s) in the resource set; or, the CSI-RS transmission occasion for channel measurement is for (one/all/each) resource(s) in the second subset of the resource set. Refer above for the description of the second subset.
Optionally, the CSI-RS and/or CSI-IM occasion for interference measurement is for (one/all/each) resource(s) in the resource set; the CSI-RS and/or CSI-IM occasion for interference measurement is for (one/all/each) resource(s) in the second subset of the resource set. Refer above for the description of the second subset.
Optionally, the CSI-RS transmission occasion is no later than the CSI reference resource. For example, the CSI-RS transmission occasion is the CSI-RS transmission occasion no later than the CSI reference resource.
Optionally, the CSI-RS and/or CSI-IM occasion is no later than the CSI reference resource. For example, the CSI-RS transmission occasion is the CSI-RS transmission occasion no later than the CSI reference resource and/or the CSI-IM transmission occasion is the CSI-IM transmission occasion no later than the CSI reference resource.
When the first time domain resource(s) are the SBFD time domain resource(s) and the non-SBFD time domain resource(s), at least one CSI-RS transmission occasion for channel measurement and/or one CSI-RS and/or CSI-IM occasion for interference measurement is received on the SBFD time domain resource(s), and at least one CSI-RS transmission occasion for channel measurement and/or one CSI-RS and/or CSI for interference measurement is received on the non-SBFD time domain resource(s).
Optionally, the CSI-RS transmission occasion for channel measurement is for (one/all/each) resource(s) in the resource set.
The CSI-RS transmission occasion for channel measurement in the SBFD time domain resource(s) is for (one/all/each) resource(s) in the first subset of the resource set. Refer above for the description of the first subset.
The CSI-RS transmission occasion for channel measurement in the non-SBFD time domain resource(s) is for (one/all/each) resource(s) in the second subset of the resource set. Refer above for the description of the second subset.
Optionally, the CSI-RS and/or CSI-IM occasion for interference measurement is for (one/all/each) resource(s) in the resource set; the CSI-RS and/or CSI-IM occasion for interference measurement is for (one/all/each) resource(s) in the second subset of the resource set. Refer above for the description of the second subset.
Optionally, the CSI-RS transmission occasion is no later than the CSI reference resource. For example, the CSI-RS transmission occasion is the CSI-RS transmission occasion no later than the CSI reference resource.
Optionally, the CSI-RS and/or CSI-IM occasion is no later than the CSI reference resource. For example, the CSI-RS transmission occasion is the CSI-RS transmission occasion no later than the CSI reference resource and/or the CSI-IM transmission occasion is the CSI-IM transmission occasion no later than the CSI reference resource.

In case that discontinuous reception (DRX) (for example, UE DRX) is configured, enough measurements may not be received in the DRX active time, and accordingly, a meaningful report may not be generated due to incomplete measurement information, so the CSI reporting may not be performed in order to save uplink transmission resources. Under what conditions the CSI report corresponding to the CSI reporting configuration disclosure herein should be transmitted or dropped is described below in detail. Based on the second condition, the UE transmits the CSI report or UE drops the CSI report. When the DRX is configured, the CSI-RS and/or CSI-IM occasion in the second condition refers to the CSI-RS and/or CSI-IM occasion in the DRX active time.

In case of cell discontinuous transmission (DTX) and/or UE DRX, enough measurements may not be received in the cell DTX active time and/or DRX active time for the CSI report. Accordingly, a meaningful report may not be generated due to incomplete measurement information for the CSI report. Therefore, such CSI report may not be fed back to save uplink transmission resources. Under what conditions the CSI report corresponding to the CSI reporting configuration disclosure herein should be transmitted or dropped is described below in detail. Optionally, when a third condition is satisfied, the UE transmits the CSI report; otherwise, the UE drops the CSI report. The third condition includes at least one of the followings:
The report quantity corresponding to the CSI reporting configuration includes RI;
The cell DTX of the serving cell where the CSI reporting configuration is located is activated and/or the cell DTX is configured;
The cell DTX of the serving cell where the CSI resource setting (for example, CSI-ResourceConfig) associated with the CSI reporting configuration is located is activated and/or the cell DTX is configured;
The cell DTX of the serving cell where the resources for measurement corresponding to the CSI reporting configuration is activated and/or the cell DTX is configured;
The cell DTX of the serving cell where the resources for channel measurement (and/or interference measurement) corresponding to the CSI reporting configuration is located is activated and/or the cell DTX is configured;
DRX is configured;
After the CSI report (re) configuration, or serving cell activation, or BWP change, or activation of SP-CSI;
When the first time domain resource(s) are the SBFD time domain resource(s), at least one CSI-RS transmission occasion for channel measurement and/or one CSI-RS and/or CSI-IM occasion for interference measurement is received on the SBFD time domain resource(s) (and in the DRX active time and/or the cell DRX active time);
Optionally, the CSI-RS transmission occasion for channel measurement is for (one/all/each) resource(s) in the resource set; or, the CSI-RS transmission occasion for channel measurement is for (one/all/each) resource(s) in the first subset of the resource set. Refer above for the description of the first subset.
Optionally, the CSI-RS and/or CSI-IM occasion for interference measurement is for (one/all/each) resource(s) in the resource set; the CSI-RS and/or CSI-IM occasion for interference measurement is for (one/all/each) resource(s) in the first subset of the resource set. Refer above for the description of the first subset.
Optionally, the CSI-RS transmission occasion is no later than the CSI reference resource. For example, the CSI-RS transmission occasion is the CSI-RS transmission occasion no later than the CSI reference resource.
Optionally, the CSI-RS and/or CSI-IM occasion is no later than the CSI reference resource. For example, the CSI-RS transmission occasion is the CSI-RS transmission occasion no later than the CSI reference resource and/or the CSI-IM transmission occasion is the CSI-IM transmission occasion no later than the CSI reference resource.
When the first time domain resource(s) are the non-SBFD time domain resource(s), at least one CSI-RS transmission occasion for channel measurement and/or one CSI-RS and/or CSI-IM occasion for interference measurement is received on the non-SBFD time domain resource(s) (and in the DRX active time and/or the cell DRX active time);
Optionally, the CSI-RS transmission occasion for channel measurement is for (one/all/each) resource(s) in the resource set; or, the CSI-RS transmission occasion for channel measurement is for (one/all/each) resource(s) in the second subset of the resource set. Refer above for the description of the second subset.
Optionally, the CSI-RS and/or CSI-IM occasion for interference measurement is for (one/all/each) resource(s) in the resource set; the CSI-RS and/or CSI-IM occasion for interference measurement is for (one/all/each) resource(s) in the second subset of the resource set. Refer above for the description of the second subset.
Optionally, the CSI-RS transmission occasion is no later than the CSI reference resource. For example, the CSI-RS transmission occasion is the CSI-RS transmission occasion no later than the CSI reference resource.
Optionally, the CSI-RS and/or CSI-IM occasion is no later than the CSI reference resource. For example, the CSI-RS transmission occasion is the CSI-RS transmission occasion no later than the CSI reference resource and/or the CSI-IM transmission occasion is the CSI-IM transmission occasion no later than the CSI reference resource.
When the first time domain resource(s) are the SBFD time domain resource(s) and the non-SBFD time domain resource(s), at least one CSI-RS transmission occasion for channel measurement and/or one CSI-RS and/or CSI-IM occasion for interference measurement is received on the SBFD time domain resource(s) (and, in the DRX active time and/or the cell DRX active time), and at least one CSI-RS transmission occasion for channel measurement and/or one CSI-RS and/or CSI-IM occasion for interference measurement is received on the non-SBFD time domain resource(s) (and, in the DRX active time and/or the cell DRX active time);
Optionally, the CSI-RS transmission occasion for channel measurement is for (one/all/each) resource(s) in the resource set.
The CSI-RS transmission occasion for channel measurement in the SBFD time domain resource(s) is for (one/all/each) resource(s) in the first subset of the resource set. Refer above for the description of the first subset.
The CSI-RS transmission occasion for channel measurement in the non-SBFD time domain resource(s) is for (one/all/each) resource(s) in the second subset of the resource set. Refer above for the description of the second subset.
Optionally, the CSI-RS and/or CSI-IM occasion for interference measurement is for (one/all/each) resource(s) in the resource set; the CSI-RS and/or CSI-IM occasion for interference measurement is for (one/all/each) resource(s) in the second subset of the resource set. Refer above for the description of the second subset.
Optionally, the CSI-RS transmission occasion is no later than the CSI reference resource. For example, the CSI-RS transmission occasion is the CSI-RS transmission occasion no later than the CSI reference resource.
Optionally, the CSI-RS and/or CSI-IM occasion is no later than the CSI reference resource. For example, the CSI-RS transmission occasion is the CSI-RS transmission occasion no later than the CSI reference resource and/or the CSI-IM transmission occasion is the CSI-IM transmission occasion no later than the CSI reference resource.

The above method (for example, the method associated with Operation 3) may prevent the UE from reporting the CSI without obtaining enough measurements on the first time domain resource(s), ensure the accuracy of the reported CSI and improve the efficiency of the communication system.

In some cases, when the reference signal associated with the CSI resource setting associated with the CSI reporting configuration (for example, corresponding to at least one of Operation 1, Operation 2, and Operation 3) is a semi-persistent or periodic reference signal, the reference signal is associated with a periodicity. For example, when the reference signal is a semi-persistent or periodic reference signal, the reference signal may be associated with/configured with a periodicity and offset parameter (for example, periodicity AndOffset) to indicate the periodicity of the reference signal. Optionally, periodicities corresponding to all resources in a resource set are equal. Optionally, the periodicity corresponding to the reference signal is equal to the periodicity associated with the SBFD time domain resource(s). Optionally, the periodicity corresponding to the reference signal is a multiple of the periodicity associated with the SBFD time domain resource(s). The periodicity corresponding to the reference signal is a positive integer multiple of the periodicity associated with the SBFD time domain resource(s). Limiting the periodicity corresponding to the reference signal may make the transmission occasion corresponding to the reference signal only occur in the SBFD time domain resource(s) or the non-SBFD time domain resource(s), such that the UE may average the measurement results corresponding to a plurality of measurement occasions of the same reference signal, thus improving the accuracy of the CSI.

In some cases, the time domain position of the CSI reference resource associated with/corresponding to the CSI report corresponding to the CSI reporting configuration is determined based on a valid downlink slot. For example, in time domain, for periodic or semi-persistent CSI report, the UE may determine the CSI reference resource (the valid downlink slot where the CSI reference resource is located) based on the number of the CSI-RS/SSB resources for channel measurement. For example, in time domain, for aperiodic CSI report, the UE may determine the CSI reference resource (the valid downlink slot where the CSI reference resource is located) based on the time domain position of the CSI request triggering the aperiodic CSI report. A method for the UE to determine the valid downlink slot based on the SBFD configuration will be further explained below. In the disclosure, the term “valid downlink slot” may be used interchangeably with the term “valid slot”. For example, when a fourth condition is satisfied, a first slot for/in a second cell may be considered as a valid downlink slot. Optionally, the second cell is the serving cell. Optionally, the second cell may be at least one of the SBFD cell, the cell in the same frequency band as the SBFD cell, the cell where the CSI resource setting is located, and the cell where the CSI reporting configuration is located. Optionally, the fourth condition includes at least one of the followings:
The first slot is not in a configured measurement gap for the UE;
The first slot includes at least one downlink symbol or flexible symbol configured by the high layer;
The first slot includes at least one symbol in the first time domain resource(s);
The first time domain resource(s) are the SBFD time domain resource(s), and the first slot includes at least one symbol in the first time domain resource(s);
The first time domain resource(s) are the non-SBFD time domain resource(s), and the first slot includes at least one symbol in the first time domain resource(s);
The first time domain resource(s) are the SBFD time domain resource(s), and the first slot includes at least one symbol in the first time domain resource(s); or, the first time domain resource(s) are the non-SBFD time domain resource(s), and the first slot includes at least one symbol in the first time domain resource(s), and the first slot includes at least one downlink symbol or flexible symbol configured by the high layer; or, the first time domain resource(s) are the SBFD time domain resource(s) and the non-SBFD time domain resource(s), and the first slot includes at least one downlink symbol or flexible symbol configured by the high layer;
The first time domain resource(s) are the SBFD time domain resource(s), and the first slot only includes the symbol in the first time domain resource(s); or, the first time domain resource(s) are the non-SBFD time domain resource(s), and the first slot only includes the symbol in the first time domain resource(s), and the first slot includes at least one downlink symbol or flexible symbol configured by the high layer; or, the first time domain resource(s) are the SBFD time domain resource(s) and the non-SBFD time domain resource(s), and the first slot includes at least one downlink symbol or flexible symbol configured by the high layer.

The above method may determine the CSI reference resource corresponding to the CSI report based on the SBFD time domain resource(s), such that the UE may perform measurement for the SBFD time domain resource(s) and/or the non-SBFD time domain resource(s), so as to obtain the reference of the CSI measurement on the corresponding time domain resource(s), thereby improving the accuracy of the CSI.

In some cases, the report quantity parameter (e.g., reportQuantity) corresponding to the CSI reporting configuration (the report quantity parameter with which the CSI reporting configuration is configured) (e.g., corresponding to at least one of Operation 1, Operation 2 and Operation 3) may include at least ‘RI’. For example, when the report quantity parameter (e.g., reportQuantity) corresponding to the CSI reporting configuration (the report quantity parameter with which the CSI reporting configuration is configured) includes at least ‘RI’, the UE performs at least one of Operation 1, Operation 2 and Operation 3 based on the first time domain resource(s). In the disclosure, the term “the report quantity parameter corresponding to the CSI reporting configuration (the report quantity parameter with which the CSI reporting configuration is configured) may include at least ‘RI’” may be used interchangeably with the term “the CSI includes at least ‘RI’”. For example, the report quantity parameter corresponding to the CSI reporting configuration (the report quantity parameter with which the CSI reporting configuration is configured) is set to at least one of ‘cri-RI-PMI-CQI’, ‘cri-RI-LI-PMI-CQI’, ‘cri-RI-i1’, ‘cri-RI-i1-CQI’ and ‘cri-RI-CQI’. For example, the report quantity parameter corresponding to the CSI reporting configuration (the report quantity parameter with which the CSI reporting configuration is configured) is set to at least one of ‘cri-RI-PMI-CQI’, ‘cri-RI-LI-PMI-CQI’, ‘cri-RI-i1-CQI’ and ‘cri-RI-CQI’. Adding the condition associated with the RI herein may restrict the CSI report for CSI/CQI computation by the CSI report being configured to report the RI, and because accurate CSI information is required for CSI/CQI computation, distinguishing the SBFD time domain resource(s) from the non-SBFD time domain resource(s) and then performing corresponding CSI-related operations may improve the accuracy of the CSI obtained by the UE and improve the efficiency of the communication system.

The disclosure provides several methods to enable the UE to perform CSI-related operations based on the SBFD configuration information, such that the UE/the base station may obtain CSI for the SBFD, and the flexibility of the CSI reporting is improved.

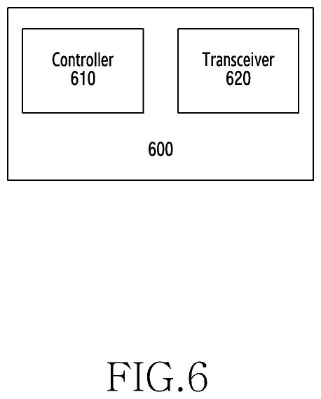

FIG. 6 illustrates a structure of a user equipment according to an embodiment of the disclosure.

Referring to FIG. 6, a structure of a user equipment 600 includes a controller 610 and a transceiver 620, wherein the controller 610 is configured to perform various methods disclosed herein and performed by the user equipment, and the transceiver 620 is configured to transmit and receive channels or signals.

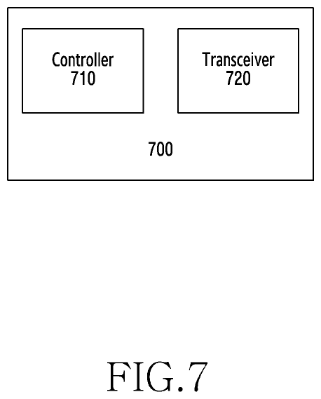

FIG. 7 illustrates a structure of a base station according to an embodiment of the disclosure.

Referring to FIG. 7, a structure of a network device 700 (e.g., a base station) includes a controller 710 and a transceiver 720, wherein the controller 710 is configured to perform various methods performed by the network device as disclosed herein above, and the transceiver 720 is configured to transmit or receive channels or signals.

Furthermore, “at least one of” described in the disclosure includes any and/or all possible combinations of the listed items, and the embodiment and examples in the embodiment described in the disclosure may be changed and combined in any suitable form, and “/” described in the disclosure denotes “or”, “and” or “and/or”.

In some embodiments, contents described in bracket “( )” in the disclosure may be optional.

In the disclosure, the downlink channel/downlink signal overlapped with frequency domain resource(s) other than the downlink subband(s) associated with the SBFD frequency domain resource(s) may refer to the downlink channel/downlink signal overlapped with the uplink subband and/or guard band associated with the SBFD frequency domain resource(s), or the downlink channel/downlink signal overlapped with the uplink subband and/or guard band associated with the SBFD frequency domain resource(s), or, the downlink channel/downlink signal overlapped with the frequency domain resource(s) other than the downlink subband associated with the SBFD frequency domain resource(s), or at least one PRB/RE of the downlink channel/downlink signal only overlapped with the frequency domain resource(s) other than the downlink subband associated with the SBFD frequency domain resource(s), or at least one PRB/RE of the downlink channel/downlink signal not overlapped with the downlink subband associated with the SBFD frequency domain resource(s).

In the disclosure, the downlink channel/downlink signal overlapped with the downlink subband associated with the SBFD frequency domain resource(s) may refer to all/each PRB(s)/RE(s) of the downlink channel/downlink signal overlapped with the downlink subband associated with the SBFD frequency domain resource(s), or all/each PRB(s)/RE(s) of the downlink channel/downlink signal not overlapped with the frequency domain resource(s) other than the downlink subband associated with the SBFD frequency domain resource(s).

In the disclosure, the uplink channel/uplink signal overlapped with the frequency domain resource(s) other than the uplink subband associated with the SBFD frequency domain resource(s) may refer to the uplink channel/uplink signal overlapped with the downlink subband and/or guard band associated with the SBFD frequency domain resource(s), or the uplink channel/uplink signal overlapped with the frequency domain resource(s) other than the uplink subband associated with the SBFD frequency domain resource(s), or at least one PRB/RE of the uplink channel/uplink signal only overlapped with the frequency domain resource(s) other than the uplink subband associated with the SBFD frequency domain resource(s), or at least one PRB/RE of the uplink channel/uplink signal not overlapped with the uplink subband associated with the SBFD frequency domain resource(s).

In the disclosure, the uplink channel/uplink signal overlapped with the uplink subbands associated with the SBFD frequency domain resource(s) may refer to all/each PRB(s)/RE(s) of the uplink channel/uplink signal overlapped with the uplink subband associated with the SBFD frequency domain resource(s), or all/each PRB(s)/RE(s) of the uplink channel/uplink signal not overlapped with the frequency domain resource(s) other than the uplink subbands associated with the SBFD frequency domain resource(s).

In some cases, the UE may perform at least one of the following operations on signals and/or channels.
Operation 1: SBFD related operation. Optionally, Operation 1 is an SBFD related operation for the downlink channel/downlink signal. Optionally, Operation 1 is an SBFD related operation to restrict UE reception. Optionally, the UE does not receive (or drop, or do not monitor) the downlink channel/downlink signal overlapped with the frequency domain resource(s) other than the downlink subband(s) associated with the SBFD frequency domain resource(s). Optionally, in the SBFD time domain resource(s), if a downlink channel/downlink signal is overlap overlapped with the frequency domain resource(s) other than the downlink subband(s) associated with the SBFD frequency domain resource(s), the UE does not receive the downlink channel/downlink signal, or the UE drops the reception of the downlink channel/downlink signal. Optionally, in the SBFD time domain resource(s), if the UE would receive a downlink channel/downlink signal, and the downlink channel/downlink signal is overlapped with the frequency domain resource(s) other than the downlink subband(s) associated with the SBFD frequency domain resource(s), the UE does not receive the downlink channel/downlink signal, or the UE will drop the reception of the downlink channel/downlink signal. Optionally, the downlink channel may be at least one of PDCCH and PDCCH. Optionally, the PDSCH may be at least one of semi-persistent scheduling (SPS) PDSCH or PDSCH without corresponding PDCCH or PDSCH without associated DCI format. Optionally, the PDSCH without corresponding PDCCH may be a PDSCH without corresponding PDCCH transmission. Optionally, the downlink signal may be at least one of CSI-RS, SSB and reference signal for positioning. Optionally, the downlink signal may be at least one of periodic CSI-RS and semi-persistent CSI-RS. For example, in the SBFD time domain resource(s), the UE would receive an SPS PDSCH (or a PDSCH without corresponding PDCCH), and the SPS PDSCH (or PDSCH without corresponding PDCCH) is overlapped with the frequency domain resource(s) other than the downlink subband(s) associated with the SBFD frequency domain resource(s), then the UE does not receive the SPS PDSCH (or PDSCH without corresponding PDCCH), or the UE drop the SPS PDSCH (or PDSCH without corresponding PDCCH). For example, in the SBFD time domain resource(s), if the CORESET associated with a search space set is overlapped with the frequency domain resource(s) other than the downlink subband(s) associated with the SBFD frequency domain resource(s), the UE does not monitor PDCCH on the search space, or the UE does not monitor PDCCH candidate on the search space. Optionally, the frequency domain resource(s) may be at least one of one or more PRBs/REs/subbands. Optionally, the time domain resource(s) may be one or more slots, or one or more symbols. Optionally, the downlink channel/downlink signal overlapped with the frequency domain resource(s) may be that the resources of the downlink channel/downlink signal overlapped with the frequency domain resource(s). Optionally, PDSCH may be a repetition of PDSCH. Optionally, SPS PDSCH may be a repetition of SPS PDSCH. Optionally, the PDSCH without corresponding PDCCH may be a repetition of the PDSCH without corresponding PDCCH. When (part of/all of) the downlink signal/downlink channel is outside the downlink subband associated with the SBFD frequency domain resource(s), the downlink signal/downlink channel may not be transmitted by the base station. Accordingly, the UE not receiving or dropping the downlink signal/downlink channel may avoid subsequent processing of the downlink signal/downlink channel by the UE, saving energy consumption of the UE and improving the efficiency of the communication system.
Operation 2: SBFD related operation. Optionally, SBFD related operation for the uplink channel/uplink signal. Optionally, SBFD related operation to restrict UE transmission. Optionally, the UE does not transmit the uplink channel/uplink signal overlapped with the frequency domain resource(s) other than the uplink subband associated with the SBFD frequency domain resource(s), or the UE drops (or cancels or postpones) the transmission of the uplink channel/uplink signal overlapped with the frequency domain resource(s) other than the uplink subband associated with the SBFD frequency domain resource(s). Optionally, in the SBFD time domain resource(s), if an uplink channel/uplink signal is overlapped with the frequency domain resource(s) other than the uplink subband associated with the SBFD frequency domain resource(s), the UE does not transmit the uplink channel/uplink signal, or the UE drops/cancels/postpone the transmission of the uplink channel/uplink signal. Optionally, in the SBFD time domain resource(s), if the UE would transmit an uplink channel/uplink signal and the uplink channel/uplink signal is overlapped with the frequency domain resource(s) other than the uplink subband associated with the SBFD frequency domain resource(s), the UE does not transmit the uplink channel/uplink signal, or the UE drops (or cancels, or postpones) the transmission of the uplink channel/uplink signal. Optionally, the uplink channel may be at least one of PUSCH and PUCCH. Optionally, the PUSCH may be at least one of a configured grant PUSCH, a PUSCH without corresponding PDCCH, or a PUSCH without associated DCI format. Optionally, the PUSCH without corresponding PDCCH may be a PUSCH without corresponding PDCCH transmission. Optionally, the uplink signal may be at least one of SRS, SSB and PRACH. Optionally, the uplink signal may be at least one of a periodic SRS and a semi-persistent SRS. For example, in the SBFD time domain resource(s), the UE would receive a configured grant PUSCH (or PUSCH without corresponding PDCCH), and the configured grant PUSCH (or PUSCH without corresponding PDCCH) is overlapped with the frequency domain resource(s) other than the uplink subband associated with the SBFD frequency domain resource(s), then the UE does not transmit the configured grant PUSCH (or PUSCH without corresponding PDCCH), or the UE drops (or cancels, or postpones) the transmission of the configured grant PUSCH (or PDUCH without corresponding PDCCH). For example, in the SBFD time domain resource(s), if the PUCCH is overlapped with the frequency domain resource(s) other than the uplink subband associated with the SBFD frequency domain resource(s), the UE does not transmit the PUCCH, or the UE drops (or cancels, or postpones) the transmission of the configured grant PUCCH. Optionally, after resolving the overlapping for PUCCH and/or PUSCH transmissions, and in the SBFD time domain resource(s), a PUCCH is overlapped with the frequency domain resource(s) other than the uplink subband associated with the SBFD frequency domain resource(s), (and the PUCCH does not include/is not multiplexed with HAQR-ACK information), the UE does not transmit the PUCCH, or the UE drops (or cancels or postpones) the transmission of the PUCCH. Optionally, after resolving the overlapping for PUCCH and/or PUSCH transmissions, and in the SBFD time domain resource(s), a PUSCH is overlapped with the frequency domain resource(s) other than the uplink subband associated with the SBFD frequency domain resource(s), (and the PUSCH does not include/is not multiplexed with HAQR-ACK information and/or the PUSCH does not have corresponding PDCCH), the UE does not transmit the PUSCH, or the UE drops (or cancels or postpones) the transmission of the PUSCH. Optionally, the frequency domain resource may be at least one of a PRB, a RE and a subband. Optionally, the time domain resource may be one or more slots, or one or more symbols. Optionally, the uplink channel/uplink signal overlapped with the frequency domain resource(s) may be that the resource(s) of the uplink channel/uplink signal is overlapped with the frequency domain resource(s). Optionally, the PUSCH may be a repetition of PUSCH. Optionally, the configured grant PUSCH may be a repetition of the configured grant PUSCH. Optionally, the PUSCH without corresponding PDCCH may be a repetition of the PUSCH without corresponding PDCCH. When (part of/all of) the uplink signal/uplink channel is outside the uplink subband associated with the SBFD frequency domain resource(s), the uplink signal/uplink channel may not be transmitted, so that UE does not transmit/drop/cancel/postpone the uplink signal/uplink channel, which may reduce the processing of the uplink signal/uplink channel by the UE, save energy consumption of the UE and improve the efficiency of the communication system.

Optionally, the UE multiplexes UCIs with same priority index in a PUCCH or a PUSCH before/after considering limitations for UE transmission due to SBFD related operation. This method clarifies the sequence relationship between UCI multiplexing and SBFD related operation (for example, Operation 2), such that the base station and the UE may have the same understanding of the result of UCI multiplexing and the reliability of the communication system is improved.

In some cases, if the UE is configured to receive SPS PDSCH and the UE multiplexes the HARQ-ACK information for an activated SPS PDSCH reception, the UE generates a HARQ-ACK information bit associated with the reception of a specific SPS PDSCH on the PUCCH. Optionally, a HARQ-ACK information bit associated with the reception of the specific SPS PDSCH is added after O^{ACK} HARQ-ACK information bits. Optionally, the specific SPS PDSCH includes an SPS PDSCH associated with/corresponding to activation DCI. Optionally, the PUCCH is on slot n. Here, HARQ refers to Hybrid Automatic Repeat Request. Here, ACK refers to Acknowledgement. Optionally, one activated SPS PDSCH reception provides transport block with enabled HARQ-ACK information report. Optionally, the PRB/RE of SPS PDSCH refers to the PRB/RE of PDSCH resource(s) (for example, nominal resources of PDSCH) corresponding to SPS PDSCH. Optionally, the specific SPS PDSCH may be/include at least one of the followings (or, the specific SPS PDSCH satisfies at least one of the following conditions):
The specific SPS PDSCH is associated with/corresponds to activation DCI; or the specific SPS PDSCH includes an SPS PDSCH associated with/corresponding to activation DCI;
The specific SPS PDSCH is in the SBFD time domain resource(s), and all/each (or any) PRB/RE of the specific SPS PDSCH is overlapped (or completely overlapped) with the downlink subband(s) associated with the SBFD frequency domain resource(s); or the specific SPS PDSCH is in the SBFD time domain resource(s), and all/each (or any) PRB/RE of the specific SPS PDSCH is not overlapped with the frequency domain resource(s) other than the downlink subband(s) associated with the SBFD frequency domain resource(s); or the specific SPS PDSCH is in the SBFD time domain resource(s), and the specific SPS PDSCH is not overlapped with the frequency domain resource(s) other than the downlink subband(s) associated with the SBFD frequency domain resource;
The specific SPS PDSCH is in the serving cell where the SBFD configuration information is located/indicated by the SBFD configuration information;
The serving cell where the specific SPS PDSCH is located and the serving cell where the SBFD configuration information is located/indicated by the SBFD configuration information are in the same frequency band;
The SPS PDSCH is not overlapped with a non-active period of cell DTX for a serving cell of the SPS PDSCH reception if cell DTX is activated for the serving cell.

Optionally, the specific SPS PDSCH is not/does not include at least one of the followings (or, the specific SPS PDSCH does not satisfy at least one of the following conditions):
SPS PDSCH provide only transport blocks with disabled HARQ-ACK information report;
SPS PDSCH is in the SBFD time domain resource(s), and the specific SPS PDSCH is overlapped with the frequency domain resource(s) other than the downlink subband(s) associated with the SBFD frequency domain resource(s);
SPS PDSCH is in the serving cell where the SBFD configuration information is located/indicated by the SBFD configuration information, and SPS PDSCH is in the SBFD time domain resource(s), and the specific SPS PDSCH is overlapped with the frequency domain resource(s) other than the downlink subband(s) associated with the SBFD frequency domain resource(s);
The serving cell where SPS PDSCH is located and the serving cell where the SBFD configuration information is located/indicated by the SBFD configuration information are in the same frequency band, and SPS PDSCH is in the SBFD time domain resource(s), and the specific SPS PDSCH is overlapped with the frequency domain resource(s) other than the downlink subband(s) associated with the SBFD frequency domain resource(s);
The SPS PDSCH is overlapped with a non-active period of cell DTX of a serving cell of the SPS PDSCH reception if cell DTX is activated for the serving cell.

Since the SPS PDSCH of the frequency domain resource(s) other than the downlink subband associated with the SBFD frequency domain resource(s) in the SBFD time domain resource(s) is not received by the UE (for example, the SPS PDSCH is not received based on Operation 1), the UE does not generate corresponding HARQ-ACK information for the SPS PDSCH, which may save the overhead of uplink signaling and improve the efficiency of the communication system.

In some cases, if the UE is configured to receive SPS PDSCH and the UE multiplexes the received HARQ-ACK information for multiple activated SPS PDSCH, the UE generates the HARQ-ACK information associated with the reception of a specific SPS PDSCH on the PUCCH. Optionally, one HARQ-ACK information bit associated with the reception of the specific SPS PDSCH is added after O^{ACK} HARQ-ACK information bits. Optionally, the specific SPS PDSCH includes an SPS PDSCH corresponding to/activating DCI. Optionally, the PUCCH is on slot n. Optionally, the PRB/RE received by SPS PDSCH refers that SPS PDSCH receives the PRB/RE of the corresponding PDSCH resource (for example, the nominal resource of PDSCH). Optionally, the specific SPS PDSCH may be/include at least one of the followings (or, the specific SPS PDSCH satisfies at least one of the following conditions):
The specific SPS PDSCH is associated with/corresponds to activation DCI; the specific SPS PDSCH includes SPS PDSCH associated with/corresponding to activation DCI;
The specific SPS PDSCH is in the SBFD time domain resource(s), and all/each (or any) PRB/RE of the specific SPS PDSCH overlaps (or completely overlaps) with the downlink subband associated with the SBFD frequency domain resource(s); or the specific SPS PDSCH is in the SBFD time domain resource(s), and all/each (or any) PRB/RE of the specific SPS PDSCH does not overlap with the frequency domain resource(s) other than the downlink subband associated with the SBFD frequency domain resource(s);
The specific SPS PDSCH is in the serving cell where the SBFD configuration information is located/indicated by the SBFD configuration information;
The serving cell where the specific SPS PDSCH is located and the serving cell where the SBFD configuration information is located/indicated by the SBFD configuration information are in the same frequency band;
The SPS PDSCH does not overlap with a non-active period of cell DTX of a serving cell of the SPS PDSCH reception if cell DTX is activated for the serving cell.

Optionally, the specific SPS PDSCH is not/does not include at least one of the followings (or, the specific SPS PDSCH does not satisfy at least one of the following conditions):
SPS PDSCH provide only transport blocks with disabled HARQ-ACK information report;
SPS PDSCH is in the SBFD time domain resource(s), and the specific SPS PDSCH overlaps with the frequency domain resource(s) other than the downlink subband associated with the SBFD frequency domain resource(s);
the SPS PDSCH overlaps with a non-active period of cell DTX of a serving cell of the SPS PDSCH reception if cell DTX is activated for the serving cell.

Since the SPS PDSCH of the frequency domain resource(s) other than the downlink subband associated with the SBFD frequency domain resource(s) in the SBFD time domain resource(s) is not received by the UE (for example, the SPS PDSCH is not received based on Operation 1), the UE does not generate corresponding HARQ-ACK information for the SPS PDSCH, which may save the overhead of uplink signaling and improve the efficiency of the communication system.

In some cases, if more than one PDSCH on a serving cell each without a corresponding PDCCH transmission are in a slot, the UE receives one or more PDSCHs without corresponding PDCCH(s). Optionally, if more than one PDSCH on a serving cell each without a corresponding PDCCH transmission are in a slot, the UE receives one or more PDSCHs without corresponding PDCCHs after resolving the overlapping in the SBFD time domain resource(s) (e.g., one or more symbols included in/corresponding to the SBFD time domain resource(s)) in the slot for the frequency domain resource(s) other than the downlink resources of the SBFD frequency domain resource(s). Here, resolving the overlapping in the SBFD time domain resource(s) (e.g., one or more symbols included in/corresponding to the SBFD time domain resource(s)) in the slot for the frequency domain resource(s) other than the downlink resources of the SBFD frequency domain resource(s) refers to that if one/each/any of the more than one PDSCH without corresponding PDCCH is within the SBFD time domain resource(s) and the PDSCH overlaps with the frequency domain resource(s) other than the downlink resources of SBFD frequency domain resource(s), then the PDSCH is not received. For example, in slot n, there are PDSCH #1, PDSCH #2, PDSCH #3 and PDSCH #4, and none of these PDSCH has a corresponding PDCCH. In these four PDSCHs, PDSCH #2 and PDSCH #3 are in SBFD symbols (e.g., symbols indicated by the SBFD time domain information) and overlap with the frequency domain resource(s) other than downlink resources of the SBFD frequency domain resource(s), then the UE receives PDSCH #1 and PDSCH #4 (that is, does not receive PDSCH #2 and PDSCH #3). For PDSCHs that need to be received (for example, PDSCH #1 and PDSCH #4), or for one or more PDSCHs (for example, PDSCH #1 and PDSCH #4) after the overlapping is resolved, the UE may determine how to receive these PDSCHs according to the UE capability and the following steps. Optionally, in the slot, steps for the UE to receive one or more PDSCHs without corresponding PDCCH(s) are as follows:
Step 0: set j=0, where j is the number of selected PDSCH(s) for decoding. Q is the set of activated PDSCHs without corresponding PDCCH transmissions within the slot.
Step 1: the UE receives one PDSCH with the lowest configured sps-ConfigIndex within Q, set j=j+1. Designate the received PDSCH as survivor PDSCH.
Step 2: the survivor PDSCH in step 1 and any other PDSCH(s) overlapping (even partially) with the survivor PDSCH in step 1 are excluded from Q.
Step 3: repeat step 1 and 2 until Q is empty or j is equal to the number of unicast/multicast PDSCHs in a slot supported by the UE.

The above method may enable the UE to exclude the PDSCH that is unnecessary to be received based on the SBFD operation (for example, Operation 1), and then determine which PDSCH is received based on the UE's ability/steps, so as to prevent the UE from receiving the PDSCH that is unnecessary to be received due to the SBFD operation and improve the efficiency of the communication system.

In some cases, after resolving the overlapping for PUCCH and/or PUSCH transmissions, and in the SBFD time domain resource(s), a PUCCH overlaps with the frequency domain resource(s) other than the uplink subband associated with the SBFD frequency domain resource(s), the UE drops/cancels/postpones/does not transmit the PUCCH. In some cases, after resolving the overlapping for PUCCH and/or PUSCH transmissions, and in the SBFD time domain resource(s), a PUSCH without corresponding PDCCH overlaps with the frequency domain resource(s) other than the uplink subband associated with the SBFD frequency domain resource(s), the UE drops/cancels/postpone/does not transmit the PUSCH. This method may resolve the overlapping for PUCCH and/or PUSCH and determine the transmission order of the uplink channel/uplink signal based on the SBFD operation (for example, Operation 2), such that the UE and the base station may have common understanding of the actually transmitted uplink signal/uplink channel and the reliability of the communication system is improved.

In some cases, the UE may receive/be configured with the CSI reporting configuration. Optionally, the report quantity parameter (for example, reportQuantity) associated with the CSI reporting configuration is not set to “none”. Optionally, the UE determines the CSI and/or reports the CSI and/or reports the CSI report based on the CSI reporting configuration.
Optionally, the UE determines the CSI and/or reports the CSI based on the reference signal resource associated with the CSI reporting configuration. Optionally, the reference signal resource associated with the CSI reporting configuration refers to the resource in the reference signal resource set for channel measurement indicated by/configured by/corresponding to the CSI reporting configuration, and/or the resource in the reference signal resource set for interference measurement indicated by/configured by/corresponding to the CSI reporting configuration, and/or the reference signal resource for link quality assessment. Optionally, the size of the reference signal resource set for channel measurement is K (K≥1). Optionally, the reference signal resource may be the SSB resource or CSI-RS resource. Optionally, in case that the reference signal resource is the CSI-RS resource, the reference signal resource or the reference signal resource set is periodic/semi-persistent.
Optionally, the UE may be configured with a high-layer parameter (e.g., dl-OrJointTCI-StateList) associated with a TCI state. Optionally, the higher-layer parameter (for example, dl-OrJointTCI-StateList) associated with the TCI state is in a higher-layer parameter PDSCH-Config. Optionally, the higher-layer parameter (e.g., dl-OrJointTCI-StateList) associated with the TCI state is for providing a reference signal for the quasi co-location for DM-RS of PDSCH and DM-RS of PDCCH in a BWP/CC, for CSI-RS, and to provide a reference, if applicable, for determining uplink transmission spatial filter. Optionally, the uplink transmission spatial filter is for dynamic-grant and configured-grant based PUSCH and PUCCH resource, and SRS. Optionally, the UE receives/applies an indication of the TCI state. Optionally, the UE receives/applies/has the indicated TCI state. Optionally, the UE applies/uses the indicated TCI state after receiving TCI state indication information. Optionally, the reference signal associated with/corresponding to the indicated TCI state is an SSB that is quasi-co-located with the QCL (quasi-co-location) reference signal of the indicated TCI state, or the reference signal associated with/corresponding to/included in the indicated TCI state is a reference signal of the indicated TCI state. Optionally, if a TCI state is associated with/includes/corresponds to two QCL reference signals, the reference signal(s) associated with/corresponding to/included in the TCI state are the QCL type-D reference signals included in/corresponding to the TCI state. Optionally, if the resource(s) in the resource set is SSB resource(s), the reference signal associated with/corresponding to the indicated TCI state is an SSB that is quasi-co-located with the QCL (quasi-co-location) reference signal of the indicated TCI state. Optionally, if the resource in the resource set(s) is CSI-RS resource(s), the reference signal associated with/corresponding to the indicated TCI state is a QCL (quasi-co-location) reference signal associated with/corresponding to/included in the indicated TCI state, wherein the reference signal is a CSI-RS. Optionally, the indicated TCI state may be an indicated unified TCI state.
Optionally, the UE transmits a first uplink channel or a first uplink signal. Optionally, the first uplink channel may be one of PUCCH, PUSCH and PRACH. Optionally, the first uplink signal may be one of SRS, demodulation reference signal (DM-RS) of PUSCH and DM-RS of PUCCH. Optionally, the first uplink channel or the first uplink signal indicates/notifies a second uplink channel to carry the CSI report. Optionally, the second uplink channel is determined based on the first uplink channel/first uplink signal. Optionally, the serving cell (or component carrier) where the second uplink channel is located is determined based on the first uplink channel/first uplink signal. Optionally, the slot (e.g., starting slot) where the second uplink channel is located and/or the starting symbol (of each slot in slots where the second uplink channel is located) is determined based on the first uplink channel/first uplink signal. Optionally, the second uplink channel may be PUSCH or PUCCH.
Optionally, the first uplink channel or the first uplink signal is triggered based on the resource set (for example, the resource set for channel measurement associated with the CSI reporting configuration) and/or the indicated TCI state. Optionally, the first uplink channel or the first uplink signal is triggered based on the reference signal associated with/corresponding to the resources in the resource set and/or the reference signal associated with/corresponding to the indicated TCI state. Optionally, the first uplink channel or the first uplink signal is triggered based on the difference between the measured L1-RSRP corresponding to the reference signal associated with/corresponding to the resources in the resource set and/or the measured L1-RSRP corresponding to the indicated TCI state being greater than or equal to a threshold configured by RRC. For example, the threshold configured by RRC is 6 dB, and the L1-RSRP corresponding to CSI-RS #1 in the measurement resource set is higher than the L1-RSRP corresponding to the reference signal associated with/corresponding to the TCI state by 7 dB, then the first uplink channel or the first uplink signal may be triggered. Optionally, the UE applies the threshold to the measured L1-RSRP after scaling. Optionally, if the reference signal associated with the TCI state is different from the type of the reference signal in the resource set, the UE applies the threshold to the measured L1-RSRP after scaling. If one reference signal is SSB and the other reference signal is CSI-RS, it may be considered that the types of these two reference signals are different. Optionally, the measured L1-RSRP after scaling refers to the measured L1-RSRP after scaling the received power of the CSI-RS using a power offset parameter (e.g., powerControlOffsetSS) with which the corresponding CSI-RS resource is configured. Optionally, scaling the received power of the CSI-RS refers to subtracting the value corresponding to powerControlOffsetSS from the L1-RSRP corresponding to the CSI-RS. For example, the threshold configured by RRC is 6 dB, and the L1-RSRP corresponding to SSB #1 in the measurement resource set is higher than the L1-RSRP corresponding to the CSI-RS associated with/corresponding to the TCI state by 4 dB, at this time, the L1-RSRP corresponding to the CSI-RS needs to be scaled according to powerControlOffsetSS (for example, 3 dB). After scaling, the L1-RSRP corresponding to SSB #1 is higher than the L1-RSRP corresponding to the CSI-RS associated with/corresponding to the TCI state by 7 dB, which is higher than the threshold, so the first uplink channel or the first uplink signal may be triggered. This method may cause the transmission power of CSI-RS and SSB the same through corresponding scaling operation while comparing the L1-RSRPs among different types of reference signals (for example, CSI-RS and SSB), thus ensuring the accuracy of the comparison result and improving the reliability of the communication system.
Optionally, the first uplink channel or the first uplink signal is transmitted when at least one of the following conditions is satisfied:
Condition 1: the difference between the measured L1-RSRP corresponding to at least one same reference signal in the resource set in each of the latest consecutive Y_{win} measurement windows (earlier/no later than the first uplink channel or the first uplink signal) and the measured L1-RSRP corresponding to the reference signal associated with/corresponding to the indicated TCI state is greater than or equal to T_thr. Optionally, Y_{win} and/or T_thr are configured by RRC. Optionally, Y_{win} is predefined (for example, Y_{win} is 1 or 2). Optionally, the indicated TCI state refers to the indicated TCI state used/applied in the slot where the first uplink channel or the first uplink signal is located. Optionally, A1 may be an integer greater than or equal to 1. Optionally, A1 may be predefined or determined based on the configuration/indication of the base station. Optionally, A1 may be based on the UE capability.
Condition 2: the difference between the measured L1-RSRP corresponding to at least one same reference signal in the resource set in each of the latest consecutive Y_{win} measurement windows (with X_eva symbols being earlier than the first symbol of the first uplink channel or the first uplink signal) and the measured L1-RSRP corresponding to the reference signal associated with/corresponding to the indicated TCI state is greater than or equal to T_thr. Optionally, Y_{win} and/or T_thr are configured by RRC. Optionally, Y_{win} is predefined (for example, Y_{win} is 1 or 2). Optionally, X_eva may be configured by RRC, or predefined, or based on the UE capability. Optionally, the indicated TCI state refers to the indicated TCI state used/applied in the slot where the first uplink channel or the first uplink signal is located. Optionally, A2 may be an integer greater than or equal to 1. Optionally, A1 may be predefined or determined based on the configuration/indication of the base station. Optionally, A1 may be based on the UE capability.
The indicated TCI state for determining the triggering/transmission of the first uplink channel (or the first uplink signal) needs to be clarified. The indicated TCI status may be different at different time points, therefore, it is necessary to specify which time point the reported information related to the indicated TCI status is based on/for. Optionally, the indicated TCI state for determining the triggering/transmission of the first uplink channel (or the first uplink signal) may be the indicated TCI state applied in/used in/corresponding to/associated with the slot where the first uplink channel/first uplink signal is located. Optionally, the indicated TCI state associated with the CSI included in the CSI report on the second uplink channel may be the indicated TCI state applied in/used in/corresponding to/associated with the slot which is Q slot before the first uplink channel/first uplink signal is located. Optionally, Q is configured by the base station. Optionally, Q is predefined. Optionally, Q is based on the UE capability. Optionally, the value of Q may be at least one of 0, 1, 2, 3 and 4. Optionally, the value of Q may be determined based on the time domain interval (e.g., time domain offset, e.g., slot offset) between the first uplink channel (or the first uplink signal) and the second uplink channel. For example, Q is an integer (greater than or equal to 1) multiple of the time domain interval between the first uplink channel (or the first uplink signal) and the second uplink channel. Optionally, the value of Q may be determined based on the periodicity of the resource in the resource set. For example, Q is an integer (greater than or equal to 1) multiple of the resource periodicity. The above method clarifies the time point corresponding to the information related to the indicated TCI state for determining the triggering/transmission of the first uplink channel (or the first uplink signal), ensures that the UE and the base station have the same understanding of the indicated TCI state, and improves the reliability of the communication system.
Optionally, the UE receives/detects feedback for the first uplink channel (or, the first uplink signal). Optionally, the feedback may be one of PDCCH and PDSCH. Optionally, the PDCCH corresponds to/is associated with DCI format 0_1 or 0_2.
Optionally, the UE transmits the second uplink channel. Optionally, the second uplink channel carries the CSI/CSI report associated with the CSI reporting configuration.
Optionally, the time domain position of the second uplink channel is determined based on the feedback for the first uplink channel (or the first uplink signal).
Optionally, the time domain position of the second uplink channel is determined based on the first uplink channel or the first uplink signal. Optionally, the slot offset between the second uplink channel and the first uplink channel/first uplink signal is predefined, or based on the indication of the base station or based on the UE capability. For example, the slot offset is configured by the CSI reporting configuration.
Optionally, the UE is not expected to measure channel/interference on the CSI-RS/SSB. Optionally, the last symbol of the CSI-RS/SSB is received up to Z′ symbols before transmission time of the first symbol of the CSI reporting on the second UL channel.
Optionally, the UE may be indicated by the base station whether to report the reference signal information (for example, CRI/SSBRI) associated with the indicated TCI state and/or the corresponding L1-RSRP. Optionally, when the UE is indicated to report the reference signal information associated with the indicated TCI state, the UE reports the reference signal resource associated with the indicated TCI state and/or the CSI associated with the reference signal resource associated with/corresponding to the resource set for channel measurement in one report instance. Optionally, the CSI includes CRI/SSBRI and/or (corresponding) L1-RSRP. Optionally, the size of the CSI field corresponding to CRI/SSBRI may be determined based on K. For example, the size of the CSI field corresponding to CRI/SSBRI is equal to [log₂(K+1)]. The value of CRI/SSBRI is recorded as k (k≥0). Optionally, CRI/SSBRI k corresponds to the k+1-th resource configured in the resource set. Optionally, when the value of CRI/SSBRI is equal to the size of the resource set (for example, k=K), the CRI/SSBRI corresponds to the reference signal associated with/corresponding to the indicated TCI state (or the resource corresponding to the reference signal associated with/corresponding to the indicated TCI state). This method clarifies the reporting method for the beam associated with the indicated TCI state, such that the base station may obtain the measurement of the current beam indicated by the UE, facilitating the scheduling of the base station and improving the flexibility of the communication system. In addition, because the indicated TCI state may be different at different time points, it is necessary to clarify that which time point the reported information associated with the indicated TCI state is based on/for. Optionally, the indicated TCI state associated with the CSI included in the CSI report on the second uplink channel may be the indicated TCI state applied by/used by/corresponding to/associated with the slot where the CSI reference resource corresponding to the CSI report is located. Optionally, the indicated TCI state associated with the CSI included in the CSI report on the second uplink channel may be the indicated TCI state applied by/used by/corresponding to/associated with the slot where the first uplink channel/first uplink signal is located. Optionally, the indicated TCI state associated with the CSI included in the CSI report on the second uplink channel may be the indicated TCI state applied by/used by/corresponding to/associated with the slot where the feedback for the first uplink channel/first uplink signal is located; or the TCI state indicated by the feedback for the first uplink channel/the first uplink signal. Optionally, the indicated TCI state associated with the CSI included in the CSI report on the second uplink channel may be the indicated TCI state applied/indicated TCI state used/corresponding indicated TCI state/associated indicated TCI state before the first uplink channel/first uplink signal; or the TCI state indicated by the feedback for the first uplink channel/the first uplink signal. The above methods clarify the time points corresponding to the information associated with the indicated TCI state associated with the reported CSI, ensures that the UE and the base station have the same understanding of the indicated TCI state, and improves the reliability of the communication system.
Optionally, the CSI report on the second uplink channel includes the CSI (for example, CRI/SSBRI and/or L1-RSRP) associated with the reference signal resource. Optionally, the reference signal satisfies at least one of the following conditions/features:
Condition 1/Feature 1: the difference between the measured L1-RSRP corresponding to the reference signal in each of the latest consecutive Y_{win} measurement windows (earlier/no later than the first uplink channel or the first uplink signal) and the measured L1-RSRP corresponding to the reference signal associated with/corresponding to the indicated TCI state is greater than or equal to T_thr. Optionally, Y_{win} and/or T_thr are configured by RRC. Optionally, Y_{win} is predefined (for example, 1 or 2). Optionally, the indicated TCI state refers to the indicated TCI state used/applied in the slot where the first uplink channel or the first uplink signal is located.
Condition 2/Feature 2: the difference between the measured L1-RSRP corresponding to the reference signal resource in each of the latest consecutive Y_{win} measurement windows (with X_eva symbols being earlier than the first symbol of the first uplink channel or the first uplink signal) and the measured L1-RSRP corresponding to the resource associated with/corresponding to the indicated TCI state is greater than or equal to T_thr. Optionally, Y win and/or T_thr are configured by RRC. Optionally, Y_{win} is predefined (for example, 1 or 2). Optionally, X_eva may be configured by RRC or predefined. Optionally, the indicated TCI state refers to the indicated TCI state used/applied in the slot where the first uplink channel or the first uplink signal is located.

The procedure/method associated with CSI processing unit (CPU) are described below. The UE indicates the number of supported simultaneous CSI calculations N_{CPU} with parameter simultaneousCSI-ReportsPerCC in a component carrier, and simultaneousCSI-ReportsAllCC across all component carriers.

The UE supporting N_{CPU} parallel CSI computations refers to the UE has N_{CPU} CSI processing units for processing the CSI report(s). If a UE supports N_{CPU} simultaneous CSI computations it is said to have N_{CPU} CSI processing units for processing CSI reports. If L CPUs are occupied for computation of CSI reports in a given OFDM symbol, the UE has N_{CPU}-L unoccupied CPUs.

If N CSI reports start occupying their respective CPUs on the same OFDM symbol on which N_{CPU}-L CPUs are unoccupied, where each CSI report n=0, . . . , N−1 corresponds to O_{CPU}(n), the UE is not required to update the N-M requested CSI reports with lowest priority, where O≤M≤N is the largest value such that Eₙ₌₀^{M-1} O_{CPU}(n)≤N_{CPU}-L holds. Processing of a CSI report (e.g., the CSI report corresponding to the CSI reporting configuration) occupies a number of CPUs on time domain resource(s).

In order for the base station to manage the CSI computing resources of the UE, the time domain resource(s) on which the CSI report on the second uplink occupies the CSI processing units (CPUs) need to be clarified. Methods provided below may define the time domain resource(s) on which the CSI report on the second uplink occupies the CPUs, such that the UE and the base station have the same understanding of the CPU occupation and improve the reliability of the communication system. Optionally, the time domain resource(s) on which the CSI report on the second uplink occupies the CPUs may be a number of OFDM symbols or a number of slots.
Optionally, the time domain resource(s) on which the CSI report on the second uplink occupies the CPUs may be determined based on at least one of the first uplink channel/first uplink signal, feedback for the first uplink channel/first uplink signal and the reference signal resource (for example, the reference signal resource in the resource set).
Optionally, if the UE receives or detects the feedback for the first uplink channel/the first uplink signal, the starting point of the time domain resource(s) on which the CSI report on the second uplink occupies the CPUs is based on the time resources after the feedback (for example, the first symbol/earliest symbol/first slot/earliest slot after the feedback, or the first symbol/earliest symbol/first slot/earliest slot after the last symbol of the feedback, or the first symbol/earliest symbol/first slot/earliest slot overlapped with the last symbol of the feedback).
Optionally, the starting point of the time domain resource(s) on which the CSI report on the second uplink occupies the CPUs may be determined based on the first uplink channel/first uplink signal. Because the base station needs certain time to decode after receiving the first uplink channel/first uplink signal, in some cases, the base station may only know that the UE will generate/transmits the CSI report on the second channel after a certain interval of the first uplink channel/first uplink signal. Therefore, the CSI report needs to start occupying CPUs after the certain interval of the first uplink channel and the first uplink signal, otherwise the base station may not know the use of CPU resources by the UE. Following methods may reserve enough time for the demodulation of the base station, ensure that the base station and UE have the consistent understanding of the time of the CPUs occupied by the CSI report on the second uplink channel, and ensure the reliability of the communication system. Optionally, the CSI report on the second channel occupies the CPUs from the first symbol (starting) after X symbols of the last symbol of the first uplink channel/first uplink signal. Here, “the last symbol of the first uplink channel/first uplink signal” is called “uplink ending symbol”. The “first symbol/earliest symbol occupied by the CSI report on the second channel” is called “CPU starting symbol”.
Optionally, the CPU starting symbol is the first symbol after at least X symbols of the uplink ending symbol. Optionally, “the first symbol after at least X symbols of the uplink ending symbol” may be called a first reference symbol. Optionally, the subcarrier spacing corresponding to/associated with the first symbol is based on/equal to: the subcarrier spacing of the second uplink channel, or the subcarrier spacing of the first uplink channel, or the larger/smaller subcarrier spacing between the subcarrier spacing of the first uplink channel and the subcarrier spacing of the second uplink channel. Optionally, the subcarrier spacing corresponding to/associated with X symbols is based on/equal to: the subcarrier spacing of the second uplink channel, or the subcarrier spacing of the first uplink channel, or the larger/smaller subcarrier spacing between the subcarrier spacing of the first uplink channel and the subcarrier spacing of the second uplink channel. Since the first uplink channel and the second uplink channel may be in different CCs, above methods may clearly determine the subcarrier spacing on which the CPU starting symbol is based, such that the base station and the UE have the same understanding and improve the reliability of the communication system.
Optionally, the symbol offset between the CPU starting symbol and the uplink ending symbol is X symbols. Optionally, “the symbol with the symbol offset of X symbols from the uplink ending symbol” may be referred as the first reference symbol. For example, the uplink ending symbol is at symbol n, and the CPU starting symbol is at symbol n+X. Optionally, the subcarrier spacing corresponding to/associated with at least one of X, symbol n, symbol n+X and CPU starting symbol is based on the subcarrier spacing of the second uplink channel, or the subcarrier spacing of the first uplink channel, or the larger/smaller subcarrier spacing between the subcarrier spacing of the first uplink channel and the subcarrier spacing of the second uplink channel. Because the first uplink channel and the second uplink channel may be in different CCs, above methods may clearly determine the subcarrier spacing on which the CPU starting symbol is based, such that the base station and the UE have the same understanding and improve the reliability of the communication system.
Optionally, the CPU starting symbol is the first/earliest symbol whose starting is no earlier than (the starting/ending of) the symbol n+X. Optionally, the CPU starting symbol is the first/earliest symbol whose starting is no earlier than (the starting/ending of) the symbol n+X+1. Optionally, the subcarrier spacing corresponding to/associated with symbol n (and/or symbol n+1 and/or symbol n+X+1 and/or X) is the subcarrier spacing of the first uplink channel. Optionally, “the first/earliest symbol whose starting is no earlier than (the starting/ending of) the symbol n+X” or “the first/earliest symbol whose starting is no earlier than (the starting/ending of) the symbol n+X+1” may be called the first reference symbol. Optionally, the subcarrier spacing corresponding to/associated with the CPU starting symbol (or the first/earliest symbol) is the subcarrier spacing of the second uplink channel.
Optionally, the value of X may be at least one of 1, 2, 4, 7, 14, 28, 42, 56, 70, 84, 98, 112, 224 and 336. Optionally, X may be predefined. Optionally, X may be indicated by the base station, for example, indicated/configured by the base station via the CSI reporting configuration. Optionally, when the base station does not configure/indicate X, the value of X is 0. Optionally, X may be based on the UE capability. For example, X is indicated by the reported UE capability signaling.
Optionally, the starting point of the time domain resource(s) on which the CSI report on the second uplink occupies the CPUs may be determined based on the first uplink channel/first uplink signal and the reference signal resource (for example, the resources in the resource set and/or the reference signal/reference signal resource associated with/corresponding to the indicated TCI state). Optionally, the starting point of the time domain resource(s) on which the CSI report on the second uplink occupies the CPUs may be determined based on the first reference symbol and a second reference symbol. Refer above for the description of the first reference symbol. Optionally, the second reference symbol is determined based on the reference signal resource (e.g., the resource in the resource set and/or the reference signal/reference signal resource associated with/corresponding to the indicated TCI state). Optionally, the time domain resource(s) on which the CSI report on the second uplink occupies the CPUs starts from the later/earlier one of the first reference symbol and the second reference symbol. Optionally, the starting symbol of the time domain resource(s) on which the CSI report on the second uplink occupies the CPUs is the later/earlier one of the first reference symbol and the second reference symbol. This scheme considers the influence of the reference signal measurement on the CPU occupation time, such that the UE and the base station have accurate and same understanding of the CPU occupation time of the CSI report carried on the second channel, thus improving the reliability of the communication system.
Optionally, the second reference symbol is determined based on the CSI reference resource corresponding to the CSI report and the reference signal resource (in the resource set and associated with/corresponding to the indicated TCI state). For example, the second reference symbol is the first symbol of the earliest reference signal resource (in the resource set and associated with/corresponding to the indicated TCI state) in the latest transmission occasion no later than the CSI reference resource. For example, the second reference symbol is the first symbol of the earliest reference signal resource (in the resource set and/or in the reference signal resource associated with the indicated TCI state) in the latest transmission occasion no later than the CSI reference resource. For example, the second reference symbol is the first symbol of the earliest reference signal resource (in the resource set and associated with/corresponding to the indicated TCI state) in the latest transmission occasion no later than the CSI reference resource corresponding to the reference signal resource (in the resource set and associated with/corresponding to the indicated TCI state).
Optionally, the ending point of the time domain resource(s) on which the CPUs are occupied is determined based on the second uplink channel. For example, the CSI report on the second uplink channel occupies the CPUs until the last symbol/first symbol of the second uplink channel. For example, the CSI report on the second uplink channel occupies the CPUs until the last slot/first slot of the second uplink channel. Optionally, the subcarrier spacing corresponding to/associated with the last symbol/first symbol of the second uplink channel is based on/equal to the subcarrier spacing of the second uplink channel, or the subcarrier spacing of the first uplink channel, or the larger/smaller subcarrier spacing in the subcarrier spacing of the first uplink channel and the subcarrier spacing of the second uplink channel.

Optionally, the subcarrier spacing of the first uplink channel/first uplink signal refers to the subcarrier spacing of the (active) uplink BWP that transmits the first uplink channel/first uplink signal. Optionally, the subcarrier spacing of the second uplink channel refers to the subcarrier spacing of the (active) uplink BWP that transmits the second uplink channel.

In order for the base station to manage the CSI computing resources of the UE, the number of CSI Processing Units (CPUs) occupied by the CSI report on the second uplink needs to be clarified. Optionally, the number (for example, O_{CPU}) of CPUs occupied by the CSI report on the second uplink channel is predefined. For example, O_{CPU}=1 or 2. Optionally, the number (for example, O_{CPU}) of CPUs occupied by the CSI report on the second uplink channel is based on the UE capability. For example, O_{CPU}=X_{cap}. Here, X_{cap} represents a parameter associated with the number of CPUs occupied by the CSI report on the second uplink channel. Optionally, X_{cap} is determined based on the reported UE capability information. Optionally, the value of X_{cap} may be one of 1, 2, 3 and 4. Optionally, the number (for example, O_{CPU}) of CPUs occupied by the CSI report on the second uplink channel is indicated/configured by the base station. The method provided above may specify the number of CPUs occupied by the CSI report on the second uplink channel, such that the UE and the base station have the same understanding of CPU occupation, thus improving the reliability of the communication system.

Optionally, a method for determining the second uplink channel (time domain position) is described further below. Optionally, the time domain position of the second uplink channel is determined based on (the last symbol of) the first uplink channel/first uplink signal and/or Y. Optionally, Y is based on X. Optionally, Y≥X. Optionally, Y and X may be the same parameters. Optionally, Y is Configured by RRC or predefined. Optionally, the second uplink channel is the closest uplink channel (e.g., the closest in time domain, or the closest in time domain from the first uplink channel) satisfying at least one of the following conditions:
The serving cell/CC where the second uplink channel is located is the serving cell/CC determined based on the first uplink channel/first uplink signal;
The offset between the slot where the second uplink channel is located and the slot where the first uplink channel/first uplink signal is located is greater than or equal to Y; or the symbol offset between the first symbol of the second uplink channel and the last symbol of the first uplink channel/first uplink signal is greater than or equal to Y;
The slot number of the slot where the second uplink channel is located satisfies (N_frame_slot*n_sfn+n_slot-T_{offset})mod T_{CSI}, where N_frame_slot is the number of slots in a frame, n_sfn is the system frame number, n_slot is the slot number in a frame, T_{offset} is the slot offset, and T_{CSI} represents the periodicity. Optionally, T_{offset} may be predefined or configured by the base station. Optionally, T_{CSI} may be predefined or configured by the base station. Optionally, N_frame_slot is the number of slots in a frame for the subcarrier spacing of the second uplink channel. Optionally, n_slot is the slot number in a frame for the subcarrier spacing of the second uplink channel;
The second uplink channel does not overlap with a downlink symbol. Optionally, the downlink symbol may be a downlink symbol configured by higher-layer signaling;
Optionally, the second uplink channel symbol offset in the slot where the second uplink channel is located is equal to a specific value or one of one or more specific values. Optionally, the second uplink channel symbol offset refers to the symbol offset between the starting symbol of the second uplink channel and the first symbol in the slot where the second uplink channel is located. Optionally, the value of the symbol offset is ranged from 0 to 13. Optionally, the one or more specific values may be predefined. Optionally, the one or more specific values may be indicated by the base station (for example, configured by the CSI reporting configuration).

The above method may reduce the time separation between the second uplink channel and the first uplink channel/first uplink signal, reducing the delay of uplink transmission and improving the performance of the communication system.

A procedure/method associated with the CSI reference resource corresponding to/associated with the CSI report (for example, the CSI report on the second uplink channel) will be described below.

The slot where the CSI report (for example, the CSI report on the second uplink channel) is located may be the uplink slot n′. In time domain, the CSI reference resource corresponding to the CSI report (for example, the CSI report on the second uplink channel) is defined as single downlink slot

$$n - {n}_{CSI \_ ref} - {K}_{offset} \cdot \frac{{2}^{{μ}_{DL}}}{{2}^{{μ}_{{K}_{offset}}}}$$

or a downlink n−n_{CSI_ref}. Here, K_{offset} is a parameter configured by higher-layer, and μ_{K}_{_{offset}} is the subcarrier spacing configuration of parameter μ_{K}_{_{offset}}. In case of frequency range 1 (FR1), the value of μ_{K}_{_{offset}} is 0. For example, K_{offset}=K_{cell,offset}−K_{UE,offset}, where K_{cell,offset} may be configured by a higher-level parameter (e.g., cellSpecifickoffset) and/or K_{UE,offset} may be indicated by a MAC-CE command (e.g., by a MAC-CE indicating a differential K_{offset}); otherwise, if not respectively provided, K_{cell,offset}=0 or K_{UE,offset}=0. Here,

$$n = ⌊ {n}^{′} \cdot \frac{{2}^{{μ}_{DL}}}{{2}^{{μ}_{UL}}} ⌋ + ⌊ ( \frac{{N}_{slot , offset , UL}^{CA}}{{2}^{{μ}_{offset , UL}}} - \frac{{N}_{slot , offset , DL}^{CA}}{{2}^{{μ}_{offset , DL}}} ) \cdot {2}^{{μ}_{DL}} ⌋ ,$$

where μ_{DL} and μ_{UL} are subcarrier spacing configurations for downlink and uplink, respectively, (for a cell transmitting uplink and downlink) N_{slot,offset}^{CA} and μ_{offset} are determined based on a parameter (for example, ca-SlotOffset) configured by higher-layer. Methods for determining the CSI reference resource (for example, the CSI reference resource corresponding to the CSI report on the second uplink channel) will be described in detail below.

Method 1: the CSI reference resource corresponding to the CSI report on the second uplink channel is determined based on the slot associated with the first uplink channel (or the first uplink signal). Optionally, the CSI reference resource corresponding to the CSI report on the second uplink channel and the slot associated with the first uplink channel (or the first uplink signal) are in the same slot (in the same downlink slot or in the same valid downlink slot). Optionally, the slot associated with the first uplink channel (or the first uplink signal) refers to the downlink slot determined based on the uplink slot where the first uplink channel (or the first uplink signal) is located. Here, the uplink slot where the first uplink channel (or the first uplink signal) is located may be recorded as the uplink slot n″. For example, the slot associated with the first uplink channel (or the first uplink signal) is: downlink slot

$$⌊ {n}^{″} \cdot \frac{{2}^{{μ}_{DL}}}{{2}^{{μ}_{UL}}} ⌋ ,$$

or downlink slot

$$⌈ {n}^{″} \cdot \frac{{2}^{{μ}_{DL}}}{{2}^{{μ}_{UL}}} ⌉$$

or downlink slot

$$⌊ {n}^{″} \cdot \frac{{2}^{{μ}_{DL}}}{{2}^{{μ}_{UL}}} ⌋ + K 1 ,$$

or downlink slot

$$⌈ {n}^{″} \cdot \frac{{2}^{{μ}_{DL}}}{{2}^{{μ}_{UL}}} ⌉ + K 1.$$

Optionally, K1 may be predefine. Optionally, K1 may be configured by the base station or based on the UE capability. Optionally, the value of K1 may be one of −2, −1, 0, 1 and 2. Below is described by taking the slot associated with the first uplink channel (or the first uplink signal) being the downlink slot

$$⌊ {n}^{″} \cdot \frac{{2}^{{μ}_{DL}}}{{2}^{{μ}_{UL}}} ⌋$$

as an example. Optionally, the CSI reference resource corresponding to the CSI report on the second uplink channel is on the downlink slot

$$⌊ {n}^{″} \cdot \frac{{2}^{{μ}_{DL}}}{{2}^{{μ}_{UL}}} ⌋ .$$

Optionally, the UE determines a specific value of n_{CSI_ref}, wherein the specific value makes the downlink slot (for example, the valid downlink slot) where the CSI reference resource is located be the downlink slot

$$⌊ {n}^{″} \cdot \frac{{2}^{{μ}_{DL}}}{{2}^{{μ}_{UL}}} ⌋ ,$$

or be the (valid) downlink slot same as the downlink slot

$$⌊ {n}^{″} \cdot \frac{{2}^{{μ}_{DL}}}{{2}^{{μ}_{UL}}} ⌋ .$$

Optionally, Luz may be the subcarrier spacing configuration of the first uplink channel (or, the first uplink signal). Optionally, μ_{DL} may be the downlink subcarrier spacing configuration. Since the CSI report is determined based on the measurement of the CSI reference resource no later than the first uplink channel, this method may make the CSI on the second uplink channel be determined based on measurement of the first uplink channel or measurement before the first uplink channel, prevent the channel change between the first uplink channel and the second uplink channel from affecting the result of the CSI report, such that the UE and the base station have the same understanding on the measurement on which the CSI report is based, thus improving the reliability of the communication system.

Method 2: the CSI reference resource corresponding to the CSI report on the second uplink channel is determined based on the parameter associated with delay requirement and/or the UE capability. Optionally, the slot where the second uplink channel is located is the uplink slot n′. Optionally, the slot associated with the second uplink channel may be the downlink slot n. Optionally, the slot (e.g., downlink slot or valid downlink slot) corresponding to the CSI reference resource is based on n_{CSI_ref} or n-n_{CSI_ref}. Optionally, n_{CSI_ref} may be a value greater than or equal to X_{ref}. Optionally, n_{CSI_ref} may be a minimum value/maximum value (for example, an integer value) greater than or equal to X_{ref} such that the slot n-n_{CSI_ref} corresponds to a downlink slot (for example, a valid downlink slot). Optionally, X_{ref} is based on a parameter (for example, Z or Z′) associated with delay requirement. Optionally, X_{ref} is based on/equal to a parameter (for example, Z′₁ or Z′₃) associated with delay requirement. Optionally, X_{ref} is based on/equal to a parameter (for example, Z₁ or Z₃) associated with delay requirement. Below is described by taking the parameter associated with delay requirement being Z′₃ as an example to describe. Optionally, Z′₃ is based on the (reported) UE capability (e.g., beamReportTiming). Optionally, X_{ref} is based on or equal to └Z′₃/N_{symb}^{slot}┘ or ┐Z′₃/N_{symb}^{slot}┌. The CSI reference resource is determined by Z′₃, which enables UEs with different capabilities to determine the CSI reference resource based on corresponding hardware capability, thus improving the flexibility of UE hardware. Here, N_{symb}^{slot} represents the number of symbols per slot/a slot. Optionally, X_{ref} may be based on the UE capability. For example, the UE indicates/reports the value of X_{ref} via capability signaling. For example, the UE indicates/reports the value of X′ via capability signaling, and X_{ref} is based on or equal to └X′/N_{symb}^{slot}┘ slot or ┐X′/N_{symb}^{slot}┌.

Optionally, when the uplink slot associated with the first uplink channel and the uplink slot associated with the second uplink channel are the same (for example, when n″=n′), or when the uplink slot associated with the first uplink channel and the uplink slot associated with the second uplink channel overlap, the UE performs Method 1. Optionally, when the downlink slot (e.g.,

$$slot ⌊ {n}^{″} \cdot \frac{{2}^{{μ}_{DL}}}{{2}^{{μ}_{UL}}} ⌋ )$$

associated with the first uplink channel and the downlink slot (e.g.,

$$slot ⌊ {n}^{′} \cdot \frac{{2}^{{μ}_{DL}}}{{2}^{{μ}_{UL}}} ⌋ )$$

associated with the second uplink channel are in the same downlink slot, the UE performs Method 1. In this way, the conditions to perform Method 1 are clarified, so that the base station and the UE have the same understanding of the conditions for the CSI reporting, thus improving the reliability of the communication system.

Optionally, when the uplink slot associated with the first uplink channel and the uplink slot associated with the second uplink channel are different (for example, when n′ is not equal to n″), or when the uplink slot associated with the first uplink channel and the uplink slot associated with the second uplink channel do not overlap, or when the uplink slot associated with the second uplink channel is after the uplink slot associated with the first uplink channel, or when the downlink slot associated with the second uplink channel is after the downlink slot associated with the first uplink channel, the UE performs Method 2. Optionally, when the downlink slot (e.g.,

$$slot ⌊ {n}^{″} \cdot \frac{{2}^{{μ}_{DL}}}{{2}^{{μ}_{UL}}} ⌋ )$$

associated with the first uplink channel and the downlink slot (e.g.,

$$slot ⌊ {n}^{′} \cdot \frac{{2}^{{μ}_{DL}}}{{2}^{{μ}_{UL}}} ⌋ )$$

associated with the second uplink channel are in different downlink slots, the UE performs Method 2. In this way, conditions to perform Method 2 are clarified, so that the base station and the UE have the same understanding of the conditions for the CSI reporting, thus improving the reliability of the communication system.

Optionally, the method for determining the CSI reference resource may be the combination of Method 1 and Method 2. Optionally, for the CSI report carried on the second uplink channel, the UE may determine a first slot corresponding to the corresponding CSI reference resource through Method 1, and the UE may determine a second slot corresponding to the corresponding CSI reference resource through Method 2, and the UE may determine that the slot where the CSI reference resource corresponding to the CSI report carried on the second uplink channel is located/corresponds is the earlier/later slot in the first slot and the second slot. Optionally, for the CSI report carried on the second uplink channel, the UE may determine the n_{CSI_ref} corresponding to the corresponding CSI reference resource through Method 1, and the UE may determine the n_{CSI_ref} corresponding to the corresponding CSI reference resource through Method 2, wherein the n_{CSI_ref} corresponding to the CSI reference resource is the larger/smaller value of the n_{CSI_ref} determined by Method 1 and the n_{CSI_ref} determined by Method 2. For example, for CSI report #a, the UE determines that the CSI reference resource corresponding to CSI report #a is in slot #5 through Method 1, and determines that the CSI reference resource corresponding to CSI report #a is in slot #7 through Method 2, then the CSI reference resource corresponding to CSI report #a is in slot #7 (for example, the UE takes the later slot). For example, for CSI report #a, the UE determines that the value of n_{CSI_ref} corresponding to the CSI reference resource corresponding to CSI report #a is 3 through Method 1, and that the value of n_{CSI_ref} corresponding to the CSI reference resource corresponding to CSI report #a is 5 through Method 2, then the value of n_{CSI_ref} corresponding to the CSI reference resource corresponding to CSI report #a is 3 (e.g., the UE takes the smaller value). By taking the slot corresponding to the earlier CSI reference resource through combination of Method 1 and Method 2 may make the UE have more time to prepare the CSI report, which facilitates to reduce the hardware complexity of the UE. By taking the slot corresponding to the later CSI reference resource through combination of Method 1 and Method 2 may make the UE determine the CSI report based on the later measurement of the reference signal, which facilitates to derive accurate CSI.

In the disclosure, the downlink subcarrier spacing configuration may be the subcarrier spacing associated with the CSI report for measuring the (active) BWP of the reference signal. In the disclosure, the downlink subcarrier spacing configuration may be the subcarrier spacing associated with the CSI report for measuring the (active) BWP of the serving cell of the reference signal.

Optionally, a slot in a cell (e.g., a serving cell) may be considered as a valid downlink slot if at least one of the following conditions is satisfied:
The slot includes at least one higher-layer configured downlink or flexible symbol.
The slot does not fall within a configured measurement gap. Optionally, the configured measurement gap is for the UE.

The above methods may define the CSI reference resource on which the CSI in the CSI report is based, such that the UE and base station have the same understanding of the CSI, thus improving the reliability of the communication system.

Method/behavior of the UE associated with the measurement is discussed below. Optionally, the UE does not (or is not expected to, or is not required to) measure the channel and/or interference on a reference channel (e.g., a specific reference signal). Optionally, when periodic CSI-RS (or semi-persistent CSI-RS) or SSB is for channel measurement and/or interference measurement, the UE does not (or is not expected to, or is not required to) measure the channel and/or interference on a reference channel (e.g., a specific reference signal). Conditions/features satisfied by the specific reference signal are discussed below.
Optionally, the specific reference signal is for channel measurement and/or interference measurement. Optionally, the specific reference signal is in the resources set for channel measurement and/or for interference measurement.
Optionally, the specific reference signal is associated with the time domain resource(s) of the first uplink channel (or the first uplink signal) and/or the time domain resource(s) of the second uplink channel. Optionally, the specific reference signal refers to the reference signal between the first uplink channel (or the first uplink signal) and the second uplink channel. Optionally, the specific reference signal is after the first uplink channel (or, the first uplink signal) and/or the specific reference signal is before the second uplink channel. Optionally, the specific reference signal is not earlier than the first uplink channel (or the first uplink signal), and/or the specific reference signal is not later than the second uplink channel. For example, the first symbol of the specific reference signal is after the last symbol/first symbol of the first uplink channel (or the first uplink signal), and/or the last symbol of the specific reference signal is before the first symbol/last symbol of the second uplink channel. For example, the first symbol of the specific reference signal is after the first uplink channel (or the first uplink signal), and/or the last symbol of the specific reference signal is before the second uplink channel. Optionally, the specific reference signal is not earlier than the symbol before X_{ref} symbols of the first symbol of the second uplink channel. Optionally, the last symbol of the specific reference signal is not earlier than the symbol before X_{ref} symbols of the first symbol of the second uplink channel. For example, the first symbol of the second uplink channel is symbol #n, and the symbol before X_{ref} symbols of the first symbol of the second uplink channel is symbol #n-X_{ref}, then the last symbol of the specific reference signal is not earlier than symbol #n-X_{ref} (or before symbol #n-X_{ref}). X_{ref} is described above.

The above method may clarify which resources associated with the CSI report of the second uplink channel do not need to be measured, thus preventing the UE from measuring corresponding resources and saving energy consumption of the UE.

In the disclosure, a channel/time unit being before a channel/time unit may be understood as a channel/time unit being not later than a channel/time unit. A channel/time unit being after a channel/time unit may be understood as a channel/time unit being not earlier than a channel/time unit.

The illustrative logical blocks, modules, and circuits described in the disclosure may be implemented in a general-purpose processor, a Digital Signal Processor (DSP), an application specific integrated circuit, ASIC), Field Programmable Gate Array (FPGA) or other programmable logic devices, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors cooperating with a DSP core, or any other such Configuration.

The steps of a method or algorithm described in the disclosure may be embodied directly in hardware, in a software module executed by a processor, or in a combination of the two. Software modules may reside in RAM memory, flash memory, ROM memory, erasable programmable ROM (EPROM) memory, electrically erasable programmable ROM (EEPROM) memory, registers, hard disks, removable disks, or any other form of storage media known in the art. A storage medium is coupled to a processor to enable the processor to read and write information from/to the storage medium. In the alternative, the storage medium may be integrated into the processor. The processor and storage medium may reside in an ASIC. The ASIC may reside in the user terminal. In the alternative, the processor and the storage medium may reside as separate components in the user terminal.

In one or more designs, the described functions may be implemented in hardware, software, firmware, or any combination thereof. If implemented in software, each function may be stored on or transmitted by a computer-readable medium as one or more instructions or codes. Computer-readable media include both computer storage media and communication media, and the latter includes any media that facilitates the transfer of computer programs from one place to another. The storage medium may be any available medium that may be accessed by a general-purpose or special-purpose computer.

The description set forth herein, taken in conjunction with the drawings, describes example Configurations, methods and devices, and does not represent all examples that may be realized or are within the scope of the claims. As used herein, the term “example” means “serving as an example, instance or illustration” rather than “preferred” or “superior to other examples”. The detailed description includes specific details in order to provide an understanding of the described technology. However, these techniques may be practiced without these specific details. In some cases, well-known structures and devices are shown in block diagram form to avoid obscuring the concepts of the described examples.

Although this specification contains many specific implementation details, these should not be interpreted as limitations on any disclosure or the scope of the claimed protection, but as descriptions of specific features of specific embodiments of specific disclosures. Some features described in this specification in the context of separate embodiments can also be combined in a single embodiment. On the contrary, various features described in the context of a single embodiment can also be implemented separately in a plurality of embodiments or in any suitable sub-combination. Furthermore, although features may be described above as functioning in certain combinations, and even initially claimed as such, in some cases, one or more features from the claimed combination may be deleted from the combination, and the claimed combination may be directed to a subcombination or a variation of a subcombination.

It should be understood that the specific order or hierarchy of steps in the method of the disclosure is illustrative of a process. Based on design preferences, it can be understood that a specific order or hierarchy of steps in a method can be rearranged to achieve the functions and effects disclosed in the disclosure. The appended method claims present elements of various steps in an example order, and are not meant to be limited to the particular order or hierarchy presented, unless otherwise specifically stated. Furthermore, although elements may be described or claimed in the singular, the plural is also contemplated unless the limitation on the singular is explicitly stated. Therefore, the disclosure is not limited to the illustrated examples, and any means for performing the functions described herein are included in various aspects of the disclosure.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment in a wireless communication system, the method comprising:
receiving, from a base station (BS), configuration information for subband non-overlapping full-duplex (SBFD), wherein the configuration information indicates SBFD frequency domain resource(s);
receiving, from the BS, a channel state information (CSI) reporting configuration; and
determining a CSI reporting band for reporting CSI associated with the CSI reporting configuration based on the SBFD frequency domain resource(s).

2. The method of claim 1, wherein the CSI reporting band comprises at least one of:
a subset of CSI subbands; or
physical resource blocks (PRBs) of a bandwidth part (BWP) associated with the CSI reporting configuration.

3. The method of claim 2, wherein, based on a number of the PRBs of the BWP being less than or equal to a predefined value, or the number of PRBs of the BWP in a downlink subband included in the SBFD frequency domain resource(s) being less than or equal to a predefined value, then at least one of:
the CSI reporting band comprises frequency domain resource(s) of the BWP in the downlink subband included in the SBFD frequency domain resource(s);
the CSI reporting band comprises all PRBs in the BWP; or
the BWP is not configured outside the downlink subband included in the SBFD frequency domain resource(s).

4. The method of claim 2, wherein the CSI subbands are within the BWP.

5. The method of claim 4,
wherein a number of CSI subbands included in the CSI subbands is determined based on a number of bits in a bitmap included in a CSI reporting band parameter associated with the CSI reporting configuration, and
wherein a CSI subband with a lowest frequency domain position in the CSI subbands is a CSI subband with a lowest frequency domain position in the BWP.

6. The method of claim 5,
wherein the bitmap indicates one or more CSI subbands in the CSI subbands, and
wherein the subset of the CSI subbands comprises CSI subbands of the one or more CSI subbands in downlink subband(s) included in the SBFD frequency domain resource(s).

7. The method of claim 2, wherein the CSI subbands are in the BWP and in a downlink subband included in the SBFD frequency domain resource(s).

8. The method of claim 7,
wherein a number of CSI subbands included in the CSI subbands is determined based on a number of bits in a bitmap included in a CSI reporting band parameter associated with the CSI reporting configuration, and
wherein a CSI subband with a lowest frequency domain position is a CSI subband with a lowest frequency domain position in the BWP and in downlink subband(s) included in the SBFD frequency domain resource(s).

9. The method of claim 8,
wherein the bitmap indicates one or more CSI subbands in the CSI subbands, and
wherein the subset of the CSI subbands includes the one or more CSI subbands.

10. A method performed by a base station (BS) in a wireless communication system, the method comprising:
transmitting, to a user equipment (UE), configuration information for subband non-overlapping full-duplex (SBFD), wherein the configuration information indicates SBFD frequency domain resource(s);
transmitting, to the UE, a channel state information (CSI) reporting configuration; and
receiving, from the UE, CSI associated with a CSI reporting band,
wherein the CSI reporting band is determined based on the SBFD frequency domain resource(s).

11. The method of claim 10, wherein the CSI reporting band comprises at least one of:
a subset of CSI subbands; or
physical resource blocks (PRBs) of a bandwidth part (BWP) associated with the CSI reporting configuration.

12. The method of claim 11, wherein, based on a number of the PRBs of the BWP being less than or equal to a predefined value, or the number of PRBs of the BWP in a downlink subband included in the SBFD frequency domain resource(s) being less than or equal to a predefined value, then at least one of:
the CSI reporting band comprises frequency domain resource(s) of the BWP in the downlink subband included in the SBFD frequency domain resource(s);
the CSI reporting band comprises all PRBs in the BWP; or
the BWP is not configured outside the downlink subband included in the SBFD frequency domain resource(s).

13. The method of claim 11, wherein the CSI subbands are within the BWP.

14. The method of claim 13,
wherein a number of CSI subbands included in the CSI subbands is determined based on a number of bits in a bitmap included in a CSI reporting band parameter associated with the CSI reporting configuration, and
wherein a CSI subband with a lowest frequency domain position in the CSI subbands is a CSI subband with a lowest frequency domain position in the BWP.

15. The method of claim 14,
wherein the bitmap indicates one or more CSI subbands in the CSI subbands, and
wherein the subset of the CSI subbands comprises CSI subbands of the one or more CSI subbands in downlink subband(s) included in the SBFD frequency domain resource(s).

16. The method of claim 11, wherein the CSI subbands are in the BWP and in a downlink subband included in the SBFD frequency domain resource(s).

17. The method of claim 16,
wherein a number of CSI subbands included in the CSI subbands is determined based on a number of bits in a bitmap included in a CSI reporting band parameter associated with the CSI reporting configuration, and
wherein a CSI subband with a lowest frequency domain position is a CSI subband with a lowest frequency domain position in the BWP and in downlink subband(s) included in the SBFD frequency domain resource(s).

18. The method of claim 17,
wherein the bitmap indicates one or more CSI subbands in the CSI subbands, and
the subset of the CSI subbands includes the one or more CSI subbands.

19. A user equipment (UE) in a wireless communication system, the UE comprising:
a transceiver; and
a controller coupled with the transceiver and configured to:
receive, from a base station (BS), configuration information for subband non-overlapping full-duplex (SBFD), wherein the configuration information indicates SBFD frequency domain resource(s),
receive, from the BS, a channel state information (CSI) reporting configuration, and
determine a CSI reporting band for reporting CSI associated with the CSI reporting configuration based on the SBFD frequency domain resource(s).

20. A base station (BS) in a wireless communication system, the BS comprising:
a transceiver; and
a controller coupled with the transceiver and configured to:
transmit, to a user equipment (UE), configuration information for subband non-overlapping full-duplex (SBFD), wherein the configuration information indicates SBFD frequency domain resource(s),
transmit, to the UE, a channel state information (CSI) reporting configuration, and
receive, from the UE, CSI associated with a CSI reporting band,
wherein the CSI reporting band is determined based on the SBFD frequency domain resource(s).
